(19) United States
(12) Patent Application Publication
(10) Pub. No.: US 2009/0213462 A1
(43) Pub. Date: Aug. 27, 2009

(54) OPTICAL FILM, POLARIZATION PLATE AND IMAGE DISPLAY DEVICE

(76) Inventors: Daiki WAKIZAKA, Minami-Ashigara-shi (JP); Kenichi FUKUDA, Minami-Ashigara-shi (JP)

Correspondence Address: BIRCH STEWART KOLASCH & BIRCH, PO BOX 747, FALLS CHURCH, VA, 22040-0747, US

(21) Appl. No.: 12/392,738

(22) Filed: Feb. 25, 2009

(30) Foreign Application Priority Data
Feb. 26, 2008 (JP) P2008-044790

(51) Int. Cl. G02B 1/11; G02B 27/28

(52) U.S. Cl. 359/580; 359/485

(57) ABSTRACT

An optical film, includes: a transparent support; and at least one low refractive index layer on or above the transparent support, wherein the low refractive index layer is formed from a low refractive index layer forming composition containing (A) a hydrophobic polyrotaxane compound, (B) a fluorine-containing copolymer and an organic solvent.

### BACKGROUND OF THE INVENTION

1. Field of the Invention

The present invention relates to an optical film, a polarization plate using this optical film, and an image display device using this optical film or this polarization plate on the outermost surface of the display.

2. Description of the Related Art

An anti-reflection film is generally arranged on the outermost surface of a display of an image display device so as to lower reflection ratio using the optical interference principle for preventing decrease in contrast and reflecting of images by reflection of outside light, in display devices such as cathode ray tubes (CRT), plasma displays (PDP), electroluminescence displays (ELD) and liquid crystal displays (LCD).

An anti-reflection film is arranged on the outermost surface of a display of an image display device, thus, a high abrasion resistance is required for a low refractive index layer as the top layer. For realizing a high abrasion resistance on the low refractive index layer as a thin film, however, the strength of the film itself and excellent close adherence to a lower layer are necessary.

In contrast, for realizing low reflection ratio in an anti-reflection film, a material having refractive index of as low as possible is desired for the low refractive index layer. For decreasing the refractive index of the layer, there are means of (1) introducing a fluorine atom, (2) lowering density (introducing void) and the like, however, in any of them, film strength and close adherence tend to deteriorate to lower abrasion resistance, thus, low refractive index and high abrasion resistance are not satisfied easily.

For example, means are described of introducing a polysiloxane structure into a fluorine-containing polymer, to lower the friction coefficient of the film surface, thereby improving abrasion resistance (see, JP-A No. 11-189621, JP-A No. 11-228631 and JP-A No. 2000-313709). Technologies described in these documents are effective to a certain extent for improvement of abrasion resistance, however, have no sufficient abrasion resistance.

Recently, there are suggested novel gels not classified to any of physical gels and chemical gels, that is “slide-ring gel or topological gel”, using innovative means, and a polyrotaxane is used as such a slide-ring gel. A rotaxane is known as a conceptual compound having a structure composed of a cyclic compound and a linear polymer penetrating through the cavity of this cyclic compound, in which both ends of this linear polymer are capped. There is disclosed a crosslinked polyrotaxane applicable to a slide-ring gel by crosslinking a plurality of rotaxanes (see, Japanese Patent No. 3475252).

This crosslinked rotaxane has viscoelasticity since a cyclic molecule penetrated in skewered form by a linear molecule is capable of moving along this linear polymer (pulley effect), and even if tension is applied, this tension can be dispersed uniformly by this pulley effect, thus, this rotaxane has an excellent nature that crack and flaw hardly occur, differing from conventional crosslinked polymers.

However, it has been found that if this rotaxane or crosslinked rotaxane is tried to be applied to a low refractive index layer containing a fluorine polymer for improving the abrasion resistance in the anti-reflection film, then, white turbidity of a coated film occurs, causing decrease in image quality.

### SUMMARY OF THE INVENTION

For obtaining a film excellent in abrasion resistance while lowering the refractive index of a low refractive index layer as described above, it is effective to use a polymer component containing a fluorine atom introduced. However, since a polymer containing introduced fluorine is significantly hydrophobic, when it is mixed with a hydrophilic polyrotaxane compound, compatibility of them is usually poor, to cause white turbidity of a coated film.

The present invention has an object of providing an optical film having improved abrasion resistance and showing no white turbidity of a coated film though using a polyrotaxane compound, an anti-reflection film having further improved abrasion resistance and showing no white turbidity of a coated film though having a sufficient anti-reflection performance, and a method of producing the optical film. Another object of the present invention is to provide a polarization plate and a display device equipped with the optical film or the anti-reflection film.

The present inventors have intensively investigated to solve the above-described problems and resultantly found that the above-described objects can be attained by means shown below, leading to completion of the present invention. Namely, the present invention is as described below.

(1) An optical film, comprising:

a transparent support; and

at least one low refractive index layer on or above the transparent support,

wherein the low refractive index layer is formed from a low refractive index layer forming composition containing (A) a hydrophobic polyrotaxane compound, (B) a fluorine-containing copolymer and an organic solvent.

(2) The optical film as described in (1) above,

wherein the hydrophobic polyrotaxane compound (A) is a compound including a cyclic molecule that is hydrophobicized.

(3) The optical film as described in (1) or (2) above,

wherein the hydrophobic polyrotaxane compound (A) includes a cyclodextrin molecule as a cyclic molecule.

(4) The optical film as described in any of (1) to (3) above,

wherein the hydrophobic polyrotaxane compound (A) is a polyrotaxane compound having an unsaturated double bond group.

(5) The optical film as described in any of (1) to (4) above,

wherein the low refractive index layer forming composition further contains (C) at least one compound having a plurality of unsaturated double bond groups in one molecule.

(6) The optical film as described in (5) above,

wherein at least one of the at least one compound (C) includes an organosiloxane structure.

(7) The optical film as described in (5) or (6) above,

wherein at least one of the at least one compound (C) is a fluorine-containing poly-functional monomer having two or more polymerizable groups and having a fluorine content of 20.0 mass % or more.

(8) The optical film as described in any of (1) to (7) above,

wherein the low refractive index layer forming composition further contains (D) inorganic fine particles.

(9) A polarization plate, comprising:

a polarization film; and

a plurality of protective films on both sides of the polarization film,

wherein at least one of the plurality of protective films is the optical film as described in any of (1) to (8) above.

(10) An image display device, comprising:

the optical film as described in any of (1) to (8) above or the polarization plate as described in (9) above disposed on the outermost surface of a display.

### DETAILED DESCRIPTION OF THE INVENTION

The optical film of the present invention is an optical film having at least one low refractive index layer on a transparent support, wherein the low refractive index layer is formed of a low refractive index layer forming composition comprising (A) a hydrophobic polyrotaxane compound, (B) a fluorine-containing copolymer and an organic solvent.

In the present invention, the fluorine-containing copolymer is effective for lowering the refractive index of a coated film, compatibilized with a hydrophobic polyrotaxane compound, and effective for obtaining a coated film which is strong against external force due to stress relaxation, thereby showing poor flaw.

In the present invention, the above-described component (A) and component (B) are not particularly restricted, however, a low refractive index layer is preferably contained obtained by coating a coating composition containing 1 to 30 wt % of the component (A) and 30 to 99 wt % of the component (B).

The above-described component (A) is contained in an amount of preferably I to 20 wt %, more preferably 5 to 20 wt %.

The above-described component (B) is contained in an amount of preferably 30 to 80 wt %, more preferably 30 to 70 wt %.

[Hydrophobic Polyrotaxane Compound (A)]

The rotaxane means a molecule formed by fitting a cyclic molecule to an axis molecule in the form of dumbbell or the like, and a compound obtained by confining a plurality of cyclic molecules such as cyclodextrin and the like by using a polymer such as polyethylene glycol or the like as the axis molecule is referred to as polyrotaxane. Here, “poly” means confinement of a plurality of cyclic molecules to one axis molecule.

In the present invention, the hydrophobic compound is not particularly restricted providing it has a hydrophobic structure, and it is preferable that the cyclic molecule is hydrophobicized. In one specific embodiment, when cyclodextrin is used as the cyclic molecule in a polyrotaxane, at least one hydroxyl group in the cyclic molecule is modified by other organic group (hydrophobic group).

One example of specific polyrotaxane structures include compounds in which a linear polymer molecule having end functional groups as the axis molecule is included in the skewered form in a cyclic molecule, and the above-described end functional group is chemically modified with a capping group which is sufficiently bulky so that the above-described cyclodextrin molecule can not leave from the linear polymer molecules having the end functional groups.

The cyclic molecule to be used in the above-described polyrotaxane is not particularly restricted providing a linear polymer molecule can be passed through within its ring. Cyclic molecules which are suitably used include cyclodextrins, crown ethers, cryptands, macrocyclic amines, calixarenes, cyclophanes and the like. In particular, cyclodextrins are preferable since they have a nature of easy formation of an inclusion compound with an organic compound. The cyclodextrins are compounds in which a plurality of glucoses are connected via an α-1,4-bond in the form of cycle, and of them, compounds formed of 6, 7 and 8 glucoses are called α-, β- and γ-cyclodextrins respectively and used more suitably. In particular, an α-cyclodextrin molecule is advantageous.

Modified dextrins prepared by substituting at least one hydroxyl group of these cyclodextrins with other organic group (hydrophobic group) are further preferably used since they have improved solubility in a solvent. Here, the introduction ratio of the organic group (hydrophobic group) is preferably 30% or more, further preferably 50% or more. When less than 30%, compatibility with a fluorine-containing copolymer deteriorates undesirably.

Specific examples of the hydrophobic group include, but not limited to, an alkyl group, benzyl group, benzene derivative-containing group, acyl group, silyl group, trityl group, nitrate group, tosyl group, alkyl-substituted ethylenically unsaturated group as a photocuring site, alkyl-substituted epoxy group as a thermocuring site, and the like. In the above-described hydrophobicized polyrotaxane, the above-described hydrophobic groups may be used singly or in combination of two or more. Further, when the functional layer is endowed with an anti-reflection function, it is preferable that the hydrophobic group is formed of a fluorine compound (such as an optionally substituted alkyl fluoride group or the like).

As further specific examples of the substituent carried on the cyclic molecule, the following moieties can be applied.

Halogen atoms (for example, fluorine atom, chlorine atom, bromine atom, iodine atom), alkyl groups (preferably alkyl groups having I to 30 carbon atoms, for example, a methyl group, ethyl group, n-propyl group, isopropyl group, tert-butyl group, n-octyl group, 2-ethylhexyl group), cycloalkyl groups (preferably, substituted or un-substituted cycloalkyl groups having 3 to 30 carbon atoms, for example, a cyclohexyl group, cyclopentyl group, 4-n-dodecylcyclohexyl group), bicycloalkyl groups (preferably, substituted or un-substituted bicycloalkyl groups having 5 to 30 carbon atoms, namely, monovalent groups obtained by removing one hydrogen atom from bicycloalkanes having 5 to 30 carbon atoms. For example, bicyclo[1,2,2]heptan-2-yl, bicyclo[2,2,2]octan-3-yl),

alkenyl groups (preferably, substituted or un-substituted alkenyl groups having 2 to 30 carbon atoms, for example, a vinyl group, allyl group), cycloalkenyl groups (preferably, substituted or un-substituted cycloalkenyl groups having 3 to 30 carbon atoms, namely, monovalent groups obtained by removing one hydrogen atom from cycloalkenes having 3 to 30 carbon atoms. For example, 2-cyclopenten-1-yl, 2-cyclohexen-1-yl group), bicycloalkenyl groups (substituted or un-substituted bicycloalkenyl groups, preferably, substituted or un-substituted bicycloalkenyl groups having 5 to 30 carbon atoms, namely, monovalent groups obtained by removing one hydrogen atom from bicycloalkenes having one double bond. For example, bicyclo[2,2,1]hept-2-en-1-yl group, bicyclo[2,2,2]oct-2-en-4-yl group), alkynyl groups (preferably, substituted or un-substituted alkynyl groups having 2 to 30 carbon atom, for example, an ethynyl group, propargyl group), aryl groups (preferably, substituted or un-substituted aryl groups having 6 to 30 carbon atom, for example, a phenyl group, p-toyl group, naphthyl group), heterocyclic groups (preferably, monovalent groups obtained by removing one hydrogen atom from 5- or 6-membered substituted or un-substituted aromatic or non-aromatic heterocyclic compounds, further preferably, 5- or 6-membered aromatic heterocyclic groups having 3 to 30 carbon atoms. For example, a 2-furyl group, 2-thienyl group, 2-pyrimidinyl group, 2-benzothiazolyl group),

cyano group, nitro group, alkoxy groups (preferably, substituted or un-substituted alkoxy groups having I to 30 carbon atoms, for example, a methoxy group, ethoxy group, isopropoxy group, tert-butoxy group, n-octyloxy group, 2-methoxyethoxy group), aryloxy groups (preferably, substituted or un-substituted aryloxy groups having 6 to 30 carbon atoms, for example, a phenoxy group, 2-methylphenoxy group, 4-tert-butylphenoxyl group, 3-nitrophenoxy group, 2-tetradecanoylaminophenoxy group), silyloxy groups (preferably, silyloxy groups having 3 to 20 carbon atoms, for example, a trimethylsilyloxy group, tert-butyldimethylsilyloxy group), heterocyclic oxy groups (preferably, substituted or un-substituted heterocyclic oxy groups having 2 to 30 carbon atoms, 1-phenyltetrazol-5-oxy group, 2-tetrahydropyranyloxy group), acyloxy groups (preferably, a formyloxy group, substituted or un-substituted alkylcarbonyloxy groups having 2 to 30 carbon atoms, substituted or un-substituted arylcarbonyloxy groups having 6 to 30 carbon atoms, for example, formyloxy group, acetyloxy group, pivaloyloxy group, stearoyloxy group, benzoyloxy group, p-methoxyphenylcarbonyloxy group),

carbamoyloxy groups (preferably, substituted or un-substituted carbamoyloxy groups having 1 to 30 carbon atoms, for example, N,N-dimethylcarbamoyloxy group, N,N-diethylcarbamoyloxy group, morpholinocarbonyloxy group, N,N-di-n-octylaminocarbonyloxy group, N-n-octylcarbamoyloxy group), alkoxycarbonyloxy groups (preferably, substituted or un-substituted alkoxycarbonyloxy groups having 2 to 30 carbon atoms, for example, a methoxycarbonyloxy group, ethoxycarbonyloxy group, tert-butoxycarbonyloxy group, n-octylcarbonyloxy group), aryloxycarbonyloxy groups (preferably, substituted or un-substituted aryloxycarbonyloxy groups having 7 to 30 carbon atoms, for example, a phenoxycarbonyloxy group, p-methoxyphenoxycarbonyloxy group, p-n-hexadecyloxyphenoxycarbonyloxy group),

acylamino groups (preferably, a formylamino group, substituted or un-substituted alkylcarbonylamino groups having 1 to 30 carbon atoms, substituted or un-substituted arylcarbonylamino groups having 6 to 30 carbon atoms, for example, formylamino group, acetylamino group, pivaloylamino group, lauroylamino group, benzoylamino group), aminocarbonylamino groups (preferably, substituted or un-substituted aminocarbonylamino groups having 1 to 30 carbon atoms, for example, a carbamoylamino group, N,N-dimethylaminocarbonylamino group, N,N-diethylaminocarbonylamino group, morpholinocarbonylamino group), alkoxycarbonylamino groups (preferably, substituted or un-substituted alkoxycarbonylamino groups having 2 to 30 carbon atoms, for example, a methoxycarbonylamino group, ethoxycarbonylamino group, tert-butoxycarbonylamino group, n-octadecyloxycarbonylamino group, N-methyl-methoxycarbonylamino group), aryloxycarbonylamino groups (preferably, substituted or un-substituted aryloxycarbonylamino groups having 7 to 30 carbon atoms, for example, a phenoxycarbonylamino group, p-chlorophenoxycarbonylamino group, m-n-octyloxyphenoxycarbonylamino group), sulfamoylamino groups (preferably, substituted or un-substituted sulfamoylamino groups having 0 to 30 carbon atoms, for example, a sulfamoylamino group, N,N-dimethylaminosulfonylamino group, N-n-octylaminosulfonylamino group), alkyl and arylsulfonylamino groups (preferably, substituted or un-substituted alkylsulfonylamino groups having 1 to 30 carbon atoms, substituted or un-substituted arylsulfonylamino groups having 6 to 30 carbon atoms, for example, a methylsulfonylamino group, butylsulfonylamino group, phenylsulfonylamino group, 2,3,5-trichlorophenylsulfonylamino group, p-methylphenylsulfonylamino group),

mercapto group, alkylthio groups (preferably, substituted or un-substituted alkylthio groups having 1 to 30 carbon atoms, for example, a methylthio group, ethylthio group, n-hexadecylthio group), arylthio groups (preferably, substituted or un-substituted arylthio groups having 6 to 30 carbon atoms, for example, a phenylthio group, p-chlorophenylthio group, m-methoxyphenylthio group), heterocyclic thio groups (preferably, substituted or un-substituted heterocyclic thio groups having 2 to 30 carbon atoms, for example, a 2-benzothiazolylthio group, 1-phenyltetrazol-5-ylthio group), sulfamoyl groups (preferably, substituted or un-substituted sulfamoyl groups having 0 to 30 carbon atoms, for example, an N-ethylsulfamoyl group, N-(3-dodecyloxypropyl)sulfamoyl group, N,N-dimethylsulfamoyl group, N-acetylsulfamoyl group, N-benzoylsulfamoyl group, N-(N′phenylcarbamoyl)sulfamoyl group), sulfo group, alkyl and arylsulfinyl groups (preferably, substituted or un-substituted alkylsulfinyl groups having 1 to 30 carbon atoms, substituted or un-substituted arylsulfinyl groups having 6 to 30 carbon atoms, for example, a methylsulfinyl group, ethylsulfinyl group, phenylsulfinyl group, p-methylphenylsulfinyl group), alkyl and arylsulfonyl groups (preferably, substituted or un-substituted alkylsulfonyl groups having 1 to 30 carbon atoms, substituted or un-substituted arylsulfonyl groups having 6 to 30 carbon atoms, for example, a methylsulfonyl group, ethylsulfonyl group, phenylsulfonyl group, p-methylphenylsulfonyl group), acyl groups (preferably, a formyl group, substituted or un-substituted alkylcarbonyl groups having 2 to 30 carbon atoms, substituted or un-substituted arylcarbonyl groups having 7 to 30 carbon atoms, for example, an acetyl group, pivaloylbenzoyl group),

aryloxycarbonyl groups (preferably, substituted or un-substituted aryloxycarbonyl groups having 7 to 30 carbon atoms, for example, a phenoxycarbonyl group, o-chlorophenoxycarbonyl group, m-nitrophenoxycarbonyl group, p-tert-butylphenoxycarbonyl group), alkoxycarbonyl groups (preferably, substituted or un-substituted alkoxycarbonyl groups having 2 to 30 carbon atoms, for example, a methoxycarbonyl group, ethoxycarbonyl group, tert-butoxycarbonyl group, n-octadecyloxycarbonyl group), carbamoyl groups (preferably, substituted or un-substituted carbamoyl groups having 1 to 30 carbon atoms, for example, a carbamoyl group, N-methylcarbamoyl group, N,N-dimethylcarbamoyl group, N,N-di-n-octylcarbamoyl group, N-(methylsulfonyl)carbamoyl group), aryl and heterocyclic azo groups (preferably, substituted or un-substituted aryl azo groups having 6 to 30 carbon atoms, substituted or un-substituted heterocyclic azo groups having 3 to 30 carbon atoms, for example, a phenyl azo group, p-chlorophenyl azo group, 5-ethylthio-1,3,4-thiadiazol-2-yl azo group), imide groups (preferably, an N-succinimide group, N-phthalimide group),

phosphino groups (preferably, substituted or un-substituted phosphino groups having 2 to 30 carbon atoms, for example, a dimethylphosphino group, diphenylphosphino group, methylphenoxyphosphino group), phosphinyl groups (preferably, substituted or un-substituted phosphinyl groups having 2 to 30 carbon atoms, for example, a phosphinyl group, dioctyloxyphosphinyl group, diethoxyphosphinyl group), phosphinyloxy groups (preferably, substituted or un-substituted phosphinyloxy groups having 2 to 30 carbon atoms, for example, a diphenoxyphosphinyloxy group, dioctyloxyphosphinyloxy group), phosphinylamino groups (preferably, substituted or un-substituted phosphinylamino groups having 2 to 30 carbon atoms, for example, a dimethoxyphosphinylamino group, dimethylaminophosphinylamino group), silyl groups (preferably, substituted or un-substituted silyl groups having 3 to 30 carbon atoms, for example, a trimethylsilyl group, tert-butyldimethylsilyl group, phenyldimethylsilyl group).

Among the above-described substituents, those having a hydrogen atom may be deprived of the hydrogen atom, and substituted by the above-described group. Examples of such functional groups include alkylcarbonylaminosulfonyl groups, arylcarbonylaminosulfonyl groups, alkylsulfonylaminocarbonyl groups, and arylsulfonylaminocarbonyl groups. Examples thereof include a methylsulfonylaminocarbonyl group, p-methylphenylsulfonylaminocarbonyl group, acetylaminosulfonyl group, and benzoylaminosulfonyl group. The carbon numbers of them are the same as the carbon numbers of the above-described corresponding substituents, and preferable examples thereof are also the same.

The substituent carried on the cyclic molecule includes preferably an alkyl group, alkenyl group, alkynyl group, silyloxy group, acyloxy group, acylamino group, sulfamoylamino group, alkyl and arylsulfonylamino group, alkyl and arylsulfonyl group, acyl group, aryloxycarbonyl group, alkoxycarbonyl group and silyl group, more preferably an alkyl group, alkenyl group, silyloxy group, acyloxy group, alkyl and arylsulfonyl group, acyl group, alkoxycarbonyl group and silyl group, further preferably an alkyl group, alkenyl group, silyloxy group, acyloxy group, acyl group and alkoxycarbonyl group.

The cyclic molecule may have plural kinds of substituents, and it is preferable that at least one of them is a polymerizable group. Examples of combinations of a plurality of substituents present in the cyclic molecule include acetyl group/polymerizable group, alkyl group/polymerizable group, silyloxy group/polymerizable group, and the like. These two substituents may be present on the identical cyclic molecule, or may be present on different cyclic molecules connected to the identical polyrotaxane molecule (compound in the present invention).

As examples of the polymerizable group carried on the cyclic molecule, groups manifesting progress of polymerization by heat or light are preferable, further, those capable of performing an addition polymerization reaction or condensation polymerization reaction are preferable. As such polymerizable groups, polymerizable ethylenically unsaturated groups or ring-opening polymerizable groups are preferable.

Groups of the following P1, P2, P3 and P4 are further preferable.

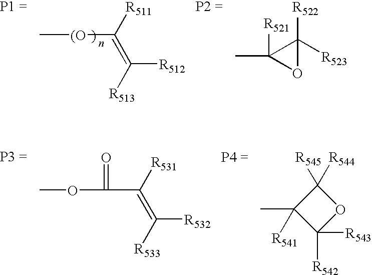

In the above-described formulae P1 to P4, R₅₁₁, R₅₁₂, R₅₁₃, R₅₂₁, R₅₂₂, R₅₂₃, R₅₃₁, R₅₃₂, R₅₃₃, R₅₄₁, R₅₄₂, R₅₄₃, R₅₄₄ and R₅₄₅ represent each independently a hydrogen atom or alkyl group. n represents 0 or 1.

The polymerizable group P1, P2, P3 or P4 may be connected directly to a cyclic molecule, or may be connected via a connecting group. The connecting group is preferably an alkyleneoxy group, alkyleneoxycarbonyloxy group or alkyleneoxycarbonyl group. Specific examples of them are shown below.

Alkyleneoxy groups (for example, alkyleneoxy groups such as ethyleneoxy, propyleneoxy, butyleneoxy, pentyleneoxy, hexyleneoxy, heptyleneoxy and the like, or substituted alkyleneoxy groups containing an ether bond such as ethyleneoxyethoxy and the like), alkyleneoxycarbonyloxy groups (for example, alkyleneoxycarbonyloxy groups such as ethyleneoxycarbonyloxy, propyleneoxycarbonyloxy, butyleneoxycarbonyloxy, pentyleneoxycarbonyloxy, hexyleneoxycarbonyloxy, heptyleneoxycarbonyloxy and the like, or substituted alkyleneoxycarbonyloxy groups containing an ether bond such as ethyleneoxyethoxycarbonyloxy and the like), alkyleneoxycarbonyl groups (for example, alkyleneoxycarbonyl groups such as ethyleneoxycarbonyl, propyleneoxycarbonyl, butyleneoxycarbonyl, pentyleneoxycarbonyl, hexyleneoxycarbonyl, heptyleneoxycarbonyl and the like, or substituted alkyleneoxycarbonyl groups containing an ether bond such as ethyleneoxyethoxycarbonyl and the like).

In the polymerizable group P1, n represents an integer of 0 or 1, and it is preferable that n is 1, and when n is 1, P1 represents a substituted or un-substituted vinyl ether group. Substituents R₅₁₁ and R₅₁₃ of the polymerizable group P1 represent each independently a hydrogen atom or an alkyl group (for example, methyl, ethyl, n-propyl, isopropyl, n-butyl, pentyl, hexyl, heptyl, octyl and nonyl are mentioned, and lower alkyl groups such as methyl and ethyl are preferable, further, methyl is preferable), and preferable is a combination in which R₅₁₁ represents a methyl group and R₅₁₃ represents a hydrogen atom, or a combination in which both R₅₁₁ and R₅₁₃ represent a hydrogen atom.

The substituent R₅₁₂ represents a hydrogen atom, substituted or un-substituted alkyl group (for example, methyl, ethyl, n-propyl, isopropyl, n-butyl, pentyl, hexyl, heptyl, octyl, nonyl, 2-chloroethyl, 3-methoxyethyl and methoxyethoxyethyl are mentioned, and alkyl groups having 1 to 3 carbon atoms such as methyl and ethyl are preferable, further, methyl is preferable), preferably a hydrogen atom, or alkyl group having 1 to 3 carbon atoms (methyl, ethyl and the like), further preferably a hydrogen atom. Therefore, an un-substituted vinyloxy group which is a functional group generally having high polymerization activity is preferably used as the polymerizable group P1.

The polymerizable group P2 represents a substituted or un-substituted oxylane group. Substituents R₅₂₁ and R₅₂₂ of the polymerizable group P2 represent each independently a hydrogen atom or an alkyl group (for example, methyl, ethyl, n-propyl, isopropyl, n-butyl, pentyl, hexyl, heptyl, octyl and nonyl are mentioned, and alkyl groups having 1 to 3 carbon atoms such as methyl and ethyl are preferable, further, methyl is preferable), and it is preferable that both R₅₂₁ and R₅₂₂ represent a hydrogen atom.

The substituent R₅₂₃ represents a hydrogen atom, substituted or un-substituted alkyl group (for example, methyl, ethyl, n-propyl, isopropyl, n-butyl, pentyl, hexyl, heptyl, octyl, nonyl, 2-chloroethyl, 3-methoxyethyl and methoxyethoxyethyl are mentioned, and alkyl groups having 1 to 3 carbon atoms such as methyl and ethyl are preferable, further, methyl is preferable), preferably a hydrogen atom, or alkyl group having 1 to 3 carbon atoms such as methyl, ethyl, n-propyl and the like.

The polymerizable group P3 represents a substituted or un-substituted acrylic group. Substituents R₅₃₁ and R₅₃₃ of the polymerizable group P3 represent each independently a hydrogen atom or an alkyl group (for example, methyl, ethyl, n-propyl, isopropyl, n-butyl, pentyl, hexyl, heptyl, octyl and nonyl are mentioned, and alkyl groups having 1 to 3 carbon atoms such as methyl and ethyl are preferable, further, methyl is preferable), and preferable is a combination in which R₅₃₁ represents a methyl group and R₅₃₃ represents a hydrogen atom, or a combination in which both R₅₃₁ and R₅₃₃ represent a hydrogen atom.

The substituent R₅₃₂ represents a hydrogen atom, substituted or un-substituted alkyl group (for example, methyl, ethyl, n-propyl, isopropyl, n-butyl, pentyl, hexyl, heptyl, octyl, nonyl, 2-chloroethyl, 3-methoxyethyl and methoxyethoxyethyl are mentioned, and alkyl groups having 1 to 3 carbon atoms such as methyl and ethyl are preferable, further, methyl is preferable), preferably a hydrogen atom. Therefore, a functional group showing high polymerization activity such as an un-substituted acryloxy group, methacryloxy group, crotonyloxy group or the like is a preferably used as the polymerizable group P3.

The polymerizable group P4 represents a substituted or un-substituted oxetane group. R₅₄₂, R₅₄₃, R₅₄₄ and R₅₄₅ represent each independently a hydrogen atom or an alkyl group (for example, methyl, ethyl, n-propyl, isopropyl, n-butyl, pentyl, hexyl, heptyl, octyl and nonyl are mentioned, and alkyl groups having 1 to 3 carbon atoms such as methyl and ethyl are preferable, further, methyl is preferable), and it is preferable that all of R₅₄₂, R₅₄₃, R₅₄₄ and R₅₄₅ represent a hydrogen atom.

R₅₄₁ represents a hydrogen atom or substituted or un-substituted alkyl group (for example, methyl, ethyl, n-propyl, isopropyl, n-butyl, pentyl, hexyl, heptyl, octyl, nonyl, 2-chloroethyl, 3-methoxyethyl and methoxyethoxyethyl are mentioned, and alkyl groups having 1 to 3 carbon atoms such as methyl and ethyl are preferable, further, methyl is preferable), preferably a hydrogen atom, or alkyl group having 1 to 3 carbon atoms such as methyl, ethyl, n-propyl and the like.

The number of substituents carried on the cyclic molecule varies depending on the number of formation of substituent-introducible bonds. For example, when the cyclic molecule is α-cyclodextrin, the number of hydroxyl groups per molecule of the cyclic molecule is 18, thus, the substituent-introducible number is 18, and when 9 substituents on average are introduced, the introduction amount is 50%.

Though the introduction ratio of substituents carried on the cyclic molecule is not particularly restricted, it is preferably 5 to 95%.

The linear molecule is a molecule or substance which is included in a cyclic molecule and can be integrated not by a chemical bond such as conjugated bond and the like but by a mechanical bond, and is not particularly restricted providing it is in the form of straight chain.

In the present specification, “linear” in “linear molecule” means substantial “linear”. That is, the linear molecule may have a branched chain or have a substituent providing a cyclic molecule is capable of moving on the linear molecule. Examples of the substituents which may be carried include the above-described substituents carried on the cyclic molecule.

As the above-described linear molecule, known molecules can be used. For example, polyethers (for example, polyethylene glycol, polypropylene glycol, polytetrahydrofuran and the like), polyolefins (for example, polyethylene, polypropylene, polyisoprene, polyisobutylene, polybutadiene and the like), celluloses (for example, carboxymethyl cellulose, hydroxypropyl cellulose and the like), and siloxanes (polydimethylsiloxane) are mentioned. Preferable are polyethers (particularly, polyethylene glycol). These linear molecules may be used singly or in combination of two or more.

It is advantageous that the linear molecule has a molecular weight of 10,000 or more, preferably 20,000 or more, more preferably 35,000 or more.

The number of cyclic molecules to be fitted to the linear molecule (fitting amount) is, if the cyclic molecule is cyclodextrin, preferably 0.05 to 0.60, further preferably 0.10 to 0.50, furthermore preferably 0.20 to 0.40 when the maximum fitting amount is 1. When less than 0.05, the pulley effect is not manifested in some cases, and when over 0.60, cyclodextrin as the cyclic molecule is placed with too high density to lower the mobility of cyclodextrin in some cases, and no-solubility of cyclodextrin itself against an organic solvent is reinforced and also the solubility of the resultant polyrotaxane in an organic solvent lowers in some cases. The fitting amount of the cyclic molecule means an average number of molecules (number) of the cyclodextrin ring per (one) molecule of the linear molecule. The maximum fitting amount of the cyclic molecule can be determined based on the length of the linear molecule and the thickness of the cyclic molecule. For example, when the linear molecule is polyethylene glycol and the cyclic molecule is α-cyclodextrin molecule, the values of the maximum fitting amount empirically measured are described in “Macromolecules 1993, 26, 5698-5703”.

In the present invention, values obtained by using the method described in the above-described literature are adopted.

As the linear polymer molecule having end functional groups, molecules carrying on its end a reactive group capable of bonding a capping group can be used without any limitation. The end functional groups suitably used here include a hydroxyl group, amino group, carboxyl group, acid chloride group, phenol group, isocyanate group, vinyl group, acrylic group, methacrylic group, styryl group, active ester group, thiol group, lactone ring group, cyclic/linear acid anhydride group, carbonate group, silane group, silanol group, alkoxysilyl group and the like, and particularly preferably, a hydroxyl group, amino group and carboxyl group.

Also linear polymer molecules having a plurality of these end functional groups coexisting in one molecule are suitably used. As the above-described linear polymer molecule, linear polymer molecules capable of forming a structure by which the penetrated cyclic molecule cannot leave can be used without any limitation. The linear polymer molecules which are suitably used include polyalkylene glycols such as polyethylene glycol, polypropylene glycol, polytetramethylene glycol and the like; end hydroxyl group-carrying polyolefins such as polybutadiene diol, polyisoprene diol, polyisobutylene diol, poly(acrylonitrile-butadiene) diol, hydrogenated polybutadiene diol, polyethylene diol, polypropylene diol and the like; polyesters such as polycaprolactone diol, polylactic acid, polyethylene adipate, polybutylene adipate, polyethylene terephthalate, polybutylene terephthalate and the like; end functional polysiloxanes such as end silanol type polydimethylsiloxane and the like; end amino group-carrying linear polymers such as end amino group-carrying polyethylene glycol, end amino group-carrying polypropylene glycol, end amino group-carrying polybutadiene and the like; and 3- or more-functional polyfunctional linear polymer molecules having three or more of the above-described functional groups in one molecule, and the like. In general, polyethylene glycol is often used as the linear molecule, however, it is also preferable to use polyethylene glycol and more hydrophobic copolymers such as polypropylene glycol and the like, to improve compatibility with a fluorine-containing copolymer.

The above-described linear polymer having an end functional group suitably has a molecular weight in the range of 2,000 to 1,000,000, preferably 10,000 to 500,000. When the molecular weight is less than 2,000, the end capping group shows an effect of restricting mobility, and a stress relaxation effect is not manifested sufficiently. When the molecular weight is over 1,000,000, the solubility of the rotaxane in matrix resin lowers, and also workability lowers.

As the above-described bulky end capping group, groups which bond to the end by reacting with the above-described end functional group and are so sufficiently bulky that the above-described cyclic molecule cannot leave, can be used without any limitation. The capping groups which are particularly preferably used include a 2,4-dinitrophenyl group, trityl group, dansyl group, 2,4,6-trinitrophenyl group, triisopropylsilyl group, naphthalene derivative group, anthracene derivative group, fluoresceins, pyrenes, cyclodextrins, adamantane groups. Two same kind of groups among these capping groups may be present in admixture on the same linear molecule, and two different kinds of groups may also be present. Prior to the reaction of the capping group with the linear polymer having end functional groups, conversion of the end functional group of the linear polymer into a functional group having higher reactivity is also suitably performed. For example, if an end hydroxyl group of polyethylene glycol is reacted with carbonyldiimidazole, subsequently with ethylene diamine, then, end amino group-carrying polyethylene glycol is synthesized. Hereinafter, “polyethylene glycol” and “polypropylene glycol” include also cases in which the end of these molecules is denatured by chemical modification. Further, compounds obtained by further connecting a reactive group (for example, photo- and thermo-crosslinkable groups such as ethylenically unsaturated group, epoxy group and the like are preferable) to the bulky capping group are also preferable.

### <Crosslinked Polyrotaxane Compound>

The crosslinked polyrotaxane means a two crosslink groups-containing compound in which two or more cyclic molecules penetrated in the skewered form by a linear molecule are chemically bonded mutually, and these two or more cyclic molecules may be the same or different. In this case, the chemical bond may be a simple bond, or a bond via various atoms or molecules.

The above-described two crosslink groups-containing compound is not particularly restricted providing it is a compound having two or more crosslinked groups. Thus, the two crosslink groups-containing compound may have three or more crosslinked groups. Examples of the two crosslink groups-containing compound include cyanuric chloride, ethylene glycol glycidyl ether and glutaraldehyde, and derivatives thereof and the like, and preferable is at least one selected from the group consisting of them. In particular, the two crosslink groups-containing compound is preferably cyanuric chloride or derivative thereof. When the two crosslink groups-containing compound is cyanuric chloride or derivative thereof, the condition of bonding of the two crosslink groups-containing compound to the cyclic molecule can be represented by the following formula I. Here, L represents a monovalent group or single bond to be connected to the cyclic group, and either one or both of X and Y represent a group having an ionic group.

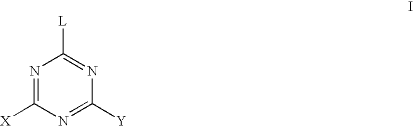

In the present invention, the crosslink group-reactive ionic group-containing compound has a nature of reacting with a crosslink group carried on the two crosslink groups-containing compound, and after the reaction, has an ionic group. As the crosslink group-reactive ionic group-containing compound, compounds having two or more functional groups are mentioned, and for example, amino acids or derivatives thereof, and the like are mentioned.

The above-described ionic group is not particularly restricted providing it has iconicity. Examples of the ionic group include a —COOX group (X represents hydrogen (H), alkali metal or other monovalent metal), —SO₃X group (X is as defined above), —NH₂ group, —NH₃X′ group (X′ represents a monovalent halogen ion), —PO₄ group, —HPO₄ group and the like. Preferable is at least one selected from the group consisting of them.

This crosslinked rotaxane has viscoelasticity since a cyclic molecule penetrated in skewered form by a linear molecule is capable of moving along this linear polymer (pulley effect). Even if tension is applied, this tension can be dispersed uniformly by this pulley effect, to relax internal stress. Further, modified crosslinked polyrotaxanes in which at least one of hydroxyl groups of cyclodextrin forming the crosslinked rotaxane is substituted by other organic group (hydrophobic group) are further preferably used since the solubility thereof in a solvent is improved. Specific examples of the hydrophobic group include, but not limited to, an alkyl group, benzyl group, benzene derivative-containing group, acyl group, silyl group, trityl group, nitrate group, tosyl group, alkyl-substituted ethylenically unsaturated group as a photocuring site, alkyl-substituted epoxy group as a thermocuring site, and the like. In the above-described hydrophobicized polyrotaxane, the above-described hydrophobic groups may be used singly or in combination of two or more.

It is advantageous that the crosslinking agent has a molecular weight of less than 2,000, preferably less than 1,000, more preferably less than 600, most preferably less than 400.

It is advantageous that the crosslinking agent is selected from the group consisting of cyanuric chloride, ethylene glycol glycidyl ether and glutaraldehyde, and derivatives thereof described as the two crosslink groups-containing compound, and additionally, trimesoyl chloride, terephthaloyl chloride, epichlorohydrin, dibromobenzene, glutaraldehyde, phenylene diisocyanate, tolylene diisocyanate, divinylsulfone, 1,1′-carbonyl diimidazole, and alkoxysilanes.

In the crosslinked polyrotaxane compound, it is recommendable that at least one OH group of at least one cyclic molecule of each polyrotaxane of at least two polyrotaxane molecules is correlated with crosslinking.

A topological gel having the crosslinked polyrotaxane of the present invention can be prepared, for example, by the following processes. That is: 1) a pseudopolyrotaxane preparation process in which a cyclic molecule and a linear molecule are mixed to prepare a pseudopolyrotaxane in which the linear molecule is included in the skewered form in an aperture of the cyclic molecule, 2) a polyrotaxane preparation process in which both ends of the pseudopolyrotaxane are capped with capping groups so that the above-described cyclic molecule does not leave from the skewered form, to produce a polyrotaxane; 3) a crosslinking process in which respective cyclic molecules of at least two polyrotaxane molecules are mutually connected via a chemical bond, to crosslink the at least two polyrotaxane molecules, 4) a process in which the above-described crosslinking process is carried out using a two crosslink groups-containing compound having two or more crosslink groups, and after or during the above-described crosslinking process, at least one crosslink group of the two crosslink groups-containing compound is reacted with a crosslink group-reactive ionic group-containing compound having a group reacting with the crosslink group and having an ionic group, wherein the cyclic molecule has the group derived from the crosslink group-reactive ionic group-containing compound and has the ionic group. The two crosslink groups-containing compound includes, but not limited to, cyanuric chloride, ethylene glycol glycidyl ether and glutaraldehyde, and derivatives thereof and the like.

The topological gel can also be prepared by the following processes. That is: 1) a pseudopolyrotaxane preparation process in which a cyclic molecule and a linear molecule are mixed to prepare a pseudopolyrotaxane in which the linear molecule is included in the skewered form in an aperture of the cyclic molecule, 2) a polyrotaxane preparation process in which both ends of the pseudopolyrotaxane are capped with capping groups so that the above-described cyclic molecule does not leave from the skewered form, to produce a polyrotaxane; 3) a crossliniking process in which respective cyclic molecules of at least two polyrotaxane molecules are mutually connected via a chemical bond, to crosslink the at least two polyrotaxane molecules, 4) a process in which after the crosslinking process, a cyclic molecule-reactive ionic group-containing compound having a group reacting with a group of the cyclic molecule and having an ionic group is reacted with a crosslinked polyrotaxane, wherein the cyclic molecule has the group derived from the cyclic molecule-reactive ionic group-containing compound and has the ionic group.

Here, as the cyclic molecule-reactive ionic group-containing compound, the following compounds are mentioned. That is, when the cyclic molecule has a —OH group such as α-cyclodextrin and the like, it is advantageous that the cyclic molecule-reactive ionic group-containing compound has a group reacting with the -OH group and has an ionic group.

More specifically, the cyclic molecule-reactive ionic group-containing compound includes, but not limited to, compounds of the following formula (ProcionBlue MX-R).

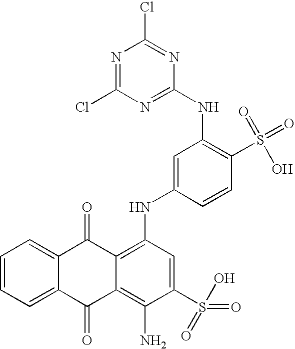

More specifically, the above-described compound can be prepared by the following processes. That is: 1) a pseudopolyrotaxane preparation process in which a cyclic molecule and a linear molecule are mixed to prepare a pseudopolyrotaxane in which the linear molecule is included in the skewered form in an aperture of the cyclic molecule, 2) a polyrotaxane preparation process in which both ends of the pseudopolyrotaxane are capped with capping groups so that the above-described cyclic molecule does not leave from the skewered form, to produce a polyrotaxane; 3) a crosslinking process in which respective cyclic molecules of at least two polyrotaxane molecules are mutually connected via a chemical bond by using cyanuric chloride, to crosslink the at least two polyrotaxane molecules, and 4) a process in which the resultant crosslinked polyrotaxane is reacted with a compound having a group reacting with a Cl group of cyanuric chloride and having an ionic group, wherein a cyclodextrin molecule has a group of the above-described formula I (in the formula I, L represents a single bond or a monovalent group bonding to a cyclic molecule, and either one or both of X and Y represent a group having an ionic group).

In this preparation method, those described above can be used as the cyclic molecule, linear molecule, capping group and the like to be used.

The conditions to be used in the reaction of the crosslink group-reactive ionic group-containing compound and the two crosslink groups-containing compound, namely, the reaction of a crosslink group-reactive group of the crosslink group-reactive ionic group-containing compound with one crosslink group of the two crosslink groups-containing compound, depend on groups used in the reaction, however, are not particularly restricted, and various reaction methods and reaction conditions can be used. Examples thereof include, but not limited to, an acid chloride reaction, silane coupling reaction and the like.

The blending amount of the polyrotaxane and crosslinked polyrotaxane is preferably 1 to 30 parts by weight, further preferably 1 to 20 parts by weight with respect to solid components of the low refractive index layer. When the blending amount is less than 1 part by weight, a stress relaxation effect by the polyrotaxane and crosslinked polyrotaxane is not sufficient, while when over 30 parts by weight, refractive index significantly increases, undesirably.

### [Fluorine-Containing Copolymer (B)]

In the present invention, the fluorine-containing copolymer is not particularly restricted in its structure providing it is a polymer which has a reactive functional group, prepared as an application composition and capable of forming a low refractive index layer. From the standpoint of formation of a layer in application and hardening without volatilization, the fluorine-containing copolymer preferably has a molecular weight of 1,000 or more and 500,000 or less. The refractive index of the fluorine-containing copolymer is preferably 1.34 to 1.44, further preferably 1.35 to 1.40.

As the fluorine-containing copolymer which can be used in the present invention, those having the following structures are listed.

(MF1)a-(MF2)b-(MF3)c-(MA)d-(MB)e Formula 1

In the formula 1, a to e represent the mol fractions of respective constituent components, and represent values satisfying the relations of 30≦a+b≦70, 0≦c≦50, 5≦d≦50, 0≦e≦2.0.

In the formula I, (MF1) represents a constituent component polymerized from a monomer of the following formula [1-1].

(CF₂═CF—Rf1) Formula [1-1]

In the formula, Rf1 represents a perfluoroalkyl group having 1 to 5 carbon atoms.

(MF2) represents a constituent component polymerized from a monomer of the following formula [1-2].

(CF₂═CF—ORf12) Formula [1-2]

In the formula, Rf12 represents a fluorine-containing alkyl group having 1 to 30 carbon atoms.

(MF3) represents a constituent component polymerized from a monomer of the following formula [1-3].

(CH₂═CH—ORf13) Formula [1-3]

In the formula, Rf13 represents a fluorine-containing alkyl group having 1 to 30 carbon atoms.

(MA) represents a constituent component containing at least one reactive group correctable with the crosslinking reaction. (MB) represents an optional constituent component.

Hereinafter, constituent components of the formula 1 will be illustrated in detail.

(CF₂═CF—Rf1) Formula [1-1]

In the formula, Rf1 represents a perfluoroalkyl group having 1 to 5 carbon atoms. As the compound of the formula [1 -1], perfluoropropylene or perfluorobutylene is preferable from the standpoint of polymerization reactivity, and perfluoropropylene is particularly preferable from the standpoint of availability.

(CF₂═CF—ORf12) Formula [1-2]

In the formula, Rf12 represents a fluorine-containing alkyl group having 1 to 30 carbon atoms, preferably 1 to 20 carbon atoms, particularly preferably a fluorine-containing alkyl group having 1 to 10 carbon atoms, further preferably a perfluoro alkyl group having 1 to 10 carbon atoms. The fluorine-containing alkyl group optionally has a substituent. Specific examples of Rh12 include

—CF₃{M2-(1)}

—CF₂CF₃{M2-(2)}

—CF₂CF₂CF₃{M2-(3)}

—CF₂CF(OCF₂CF₂CF₃)CF₃{M2-(4)}, and the like.

(CH₂═CH—ORf13) Formula [1-3]

In the formula, Rf13 represents a fluorine-containing alkyl group having 1 to 30 carbon atoms, preferably 1 to 20 carbon atoms, particularly preferably a fluorine-containing alkyl group having 1 to 15 carbon atoms, may be linear {for example, —CF₂CF₃, —CH₂(CF₂)ₐH, —CH₂CH₂(CF₂)ₐF (a represents an integer of 2 to 12), and the like} or branched {for example, —CH(CF₃)₂, —CH₂CF(CF₃)₂, —CH(CH₃)CF₂CF₃, —CH(CH₃)(CF₂)₅CF₂H, and the like}, may have an alicyclic structure (preferably, 5-membered or 6-membered ring, for example, a perfluorocyclohexyl group, a perfluorocyclopentyl group, or alkyl groups substituted with them, and the like), and may have an ether bond (for example, —CH₂OCH₂CF₂CF₃, —CH₂CH₂OCH₂(CF₂)_{b}H, —CH₂CH₂OCH₂(CF₂)_{b}F (b represents an integer of 2 to 12—CH₂CH₂OCF₂CF₂OCF₂CF₂H and the like). The substituent represented by Rf13 is not limited to the substituents listed here.

The above-described monomers of the formula [1-3] can be synthesized by, for example, a method in which a fluorine-containing alcohol is allowed to act on leaving group-substituted alkyl vinyl ethers such as vinyloxy alkyl sulfonate, vinyloxy alkyl chloride and the like in the presence of a base catalyst, as described in “Macromolecules”, vol. 32 (1), p. 7122 (1999), JP-A No. 2-721 and the like; a method in which a fluorine-containing alcohol and vinyl ethers such as butyl vinyl ether and the like are mixed in the presence of a palladium catalyst, to carry out exchange of vinyl groups, as described in WO 92/05135; a method in which a fluorine-containing ketone and dibromoethane are reacted in the presence of a potassium fluoride catalyst, then, a de-HBr reaction is carried out with an alkali catalyst, as described in U.S. Pat. No. 3,420,793; and the like.

Preferable examples of the constituent component represented by the formula [1-3] include, but not limited to, those components shown below.

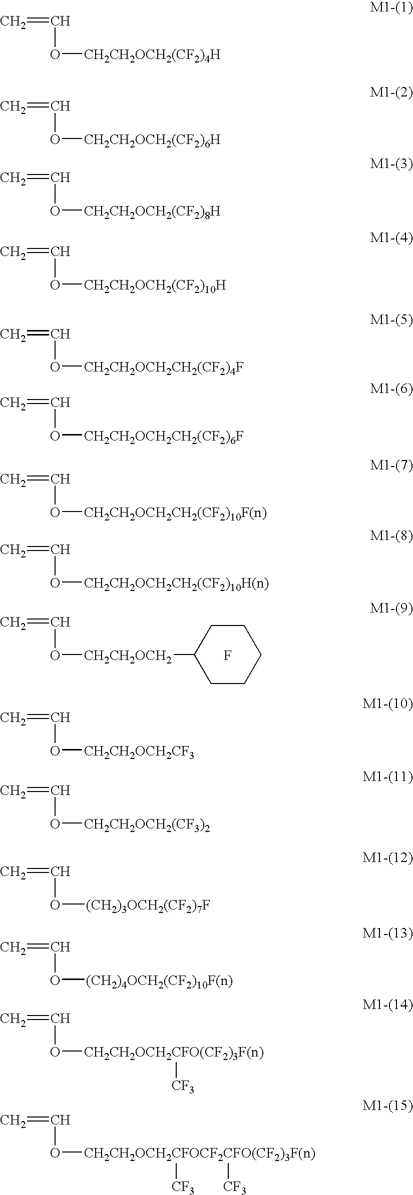

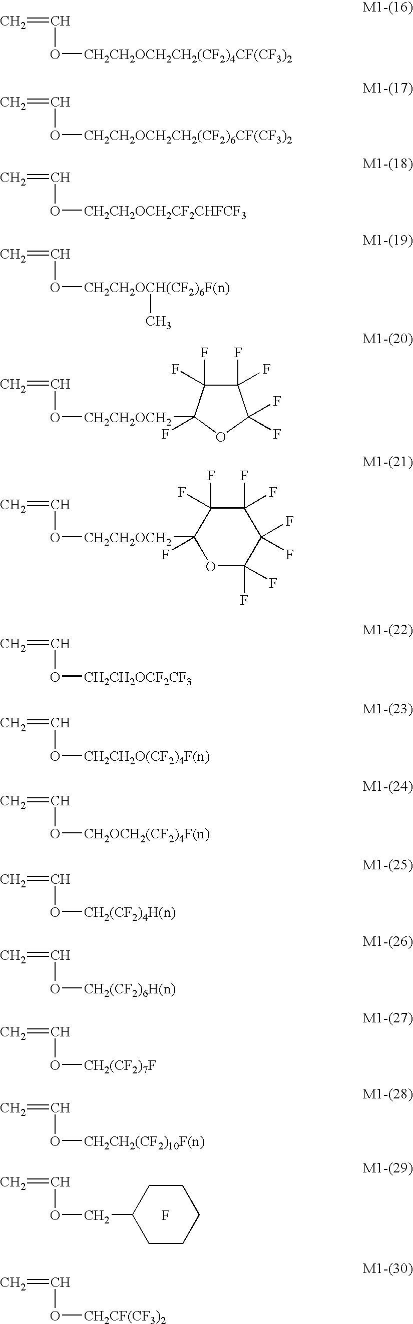

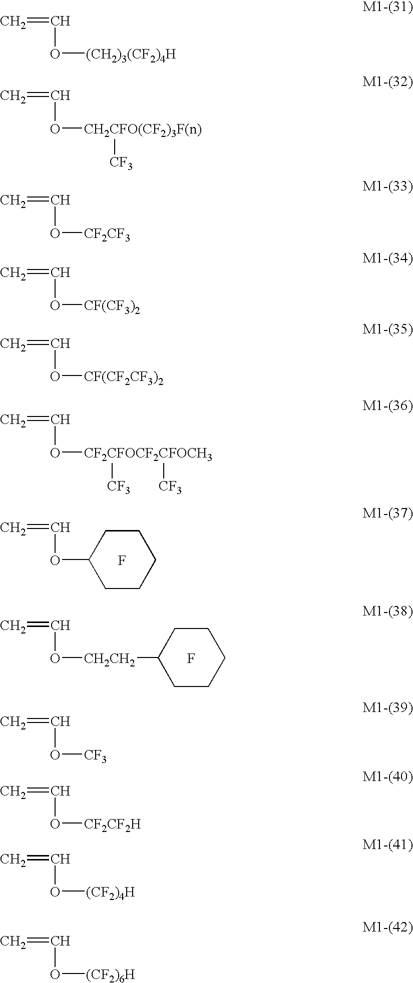

In the formula I, (MA) represents a constituent component containing at least one reactive group correctable with the crosslinking reaction. Examples of the reactive group correctable with the crosslinking reaction include silyl groups having a hydroxyl group or a hydrolysable group (for example, an alkoxysilyl group, acyloxysilyl group and the like), groups having a reactive unsaturated double bond ((meth)acryloyl group, allyl group, vinyloxy group and the like), ring opening polymerization-reactive groups (an epoxy group, oxetanyl group, oxazolyl group and the like), groups having an active hydrogen atom (for example, a hydroxyl group, carboxyl group, amino group, carbamoyl group, mercapto group, β-keto ester group, hydrosilyl group, silanol group and the like), groups substitutable with an acid anhydride or nucleophilic agent (an active halogen atom, sulfonate and the like), etc.

Of these reactive groups, preferable are groups showing polymerization activity by single use, more preferable are hydrolysable silyl groups, groups having a reactive unsaturated double bond, and ring opening polymerization-reactive groups, and particularly preferable are hydrolysable silyl groups, (meth)acryloyl group, allyl group or epoxy group. Particularly preferable embodiments of (MA) include the formulae 4 to 8.

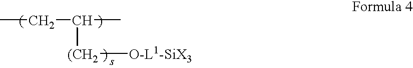

In the formula 4, L¹ represents an alkylene group having 1 to 20 carbon atoms, and optionally has a substituent (for example, an alkyl group, alkoxy group, halogen atom or the like), and may have an aliphatic ring structure (for example, a cyclohexane ring or the like). Preferable are alkylene groups having 1 to 5 carbon atoms, and particularly preferable is an ethylene group or propylene group. s represents 0 or 1, and the case of s=0 is preferable from the standpoint of polymerization reactivity. X represents a hydroxyl group or hydrolysable group (for example, alkoxy groups such as an methoxy group, ethoxy group and the like, halogen atoms such as chloro, bromo and the like, acyloxy groups such as an acetoxy group, phenoxy group and the like), and preferable is a methoxy group or ethoxy group. The constituent component of the formula 4 can be synthesized by means utilizing a hydrosilylation reaction, as described in JP-A No. 48-62726.

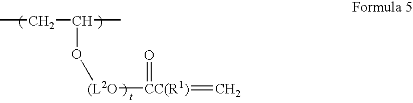

In the formula 5, L² represents an alkylene group having 1 to 20 carbon atoms, and optionally has a substituent (for example, an alkyl group, alkoxy group, halogen atom or the like), and may have an aliphatic ring structure (for example, a cyclohexane ring or the like). Preferable are alkylene groups having 1 to 10 carbon atoms, and particularly preferable are alkylene groups having 2 to 5 carbon atoms. t represents 0 or 1, and the case of t=1 is preferable. R¹ represents a hydrogen atom or methyl group, and the case of a hydrogen atom is preferable. The unsaturated double bond in the formula 5 may be introduced by a method in which a polymer having a hydroxyl group is synthesized, then, an acid halide such as (meth)acrylic chloride and the like, or an acid anhydride such as (meth)acrylic anhydride and the like is allowed to act, and the like, or may be formed by a method in which a vinyl monomer having a 3-chloropropionate portion is polymerized, then, dehydrochlorination is carried out, and the like.

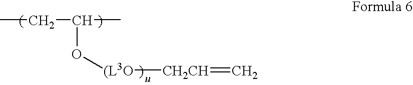

In the formula 6, L³ and u have the same meanings as for L² and t in the formula 5, respectively. An allyl group in the constituent component of the formula 6 can also introduced by a method in which a polymer having a hydroxyl group is synthesized, then, an allyl halide is allowed to act, and the like, like the constituent component of the formula 5.

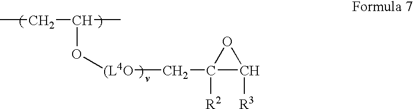

In the formula 7, L⁴ has the same meaning as for L² in the formula 5. v represents 0 or 1. R² and R³ represent a hydrogen atom or methyl group, and the case of a hydrogen atom is preferable. The constituent component of the formula 7 is obtained by polymerizing an epoxy group-containing vinyl ether synthesized by a method in which an epoxy compound such as epichlorohydrin and the like is allowed to act on a vinyl ether having a hydroxyl group, a method in which glycidol is allowed to act on butyl vinyl ether in the presence of a catalyst to perform ether exchange, and the like.

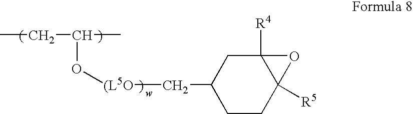

L⁵, w, R⁴ and R⁵ in the formula 8 have the same meanings as for L⁴, v, R² and R³ in the formula 7. Also the constituent component of the formula 8 is synthesized in the same manner as for the constituent component of the formula 7.

Also other functional groups than those explained as particularly preferable example of the constituent component (MA) described above may be introduced in the monomer stage, or may be introduced after synthesis of a polymer having a reactive group such as a hydroxyl group or the like.

Preferable examples of the constituent component represented by (MA) in the above-described polymer of the formula 1 will be shown below, but the present invention is not limited to them.

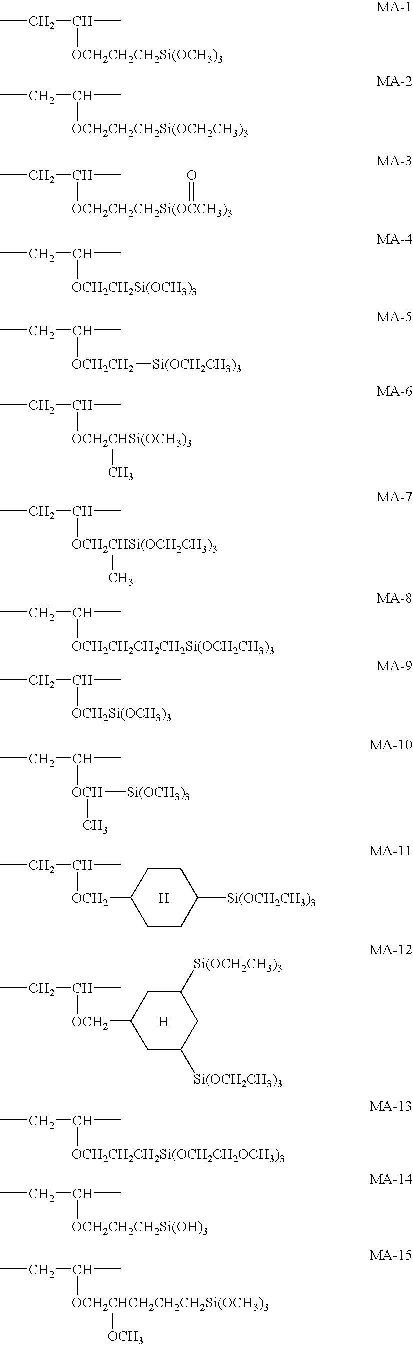

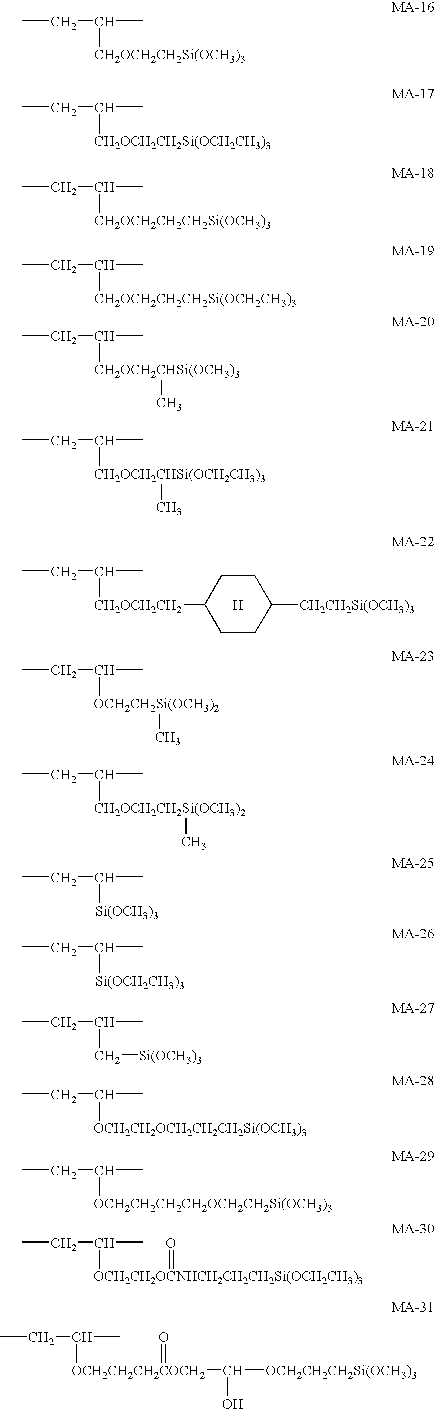

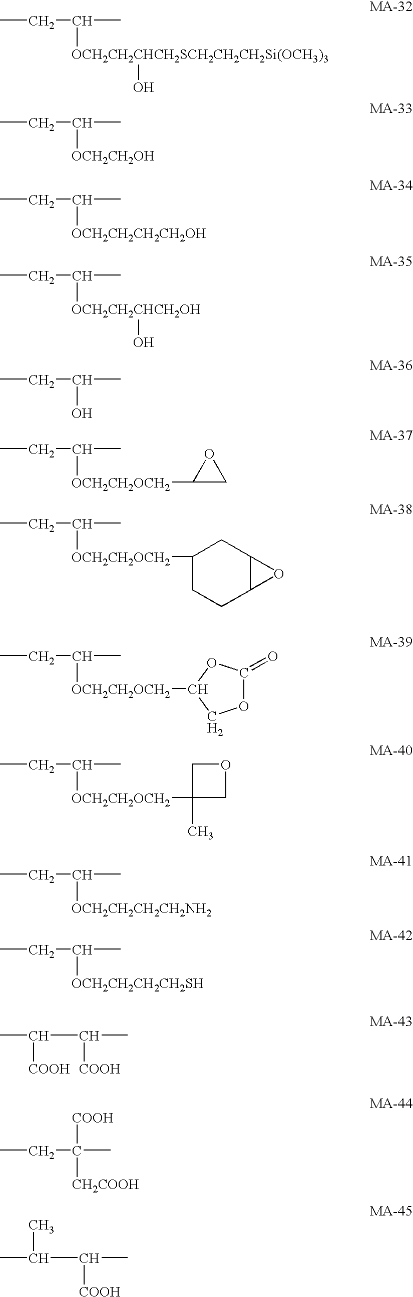

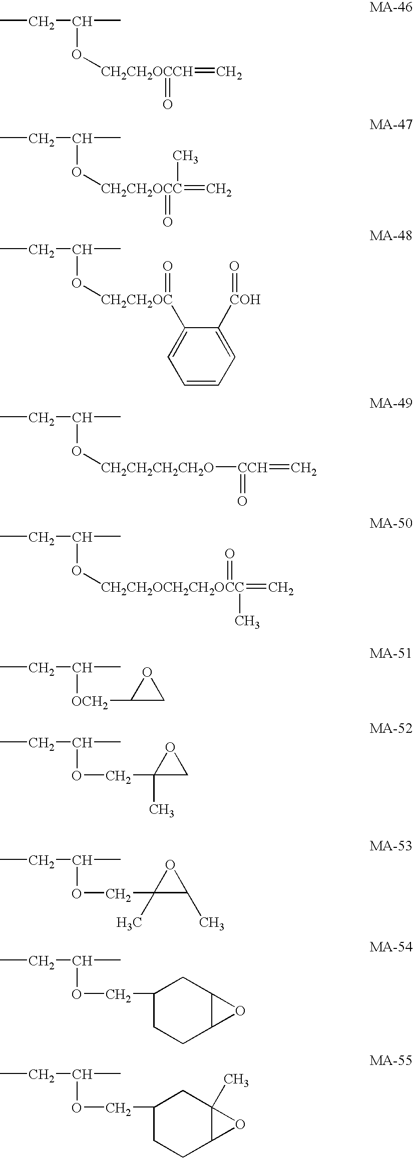

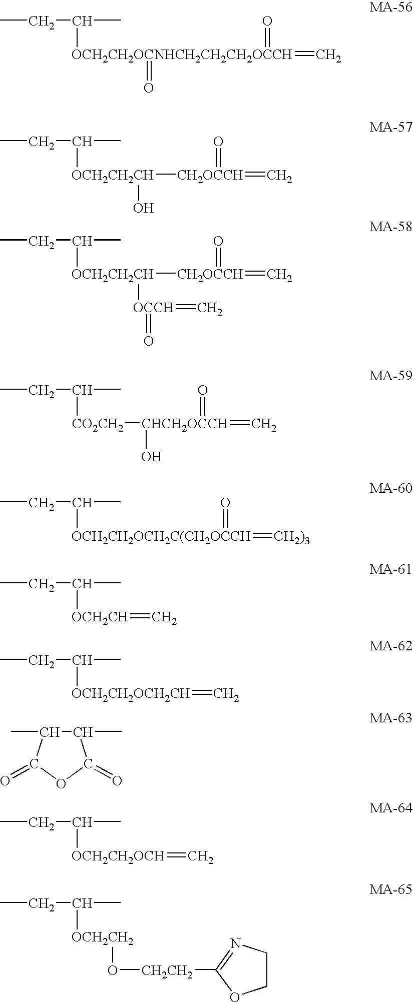

In the formula 1, (MB) represents an optional constituent component, and is not particularly restricted providing it is a constituent component of a monomer copolymerizable with monomers represented by (MF1) and (MF2) and with a monomer forming a constituent component represented by (MA), and can be appropriately selected from the various standpoints of close adherence with a substrate, Tg of polymer (contributing to film hardness), solubility in a solvent, transparency, sliding property, dust and stain-proofing, compatibility with a polyrotaxane compound, and the like.

Examples thereof include vinyl ethers such as methyl vinyl ether, ethyl vinyl ether, n-butyl vinyl ether, cyclohexyl vinyl ether, isopropyl vinyl ether and the like, vinyl esters such as vinyl acetate, vinyl propionate, vinyl butyrate, vinyl cyclohexanecarboxylate and the like.

In particular, it is preferable from the standpoint of sliding property and stain-proofing to use a constituent unit having a polysiloxane structure shown below as the component represented by (MB).

(Constituent Unit having Polysiloxane Structure)

A polysiloxane repeating unit of the following formula 2 can be contained in the main chain or side chain.

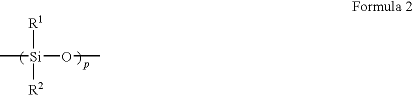

In the formula, R¹ and R² may be the same or different, and represent an alkyl group or aryl group. The alkyl group preferably has 1 to 4 carbon atoms, and examples thereof include a methyl group, trifluoromethyl group, ethyl group and the like. The aryl group preferably has 6 to 20 carbon atoms, and examples thereof include a phenyl group and a naphthyl group. Of them, a methyl group and a phenyl group are preferable, and a methyl group is particularly preferable. p represents an integer of 2 to 500, preferably 5 to 350, particularly preferably 8 to 250.

The polymer having a polysiloxane structure of the formula 2 on the side chain can be synthesized by a method of introducing a polysiloxane (for example, SILAPLANE series (manufactured by CHISSO Corporation) and the like) having an opposing reactive group (for example, an amino group, mercapto group, carboxyl group, hydroxyl group and the like against an epoxy group and acid anhydride group) on one end, by a polymer reaction, into a polymer having a reactive group such as an epoxy group, hydroxyl group, carboxyl, acid anhydride group and the like, as described in, for example, J. Appl. Polym. Sci. 2000, 78, 1995, JP-A No. 56-28219 and the like, or by a method of polymerizing a polysiloxane-containing silicon macromer, and any of the methods can be used preferably.

The method of introducing a polysiloxane partial structure into the main chain is not particularly restricted, and includes, for example, a method of using a polymer type initiator such as an azo group-containing polysiloxaneamide described in JP-A No. 6-93100 (commercial item: VPS-0501, 1001 (trade name; manufactured by Wako Pure Chemical Industries, Ltd.)) and the like, a method in which a reactive group derived from polymerization initiators and chain transfer agents (for example, a mercapto group, carboxyl group, hydroxyl group and the like) is introduced into the polymer end, then, reacted with a polysiloxane containing one end or both end reactive groups (for example, an epoxy group, isocyanate group and the like), a method in which a cyclic siloxane oligomer such as hexamethylcyclotrisiloxane and the like is copolymerized by anion ring opening polymerization, and other methods, and of them, the method of using an initiator having a polysiloxane partial structure is easy and preferable.

From the standpoint of low refractive index, it is also preferable that the component represented by (MB) is a fluorinated cycloalkyl group-containing block copolymer unit described in JP-A No. 2005-76006.

In the present invention, it is also preferable to introduce a hydrophilic unit into a fluorine-containing copolymer from the standpoint of improvement in compatibility with a polyrotaxane compound. Specifically, hydroxyl group-containing units such as (MA-31) to (MA-35) and carboxyl group-containing units such as (MA-43) to (MA-45) described in the section of (MA), and the like, are preferably used.

In the formula 1, a to e represent the mol fractions of respective constituent components, and represent values satisfying the relations of 30≦a+b≦70, 0≦c≦50, 5≦d≦50, 0≦e≦2.0. For attaining low refractive index of a material, it is desired to enhance the mol fractions (%) a+b of the component (MF1) and the component (MF2), however, an introduction ratio of about 50 to 70% is an upper limit and a value higher than this is difficult in general solution type radical polymerization reactions, from the standpoint of polymerization reactivity. In the present invention, a+b is preferably 40% or more, particularly preferably 45% or more.

In the present invention, a component (MF3) is introduced in addition to the component (MF1) and the component (MF2), for attaining low refractive index. The mol fraction c of the component (MF3) is preferably in the range of 10≦c≦50, particularly preferably 20≦c≦40. The sum of the mol fractions of these fluorine-containing monomer components is preferably in the range of 60≦a+b+c≦90, particularly preferably 60≦a+b≦75.

When the proportion of the polymer unit represented by (MA) is too small, the strength of a hardened film weakens. Particularly, in the present invention, the mol fraction of the component (MA) is preferably in the range of 5≦d≦40, particularly preferably in the range of 15≦d≦30.

The mol fraction e (%) of the optional constituent component represented by (MB) is preferably in the range of 0≦e≦20, particularly preferably in the range of 0≦d≦10.

The number average molecular weight of a fluorine-containing polymer to be used for formation of a low refractive index layer in the present invention is preferably 1,000 to 500,000, more preferably 5,000 to 300,000, particularly preferably 10,000 to 100,000.

Here, the number average molecular weight is a molecular weight represented in terms of polystyrene obtained by a differential refractive index detector, using a GPC analysis apparatus using a column such as TSKgel GMHxL, TSKgel G4000HxL, TSKgel G2000HxL (all of them are trade names, manufactured by Tosoh Corporation), using THF as a solvent.

Examples of the polymer of the formula 1 of the present invention will be shown below, but the present invention is not limited to them. Table 1 describes combinations of monomers (MF1), (MF2), (MF3), (MA) and (MB) which form a fluorine-containing constituent component of the formula 1 by polymerization. In the table, a to e represent the mol ratios (%) of monomers of respective components. In the table, a mark of wt % for the component (MB) indicates % by weight of the component based on the whole polymer.

TABLE 1

| | | | | | | | | | | | | Molecular |
|---|---|---|---|---|---|---|---|---|---|---|---|---|
| | (MF1) | (MF2) | (MF3) | (MA) | (MB) | a | b | c | d | e | Fluorine content | weight (10⁴) |
| P-1 | HFP | — | — | (MA-33) | EVE/VPS-1001 | 50 | 0 | 0 | 20 | 30/4 wt % | 47.9 | 3.0 |
| P-2 | HFP | FPVE | — | (MA-33) | EVE/VPS-1001 | 35 | 15 | 0 | 20 | 30/4 wt % | 49.9 | 3.0 |
| P-3 | HFP | — | M1-(43) | (MA-33) | EVE/VPS-1001 | 50 | 0 | 20 | 20 | 10/2 wt % | 60.3 | 2.5 |
| P-4 | HFP | FPVE | M1-(43) | (MA-33) | EVE/VPS-1001 | 35 | 15 | 20 | 25 | 5/2 wt % | 60.4 | 2.5 |
| P-5 | HFP | FPVE | M1-(43) | (MA-33) | EVE/FM-0721 | 35 | 15 | 20 | 25 | 5/2 wt % | 60.4 | 2.5 |
| P-6 | HFP | FPVE | M1-(1) | (MA-33) | EVE/VPS-1001 | 40 | 10 | 20 | 25 | 5/2 wt % | 53.9 | 3.0 |
| P-7 | HFP | FPVE | — | (MA-33) | EVE/VPS-1001/NE-30 | 35 | 15 | 0 | 20 | 30/2 wt %/0.7 wt % | 50.6 | 3.0 |
| P-8 | HFP | FPVE | M1-(43) | (MA-33) | EVE/VPS-1001/NE-30 | 35 | 15 | 20 | 20 | 10/2 wt %/0.7 wt % | 60.2 | 2.3 |
| P-9 | HFP | FPVE | M1-(1) | (MA-33) | EVE/FM-0721/NE-30 | 35 | 15 | 20 | 20 | 10/2 wt %/0.7 wt % | 54.1 | 3.5 |
| P-10 | HFP | FPVE | — | (MA-33) | EVE/NE-30 | 40 | 10 | 0 | 30 | 20/0.7 wt % | 50.4 | 3.5 |
| P-11 | HFP | — | — | (MA-34) | EVE/FM-0721 | 50 | 0 | 0 | 30 | 20/4 wt % | 47.3 | 3.5 |
| P-12 | HFP | FPVE | M1-(43) | (MA-33)/ | EVE/VPS-1001 | 35 | 15 | 20 | 2/23 | 10/2 wt % | 57.1 | 3.0 |
| | | | | (MA-46) | | | | | | | | |
| P-13 | HFP | FPVE | M1-(43) | (MA-46) | EVE/VPS-1001 | 35 | 15 | 20 | 25 | 10/2 wt % | 56.8 | 3.5 |
| P-14 | HFP | FPVE | M1-(43) | (MA-56) | EVE/VPS-1001 | 35 | 15 | 20 | 25 | 10/2 wt % | 51.2 | 3.4 |
| P-15 | HFP | FPVE | M1-(1) | (MA-35)/ | EVE/VPS-1001 | 35 | 15 | 20 | 2/23 | 10/2 wt % | 51.8 | 3.3 |
| | | | | (MA-58) | | | | | | | | |
| P-16 | HFP | FPVE | M1-(43) | (MA-33)/ | EVE/FM-0721 | 35 | 15 | 20 | 2/23 | 10/2 wt % | 57.1 | 3.5 |
| | | | | (MA-46) | | | | | | | | |
| P-17 | HFP | FPVE | M1-(43) | (MA-46) | EVE/FM-0721 | 35 | 15 | 20 | 25 | 10/2 wt % | 56.8 | 3.5 |
| P-18 | HFP | FPVE | M1-(43) | (MA-56) | EVE/FM-0721 | 35 | 15 | 20 | 25 | 10/2 wt % | 51.2 | 3.5 |
| P-19 | HFP | FPVE | M1-(1) | (MA-33)/ | EVE/FM-0721/NE-30 | 35 | 15 | 20 | 20 | 15/2 wt %/0.7 wt % | 51.3 | 3.0 |
| | | | | (MA46) | | | | | | | | |
| P-20 | HFP | FPVE | M1-(1) | (MA-46) | EVE/FM-0721/NE-30 | 35 | 15 | 20 | 20 | 15/2 wt %/0.7 wt % | 51.0 | 3.0 |
| P-21 | HFP | FPVE | M1-(1) | (MA-56) | EVE/FM-0721/NE-30 | 35 | 15 | 20 | 20 | 15/2 wt %/0.7 wt % | 46.0 | 4.2 |
| P-22 | HFP | FPVE | — | (MA-56) | EVE/VPS-1001 | 50 | 0 | 0 | 15 | 35/2 wt % | 40.8 | 5.1 |
| P-23 | HFP | FPVE | — | (MA-56) | EVE/VPS-1001 | 40 | 10 | 0 | 15 | 35/2 wt % | 42.7 | 4.5 |
| P-24 | HFP | FPVE | — | (MA-56) | EVE/VPS-1001 | 35 | 15 | 0 | 15 | 35/2 wt % | 43.5 | 3.0 |
| P-25 | HFP | FPVE | M1-(43) | (MA-56) | EVE/VPS-1001 | 40 | 10 | 15 | 15 | 20/2 wt % | 52.5 | 3.5 |
| P-26 | HFP | FPVE | M1-(43) | (MA-56) | EVE/VPS-1001/NE-30 | 40 | 10 | 15 | 15 | 20/2 wt % | 52.1 | 4.0 |
| P-27 | HFP | FPVE | M1-(43) | (MA-37) | EVE/VPS-1001 | 35 | 15 | 20 | 25 | 10/2 wt % | 56.7 | 4.0 |
| P-28 | HFP | FPVE | — | (MA-56) | MA-33/EVE/VPS-1001 | 35 | 15 | 0 | 15 | 15/20/2 wt % | 42.8 | 3.0 |
| P-29 | HFP | FPVE | — | (MA-56) | MA-33/EVE/VPS-1001 | 35 | 15 | 0 | 15 | 15/20/2 wt % | 41.7 | 3.0 |

Abbreviations in the above-described table have the following meanings.

Component (MF1): HFP: hexafluoropropylene

Component (MF2): FPVE: perfluoro(propyl vinyl ether)

Component (MB): EVE: ethyl vinyl ether

VPS-1001 (azo group-containing polydimethylsiloxane, the molecular weight of a polysiloxane portion is about 10,000, manufactured by Wako Pure Chemical Industries, Ltd.)

FM-0721 (methacryloyl-modified dimethylsiloxane, average molecular weight: 5,000, manufactured by CHISSO Corporation)

NE-30 (reactive nonion emulsifier, containing an ethylene oxide portion, manufactured by ADEKA Corporation)

In the application composition of the present invention, a hardening catalyst, or a hardener or the like may be appropriately compounded, and known materials can be used. The application composition of the present invention contains a fluorine-containing polymer, hardening catalyst and solvent. Additionally, additives for promoting hardening and improving performances for use of the polymer, and the like, may be contained.

For example, when the polymer of the formula 1 contains a hydrolysable silyl group as a hardening-reactive portion, known acid or base catalysts can be compounded as a catalyst for a sol gel reaction, and examples thereof include inorganic Broensted acids such as hydrochloric acid, sulfuric acid, nitric acid and the like, organic Broensted acids such as oxalic acid, acetic acid, formic acid, methanesulfonic acid, p-toluenesulfonic acid and the like, Lewis acids such as dibutyltin dilaurate, dibutyltin diacetate, dibutyltin dioctate, triisopropoxyaluminum, tetrabutoxyzirconium and the like, inorganic bases such as sodium hydroxide, potassium hydroxide, ammonium and the like, organic bases such as triethylamine, pyridine, tetramethylethylenediamine and the like, and acid catalysts are particularly preferable, and of them, organic Broensted acids such as p-toluenesulfonic acid and the like or Lewis acids such as dibutyltin dilaurate and the like are preferable.

The addition amount of these hardening catalysts is arbitrary depending on the kind of the catalyst and difference of the hardening-reactive portion, and in general, it is preferably about 0.1 to 15 mass %, more preferably about 0.5 to 5 mass % with respect to the all solid components of the application composition. (In this specification, mass ratio is equal to weight ratio.)

### <Solvent of Application Liquid>

It is possible that (A) the hydrophobic polyrotaxane compound and (B) the fluorine-containing copolymer according to the present invention described above are combined to give a coating composition, and a low refractive index layer is formed from this composition. Though the solvent of the coating composition is not restricted, it is preferable that the composition contains at least two volatile solvents. For example, at least two solvents selected from alcohols and derivatives thereof, ethers, ketones, hydrocarbons and esters are preferably used in combination. The solvent can be selected from the standpoint of the solubility of a binder component, stability of inorganic fine particles, viscosity regulation of coating liquid, and the like.

Particularly preferable is a combination of at least two solvents selected from alcohols and derivatives thereof, ketones and esters, further preferably, a combination of three solvents selected from them. In preferable examples, two or three solvents selected from, for example, methyl ethyl ketone, methyl isobutyl ketone, cyclohexanone, 2-methoxypropanol, 2-butoxyethanol, isopropyl alcohol, toluene, propylene glycol monomethyl ether and propylene glycol monomethyl ether acetate can be used in combination.

In the present invention, a coated film can be obtained only with the components (A) and (B), however, it is also preferable that the low refractive index layer contains further (C) a compound having a plurality of unsaturated double bond groups in one molecule.

In the composition for forming a low refractive index layer of the present invention, the above-described component (A) and component (B), and a component (C) described later are not particularly restricted, and preferable is an application composition containing 1 to 30 wt % of the above-described component (A), 5 to 80 wt % of the above-described component (B) and 1 to 50 wt % of the component (C).

The above-described component (A) is contained in an amount of preferably 1 to 20 wt %, more preferably 5 to 20 wt %.

The above-described component (B) is contained in an amount of preferably 5 to 60 wt %, more preferably 5 to 40 wt %, further preferably 5 to 30 wt %.

The above-described component (C) is contained in an amount of preferably 5 to 50 wt %, more preferably 10 to 50 wt %, further preferably 15 to 50 wt %.

[Compound (C) having a Plurality of Unsaturated Double Bond Groups in One Molecule]

In the present invention, (C) a compound having a plurality of unsaturated double bond groups in one molecule may be used simultaneously as a hardener in the above-described fluorine-containing copolymer. The compound (C) is not particularly restricted providing it has a plurality of unsaturated double bond groups in one molecule, and various polyfunctional monomers can be preferably used from the standpoint of improvement in abrasion resistance and suppression of white turbidity of a coated film when used together with a polyrotaxane. The reason for this is estimated that compatibility with a polyrotaxane is improved as compared with the case of sole use of a fluorine-containing copolymer. The molecular weight of the above-described polyfunctional monomer is preferably 2,000 or less, more preferably 1,000 or less.

As the monomer, compounds having a polymerizable functional group such as a (meth)acryloyl group, vinyl group, styryl group, allyl group and the like are mentioned, and of them, a (meth)acryloyl group is preferable. Particularly preferably, compounds containing two or more (meth)acryloyl groups in one molecule can be used. These compounds show a significant simultaneous use effect for abrasion resistance or for amelioration of abrasion resistance after treatment with a chemical, particularly in the case of use of a compound having unsaturated double bond groups in a polymer body, thus, these compound are preferable.

Specific examples of the compound having unsaturated double bond groups include

(meth)acrylic diesters of alkylene glycol such as neopentyl glycol acrylate, 1,6-hexanediol(meth)acrylate, propylene glycol di(meth)acrylate and the like;

(meth)acrylic diesters of polyoxyalkylene glycol such as triethylene glycol di(meth)acrylate, dipropylene glycol di(meth)acrylate, polyethylene glycol di(meth)acrylate, polypropylene glycol di(meth)acrylate and the like;

(meth)acrylic diesters of polyvalent alcohol such as pentaerythritol di(meth)acrylate and the like;

(meth)acrylic diesters of ethylene oxide or propylene oxide addition product such as
2,2-bis{4-(acryloxy-diethoxy)phenyl}propane,
2,2-bis{4-(acryloxy-polypropoxi)phenyl)}propane, and the like.

Further, epoxy(meth)acrylates, urethane(meth)acrylates and polyester(meth)acrylates are also preferably used as the photopolymerizable polyfunctional monomer.

Particularly, esters of (meth)acrylic acid with polyvalent alcohols are preferable. Further preferable are polyfunctional monomers having three or more (meth)acryloyl groups in one molecular. Examples thereof include pentaerythritol tetra(meth)acrylate, pentaerythritol tri(meth)acrylate, trimethylolpropane tri(meth)acrylate, EO-modified trimethylolpropane tri(meth)acrylate, PO-modified trimethylolpropane tri(meth)acrylate, EO-modified phosphoric tri(meth)acrylate, trimethylolethane tri(meth)acrylate, ditrimethylolpropane tetra(meth)acrylate, dipentaerythritol tetra(meth)acrylate, dipentaerythritol penta(meth)acrylate, dipentaerythritol hexa(meth)acrylate, pentaerythritol hexa(meth)acrylate, 1,2,3-chlorohexane tetramethacrylate, polyurethane polyacrylate, polyester polyacrylate, caprolactone-modified tris(acryloxyethyl) isocyanurate and the like.

Specific compounds of the polyfunctional acrylate compounds having a (meth)acryloyl group include ester compounds of polyols with (meth)acrylic acid, such as KAYARAD DPHA, DPHA-2C, PET-30, TMPTA, TPA-320, TPA-330, RP-1040, T-1420, D-310, DPCA-20, DPCA-30, DPCA-60, GPO-303 manufactured by Nippon Kayaku Co. Ltd., and V#3PA, V#400, V#36095D, V#1000, V#1080 and the like manufactured by Osaka Organic Chemical Industry Ltd. Also, 3- or more-functional urethane acrylate compound such as SHIKOU UV-1400B, UV-1700B, UV-6300B, UV-7550B, UV-7600B, UV-7605B, UV-7610B, UV-7620EA, UV-7630B, UV-7640B, UV-6630B, UV-7000B, UV-7510B, UV-7461TE, UV-3000B, UV-3200B, UV-3210EA, UV-3310EA, UV-3310B, UV-3500BA, UV-3520TL, UV-3700B, UV-6100B, UV-6640B, UV-2000B, UV-2010B, UV-2250EA, UV-2750B (manufactured by Nippon Synthetic Chemical Industry Co., Ltd.), UL-503LN (Kyoeisha Kagaku K.K.), UNIDICK 17-806, 17-813, V-4030, V-4000BA (manufactured by Dainippon Ink and Chemicals Inc.), EB-1290K, EB-220, EB-5129, EB-1830, EB-4858 (manufactured by Daicel UCB K.K.), HIGHCOPE AU-2010, AU-2020 (manufactured by TOKUSHIKI K.K.), Aronics M-1960 (manufactured by TOAGOSEI Co., LTd.), Artresin UN-3320HA, UB-3320HC, UN-3320HS, UN-904, HDP-4T and the like, and 3- or more functional polyester compounds such as Aronics M-8100, M-8030, M-9050 (manufactured by TOAGOSEI Co., Ltd.), KRM-8307 (manufactured by Daicel-Cytec), and the like, can be suitably used.

Further mentioned are resins having 3 or more (meth)acryloyl groups, for example, polyester resins of relatively low molecular weight, polyether resins, acrylic resins, epoxy resins, urethane resins, alkyd resins, spiroacetal resins, polybutadiene resins, polythiol polyene resins, oligomers or prepolymers of polyfunctional compounds such as poly-hydric alcohols, and the like.

As the monomer binder, dendrimers described for example in JP-A Nos. 2005-76005 and 2005-36105, and norbornene ring-containing monomers described for example in JP-A No. 2005-60425, can also be used.

The polyfunctional monomers may be used in combination of two or more.

Polymerization of these monomers having an ethylenically unsaturated group can be carried out by heating or irradiation with an ionizing radiation in the presence of a photoradical initiator or thermoradical initiator.

In the polymerization reaction of the photopolymerizable polyfunctional monomer, a photopolymerization initiator is preferably used. As the photopolymerization initiator, photoradical polymerization initiators and photocation polymerization initiators are preferable, and photoradical polymerization initiators are particularly preferable.

### [Organosilane Compound]

In the present invention, at least one component (so-called sol component (hereinafter, referred to like this in some cases)) of a hydrolysate and/or partial condensate thereof of an organosilane compound is also preferably contained as the compound (C) having a plurality of unsaturated double bond groups in one molecule. Simultaneous use of a polyrotaxane is preferable from the standpoint of obtaining excellent abrasion resistance while suppressing white turbidity of a coated film.

This sol component is condensed in a drying and heating process after application of application liquid, thereby forming a hardened material as a part of a binder of the above-described layer. When the hardened material has a polymerizable unsaturated bond, a binder having a three-dimensional structure is formed by irradiation with an active beam.

As the organosilane compound, those of the following formula 1 are preferable.

(R¹)ₘ—Si(X)₄₋ₘ Formula 1:

In the above-described formula 1, R¹ represents a substituted or un-substituted alkyl group, or substituted or un-substituted aryl group. As the alkyl group, alkyl groups having 1 to 30 carbon atoms are preferable, and the carbon number thereof is more preferably 1 to 16, particularly preferably 1 to 6. Specific examples of the alkyl group include methyl, ethyl, propyl, isopropyl, hexyl, decyl, hexadecyl and the like. The aryl group includes phenyl, naphthyl and the like, and a phenyl group is preferable.

X represents a hydroxyl group or hydrolysable group, and examples thereof include alkoxy groups (alkoxy groups having 1 to 5 carbon atoms are preferable. For example, a methoxy group, ethoxy group and the like are mentioned), halogen atoms (for example, Cl, Br, I and the like), and groups represented by R²COO (R² represents preferably a hydrogen atom or alkyl group having 1 to 6 carbon atoms. For example, CH₃COO, C₂H₅COO and the like are listed), and preferable are alkoxy groups, particularly preferable is a methoxy group or ethoxy group.

m represents an integer of 1 to 3, preferably 1 to 2.

When there exist a plurality of Xs, the plurality of Xs may be the same or different.

The substituent contained in R¹ is not particularly restricted, and includes halogen atoms (fluorine, chlorine, bromine and the like), hydroxyl group, mercapto group, carboxyl group, epoxy group, alkyl groups (methyl, ethyl, i-propyl, propyl, t-butyl and the like), aryl groups (phenyl, naphthyl and the like), aromatic heterocyclic groups (furyl, pyrazolyl, pyridyl and the like), alkoxy groups (methoxy, ethoxy, i-propoxy, hexyloxy and the like), aryloxy groups (phenoxy and the like), alkylthio groups (methylthio, ethylthio and the like), arylthio groups (phenylthio and the like), alkenyl groups (vinyl, 1-propenyl and the like), acyloxy groups (acetoxy, acryloyloxy, methacryloyloxy and the like), alkoxycarbonyl groups (methoxycarbonyl, ethoxycarbonyl and the like), aryloxycarbonyl groups (phenoxycarbonyl and the like), carbamoyl groups (carbamoyl, N-methylcarbamoyl, N,N-dimethylcarbamoyl, N-methyl-N-octylcarbamoyl and the like), acylamino groups (acetylamino, benzoylamino, acrylamino, methacrylamino and the like), and the like, and these substituents may be further substituted.

R¹ represents preferably a substituted alkyl group or substituted aryl group, and of them, preferable are organosilane compounds having a vinyl-polymerizable substituent of the following formula 2.

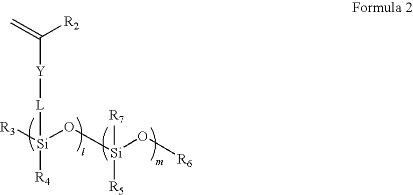

In the above-described formula 2, R₂ represents a hydrogen atom, methyl group, methoxy group, alkoxycarbonyl group, cyano group, fluorine atom or chlorine atom. The alkoxycarbonyl group includes a methoxycarbonyl group, ethoxycarbonyl group and the like. Preferable are a hydrogen atom, methyl group, methoxy group, methoxycarbonyl group, cyano group, fluorine atom and chlorine atom, further preferable are a hydrogen atom, methyl group, methoxycarbonyl group, fluorine atom and chlorine atom, and particularly preferable are a hydrogen atom and methyl group.

Y represent a single bond or *—COO—**, *—CONH—** or *—O—**, and a single bond, *—COO—** and *—CONH—** are preferable, a single bond and *—COO—** are further preferable, and *—COO—** is particularly preferable. * represents a position of connection to ═C(R₁)—, and ** represents a position of connection to L.

L represents a divalent linkage chain. Specifically mentioned are substituted or un-substituted alkylene groups, substituted or un-substituted arylene groups, substituted or un-substituted alkylene groups having inside a linkage group (for example, ether, ester, amide and the like) and substituted or un-substituted arylene groups having inside a linkage group, and preferable are substituted or un-substituted alkylene groups, substituted or un-substituted arylene groups and alkylene groups having inside a linkage group, further preferable are un-substituted alkylene groups, un-substituted arylene groups and alkylene groups having inside an ether or ester linkage group, and particularly preferable are un-substituted alkylene groups and alkylene groups having inside an ether or ester linkage group. The substituent includes halogens, hydroxyl group, mercapto group, carboxyl group, epoxy group, alkyl groups, aryl groups and the like, and these substituents may be further substituted.

1 represents a number satisfying the numerical formula: I=100−m, and m represents a number of 0 to 50. m represents further preferably a number of 0 to 40, particularly preferably a number of 0 to 30.

R₃ to R₅ represent preferably a halogen atom, hydroxyl group, un-substituted alkoxy group or un-substituted alkyl group. R₃ to R₅ represent more preferably a chlorine atom, hydroxyl group or un-substituted alkoxy group having 1 to 6 carbon atoms, further preferably a hydroxyl group or alkoxy group having 1 to 3 carbon atoms, particularly preferably a hydroxyl group or methoxy group.

R₆ represents a hydrogen atom or alkyl group. As the alkyl group, a methyl group, ethyl group and the like are preferable.

R₇ is the same as R₁ in the above-described formula 1, and represents more preferably a hydroxyl group or un-substituted alkyl group, further preferably a hydroxyl group of alkyl group having 1 to 3 carbon atom, particularly preferably a hydroxyl group or methyl group.

The compounds of the formula 1 may be used in combination of two or more kinds. In particular, the compound of the formula 2 is synthesized by using two compounds of the formula 1 as starting materials. Specific examples of the starting materials of the compound of the formula 1 and the compound of the formula 2 include, but not limited to, materials shown below.

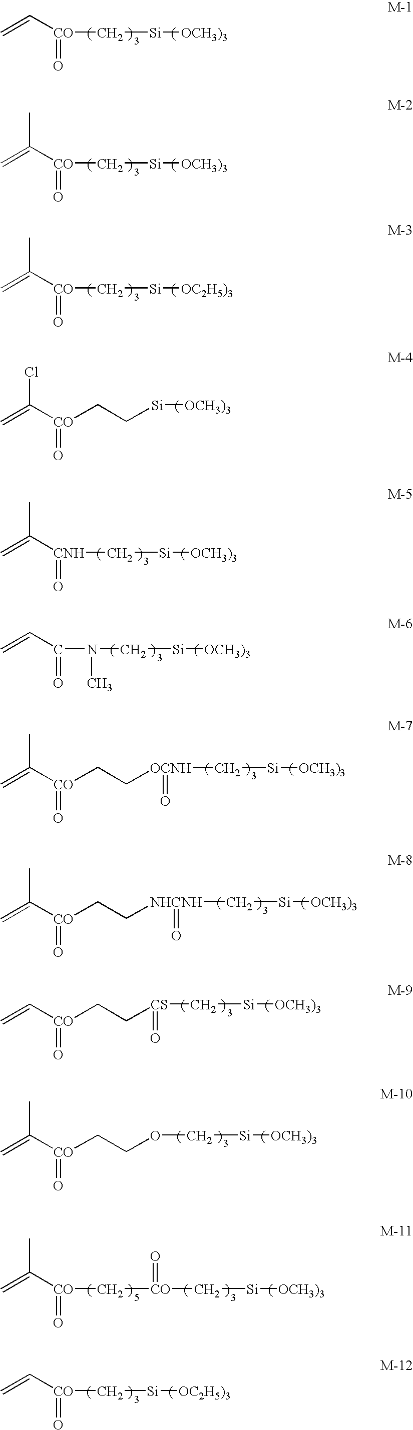

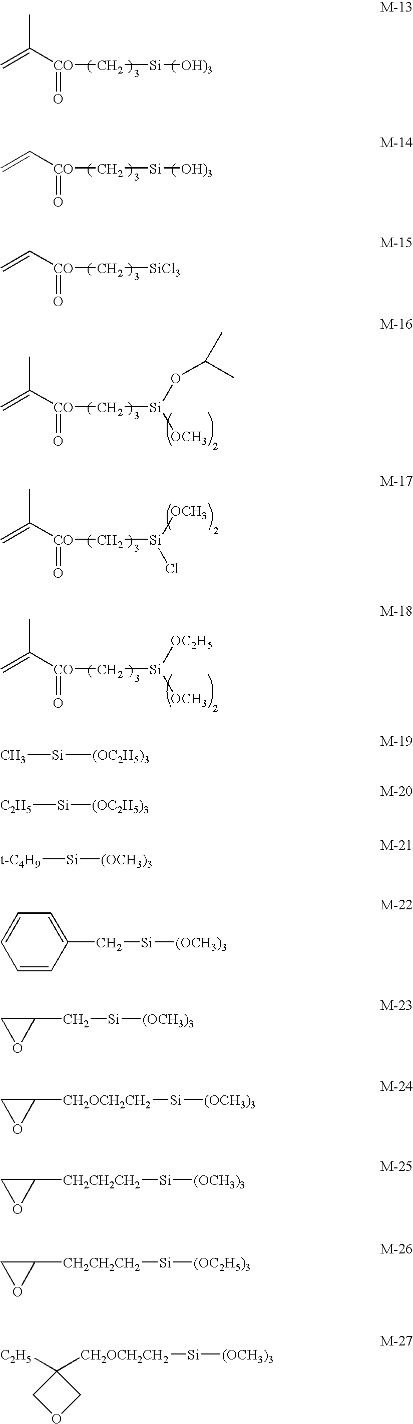

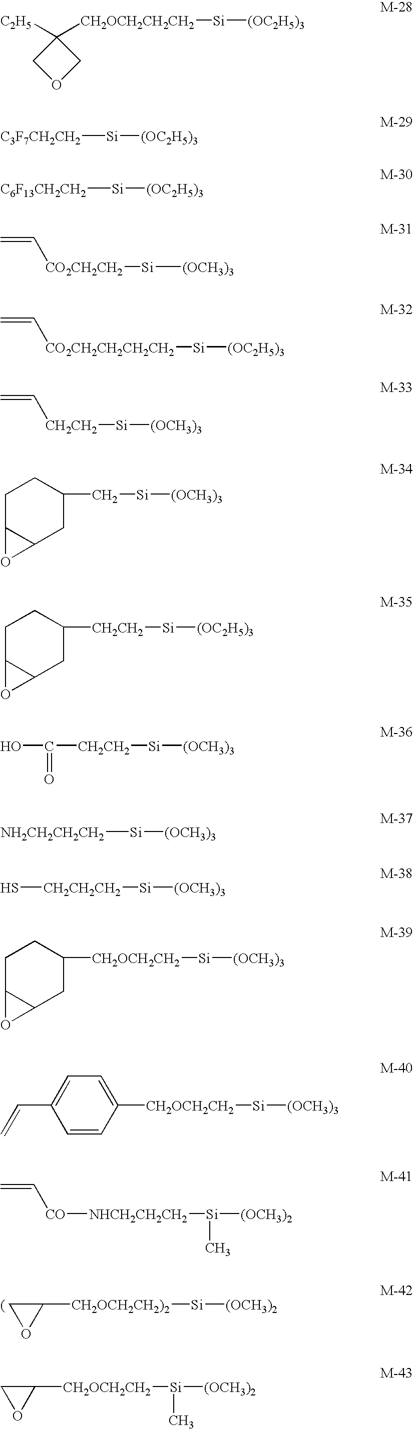

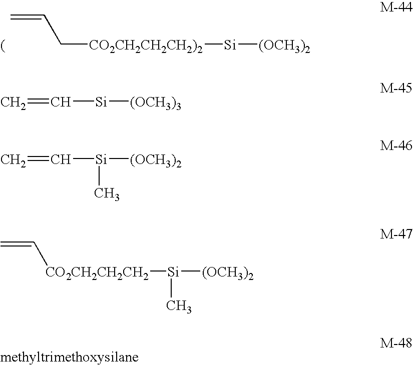

Of them, particularly preferable as the organosilane containing a polymerizable group are (M-1), (M-2) and (M-25).

For obtaining the effect of the present invention, the content of the organosilane containing the above-described vinyl-polymerizable group in the organosilane hydrolysate and/or partial condensate thereof is preferably 30 mass % to 100 mass %, more preferably 50 mass % to 100 mass %, further preferably 70 mass % to 95 mass %. When the content of the organosilane containing the above-described vinyl-polymerizable group is less than 30 mass %, there occur undesirable phenomena that a solid component is generated, liquid becomes turbid, pot life deteriorates, control of the molecular weight is difficult (increase of molecular weight), and because of small content of the polymerizable group, improvement in performances (for example, abrasion resistance of anti-reflection film) in the case of polymerization treatment is not obtained easily. When the compound of the formula 2 is synthesized, it is preferable that one compound from (M-1) and (M-2) as the organosilane containing the above-described vinyl-polymerizable group and one compound from (M-19) to (M-21) and (M-48) as the organosilane containing no vinyl-polymerizable group are used in combination in amounts described above, respectively.

It is preferable to suppress volatility, for stabilization of performances of an applied article, in at least either one of the organosilane hydrolysate and partial condensate thereof of the present invention, and specifically, the volatilization amount per hour at 105° C. is preferably 5 mass % or less, more preferably 3 mass % or less, particularly preferably 1 mass % or less.

The content of the organosilane containing the above-described vinyl-polymerizable group in at least either one of the organosilane hydrolysate and partial condensate thereof of the present invention is preferably 30 mass % to 100 mass %, more preferably 50 mass % to 100 mass %, further preferably 70 mass % to 100 mass %. When the content of the organosilane containing the above-described vinyl-polymerizable group is less than 30 mass %, there occur undesirable phenomena that a solid component is generated, liquid becomes turbid, pot life deteriorates, control of the molecular weight is difficult (increase of molecular weight), and because of small content of the polymerizable group, improvement in performances (for example, abrasion resistance of anti-reflection film) in the case of polymerization treatment is not obtained easily.

The sol component used in the present invention is prepared by hydrolysis and/or partial condensation of the above-described organosilane. In the hydrolysis condensation reaction, water is added in an amount of 0.05 to 2.0 mol, preferably 0.1 to 1.0 mol with respect to 1 mol of the hydrolysable ground (X), and the reaction mixture is stirred at 25 to 100° C. in the presence of the catalyst to be used in the present invention.

In at least either one of the organosilane hydrolysate and partial condensate thereof of the present invention, the weight average molecular weight of either one of the organosilane hydrolysate containing a vinyl-polymerizable group and partial condensate thereof is preferably 450 to 10,000, more preferably 500 to 5,000, further preferably 550 to 3,000, in the case of exclusion of components having a molecular weight of less than 300.

Among components of the organosilane hydrolysate and partial condensate thereof having a molecular weight of 300 or more, the proportion of components having a molecular weight of 20,000 or more is preferably 10 mass % or less, more preferably 5 mass % or less, further preferably 3 mass % or less. When the proportion is over 10 mass %, a hardened film obtained by hardening a hardening composition containing the organosilane hydrolysate and/or partial condensate thereof is poor in transparency and close adherence with a substrate in some cases.

Here, the weight average molecular weight and molecular weight are molecular weights represented in terms of polystyrene obtained by a differential refractive index detector, using a GPC analysis apparatus using a column such as TSKgel GMHxL, TSKgel G4000HxL, TSKgel G2000HxL (all of them are trade names, manufactured by Tosoh Corporation), using THF as a solvent, and the content is an area % of peak in the above-described molecular weight range when the peak area of components having a molecular weight of 300 or more is 100%.

The degree of dispersion (weight average molecular weight/number average molecular weight) is preferably 3.0 to 1.1, more preferably 2.5 to 1.1, further preferably 2.0 to 1.1, and particularly preferably 1.5 to 1.1.

By ²⁹Si-NMR analysis of the organosilane hydrolysate and partial condensate thereof of the present invention, the condition of condensation of X in the formula 1 in the form of —OSi can be confirmed.

In this instance, when three bonds of Si are condensed in the form of —OSi (T3), when two bonds of Si are condensed in the form of —OSi (T2), when one bond of Si is condensed in the form of —OSi (T1), and when Si is not condensed at all (T0), the condensation ratio α is represented by

numerical formula (II): α=(T3×3+T2×2+T1×1)/3/(T3+T2+T1+T0)

and the condensation ratio is preferably 0.2 to 0.95, more preferably 0.3 to 0.93, particularly preferably 0.4 to 0.9.

When smaller than 0. 1, hydrolysis and condensation are not sufficient and monomer components increase, leading to insufficient hardening, and when larger than 0.95, hydrolysis and condensation progress too excessively and hydrolysable groups are consumed, thus, an mutual action of a binder polymer, resin substrate, inorganic fine particles and the like lowers, and an effect is not obtained easily even if these components are used.

Details of the organosilane compound hydrolysate and partial condensate thereof to be used in the present invention will be illustrated.

The organosilane hydrolysis reaction, and the subsequent condensation reaction are generally carried out in the presence of a catalyst. Mentioned as the catalyst are inorganic acids such as hydrochloric acid, sulfuric acid, nitric acid and the like; organic acids such as oxalic acid, acetic acid, butyric acid, maleic acid, citric acid, formic acid, methanesulfonic acid, toluenesulfonic acid and the like; inorganic bases such as sodium hydroxide, potassium hydroxide, ammonia and the like; organic bases such as triethylamine, pyridine and the like; metal alkoxides such as triisopropoxyaluminum, tetrabutoxyzirconium, tetrabutyltitanate, dibutyltin dilaurate and the like; metal chelate compounds containing as the center metal a metal such as Zr, Ti, Al or the like; F-containing compounds such as KF, NF4F and the like.

The above-described catalysts may be used singly or in combination of two or more.

The organosilane hydrolysis• condensation reaction can be carried out without solvent or in a solvent, and it is preferable to use an organic solvent for uniform mixing of components, and for example, alcohols, aromatic hydrocarbons, ethers, ketones, esters and the like are suitable.

As the solvent, those dissolving the organosilane and catalyst are preferable. It is preferable to use an organic solvent as application liquid or as a part of application liquid from the standpoint of the process, and those not losing dissolvability or dispersibility in the case of mixing with other material such as a fluorine-containing polymer or the like are preferable.

Among them, for example, mono-hydric alcohols or di-hydric alcohols are mentioned as alcohols, and as the mono-hydric alcohol, saturated aliphatic alcohols having 1 to 8 carbon atoms are preferable.

Specific examples of these alcohols include methanol, ethanol, n-propyl alcohol, i-propyl alcohol, n-butyl alcohol, sec-butyl alcohol, tert-butyl alcohol, ethylene glycol, diethylene glycol, triethylene glycol, ethylene glycol monobutyl ether, ethylene glycol monoethyl ether acetate and the like.

Specific examples of the aromatic hydrocarbons include benzene, toluene, xylene and the like, specific examples of the ethers include tetrahydrofuran, dioxane and the like, specific examples of the ketones include acetone, methyl ethyl ketone, methyl isobutyl ketone, diisobutyl ketone, cyclohexanone and the like, and specific examples of the esters include ethyl acetate, propyl acetate, butyl acetate, propylene carbonate, and the like.

These organic solvents can be used singly or in admixture of two or more. The concentration of solid components in the reaction is not particularly restricted, and usually it is in the range of 1% to 100%.

Water is added in an amount of 0.05 to 2 mol, preferably 0.1 to 1 mol with respect to 1 mol of a hydrolysable group of the organosilane, and the mixture is stirred at 25 to 100° C. in the presence or absence of the above-described solvent and in the presence of a catalyst.

In the present invention, it is preferable to carry out hydrolysis by stirring at 25 to 100° C. in the presence of at least one metal chelate compound having as the center metal a metal selected from Zr, Ti or Al and having, as the ligand, an alcohol of the formula R³OH (wherein, R³ represents an alkyl group having 1 to 10 carbon atoms) and a compound of the formula R⁴COCH₂COR⁵ (wherein, R⁴ represents an alkyl group having 1 to 10 carbon atoms, R⁵ represents an alkyl group having 1 to 10 carbon atoms or an alkoxy group having 1 to 10 carbon atoms).

Alternatively, when a F-containing compound is used as the catalyst, the F-containing compound has an ability of completely progressing the hydrolysis-condensation, therefore, the degree of polymerization can be determined by selecting the quantity of water to be added, and it becomes possible to set any molecular weight, thus, use of the F-containing compound is preferable. That is, for preparing an organosilane hydrolysate/partial condensate having an average degree of polymerization of M, it is recommendable to use water in an amount of (M-1) mol with respect to M mol of hydrolysable organosiloxane.

As the metal chelate compound, those having as the center metal a metal selected from Zr, Ti and Al and having, as the ligand, an alcohol of the formula R³OH (wherein, R³ represents an alkyl group having 1 to 10 carbon atoms) and a compound of the formula R⁴COCH₂COR⁵ (wherein, R⁴ represents an alkyl group having 1 to 10 carbon atoms, R⁵ represents an alkyl group having 1 to 10 carbon atoms or an alkoxy group having 1 to 10 carbon atoms) can be suitably used without particular limitation. In this range, two or more metal chelate compounds may be used simultaneously. As the metal chelate compound to be used in the present invention, preferable are those selected from the compound group of the formula Zr(OR³)ₚ₁(R⁴COCHCOR⁵)ₚ₂, Ti(OR³)_{q1}(R⁴COCHCOR⁵)_{q2} and Al(OR³)ᵣ₁(R⁴COCHCOR⁵)ᵣ₂, and these chelate compounds perform an action of promoting a condensation reaction of the above-described organosilane compound hydrolysate and partial condensate thereof.

R³ and R⁴ in the metal chelate compound may be the same or different, and represent an alkyl group having 1 to 10 carbon atoms, specifically, an ethyl group, n-propyl group, i-propyl group, n-butyl group, sec-butyl group, t-butyl group, n-pentyl group, phenyl group or the like. R⁵ represents an alkoxy group having 1 to 10 carbon atoms, for example, a methoxy group, ethoxy group, n-propoxy group, i-propoxy group, n-butoxy group, sec-butoxy group, t-butoxy group or the like, in addition to the same alkyl groups having 1 to 10 carbon atoms as described above. p1, p2, q1, q2, r1 and r2 in the metal chelate compound represent integers which are determined so that p1+p2=4, q1+q2=4 and r1+r2=3, respectively.

Specific examples of these metal chelate compounds include zirconium chelate compounds such as tri-n-butoxyethyl acetoacetate zirconium, di-n-butoxy bis(ethylacetoacetate)zirconium, n-butoxy tris(ethylacetoacetate)zirconium, tetrakis(n-propylacetoacetate)zirconium, tetrakis(acetylacetoacetate)zirconium, tetrakis(ethylacetoacetate)zirconium and the like; titanium chelate compounds such as diisopropoxy•bis(ethylacetoacetate)titanium, diisopropoxy-bis(acetylacetate)titanium, diisopropoxy•bis(acetylacetone)titanium and the like; aluminum chelate compounds such as diisopropoxy ethylacetoacetate aluminum, diisopropoxy acetylacetoacetate aluminum, isopropoxy bis(ethylacetoacetate)aluminum, isopropoxy bis(acetylacetonate)aluminum, tris(ethylacetoacetate)aluminum, tris(acetylacetonate)aluminum, monoacetylacetonate•bis(ethylacetoacetate)aluminum and the like.

Of these metal chelate compounds, preferable are tri-n-butoxy ethylacetoacetate zirconium, diisopropoxy bis(acetylacetonate)titanium, diisopropoxy ethylacetoacetate aluminum and tris(ethylacetoacetate)aluminum. These metal chelate compounds can be used singly or in admixture of two or more. It is also possible to use partial hydrolysates of these metal chelate compounds.

The metal chelate compound is used in a proportion of preferably 0.01 to 50 mass %, more preferably 0.1 to 50 mass %, further preferably 0.5 to 10 mass % with respect to the above-described organosilane compound. By use of the metal chelate compound in the above-described range, the condensation reaction of the organosilane compound progresses quickly, durability of a coated film is excellent, and the storage stability of a composition containing the metal chelate compound and the organosilane compound hydrolysate and partial condensate thereof is excellent.

In the application liquid to be used in the present invention, at least any one of β-diketone compound and β-ketoester compound is preferably added, in addition to the above-described composition containing the sol component and metal chelate compound.

Used in the present invention is at least any one of β-ketoester compound and β-diketone compound of the formula R⁴COCH₂COR⁵, and this compound acts as a stability improver for the composition to be used in the present invention. Namely, it is believed that, by coordinating to a metal atom in the above-described metal chelate compound (at least any one compound from zirconium, titanium and aluminum compounds), the action of promoting the condensation reaction of the organosilane compound hydrolysate and partial condensate thereof by these metal chelate compounds is suppressed, and the storage stability of the resultant composition is improved. R⁴ and R⁵ constituting the β-diketone compound and β-ketoester compound are the same as R⁴ and R⁵ constituting the above-described metal chelate compound.

Specific examples of the β-diketone compound and β-ketoester compound include acetylacetone, methyl acetoacetate, ethyl acetoacetate, n-propyl acetoacetate, i-propyl acetoacetate, n-butyl acetoacetate, sec-butyl aceloacetate, t-butyl acetoacetate, 2,4-hexane-dione, 2,4-heptane-dione, 3,5-heptane-dione, 2,4-octane-dione, 2,4-nonane-dion, 5-methyl-hexane-dione and the like. Of them, ethyl acetoacetate and acetylacetone are preferable, and particularly, acetylacetone is preferable. These β-diketone compounds and β-ketoester compounds can be used singly or in admixture of two or more. In the present invention, the β-diketone compound and β-ketoester compound are used in an amount of 2 mol or more, more preferably 3 to 20 mol with respect to 1 mol of the metal chelate compound. When less than 2 mol, there is an undesirable possibility of poor storage stability of the resultant composition.

It is preferable that the content of the above-described organosilane compound hydrolysate and partial condensate thereof is small in the case of a relatively thin anti-reflection layer, and large in the case of a thick hard coat layer or anti-dazzling layer. The content is preferably 0.1 to 50 mass %, more preferably 0.5 to 30 mass %, most preferably 1 to 15 mass % based on all solid components of the containing layer (addition layer) in view of manifestation of the effect, refractive index, film shape and surface condition, and the like.

### [Fluorine-Containing Polyfunctional Monomer]

In the present invention, a fluorine-containing polyfunctional monomer having two or more polymerizable groups and having a fluorine content of 20.0 mass % or more may be used simultaneously as one of the component (C).

By simultaneous use of a compound containing no fluorine as the compound (C) having a plurality of unsaturated double bond groups in one molecule, it is possible to obtain abrasion resistance and suppress white turbidity of a coated film in simultaneous use with a polyrotaxane compound. To much addition is not preferable due to increase in refractive index. Then, by use of a fluorine-containing polyfunctional monomer, there can be obtained an excellent effect of improving abrasion resistance with low refractive index, while suppressing white turbidity of a coated film.

Specifically, the following compound (X-33) can also be used preferably, in addition to X-2 to 4, X-6, X-8 to 14, X-21 to 32 described in paragraph numbers [0023] to [0027] of JP-A No. 2006-28409.

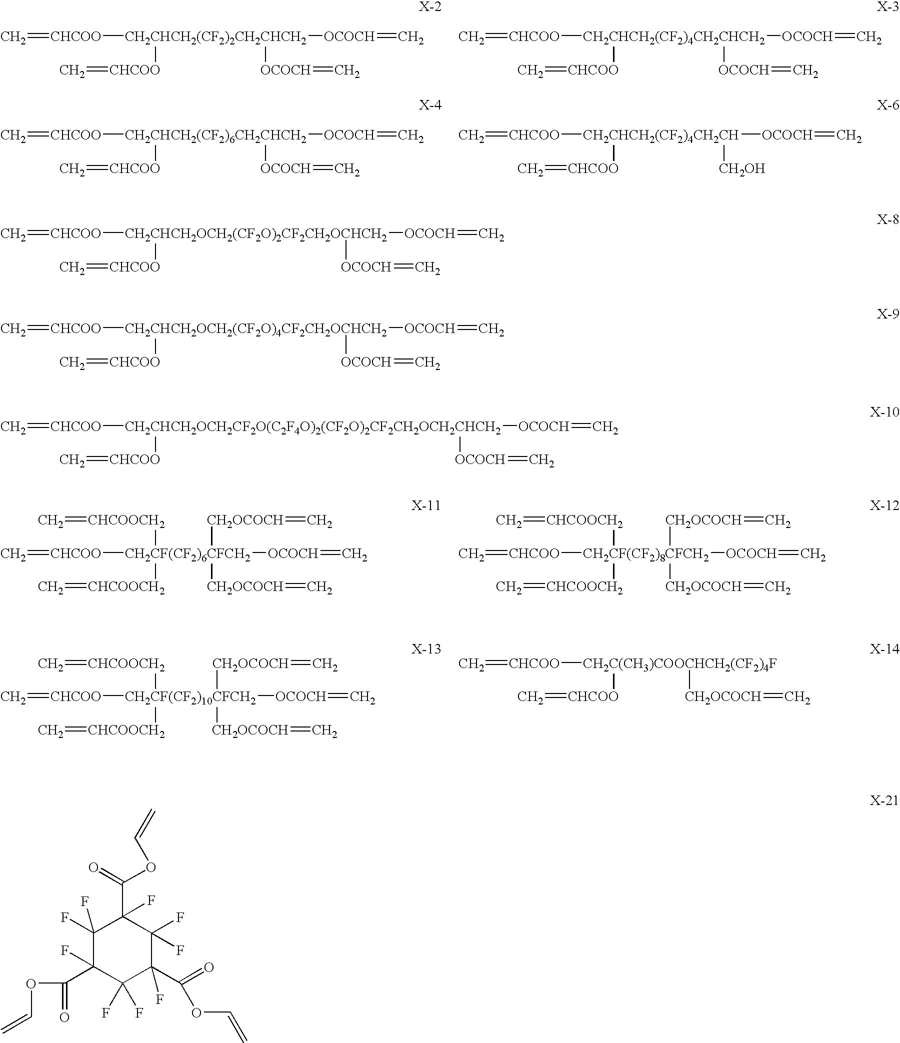

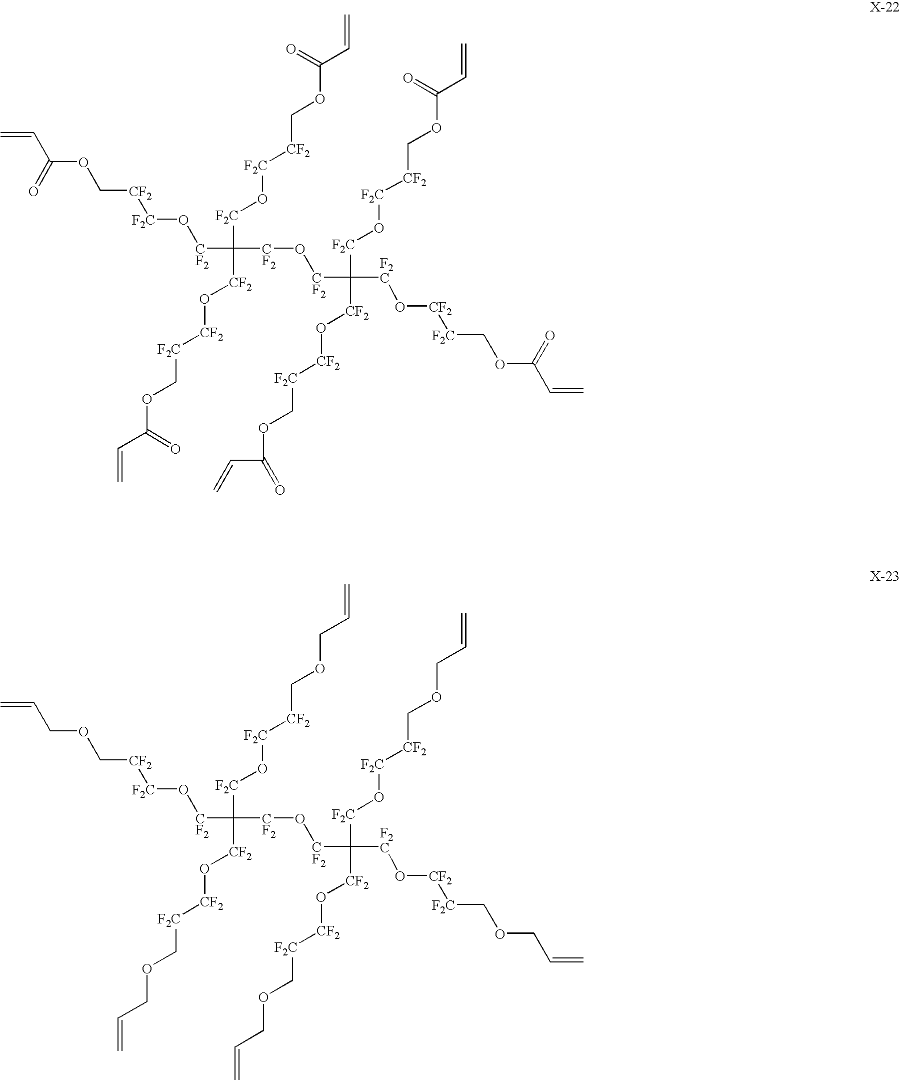

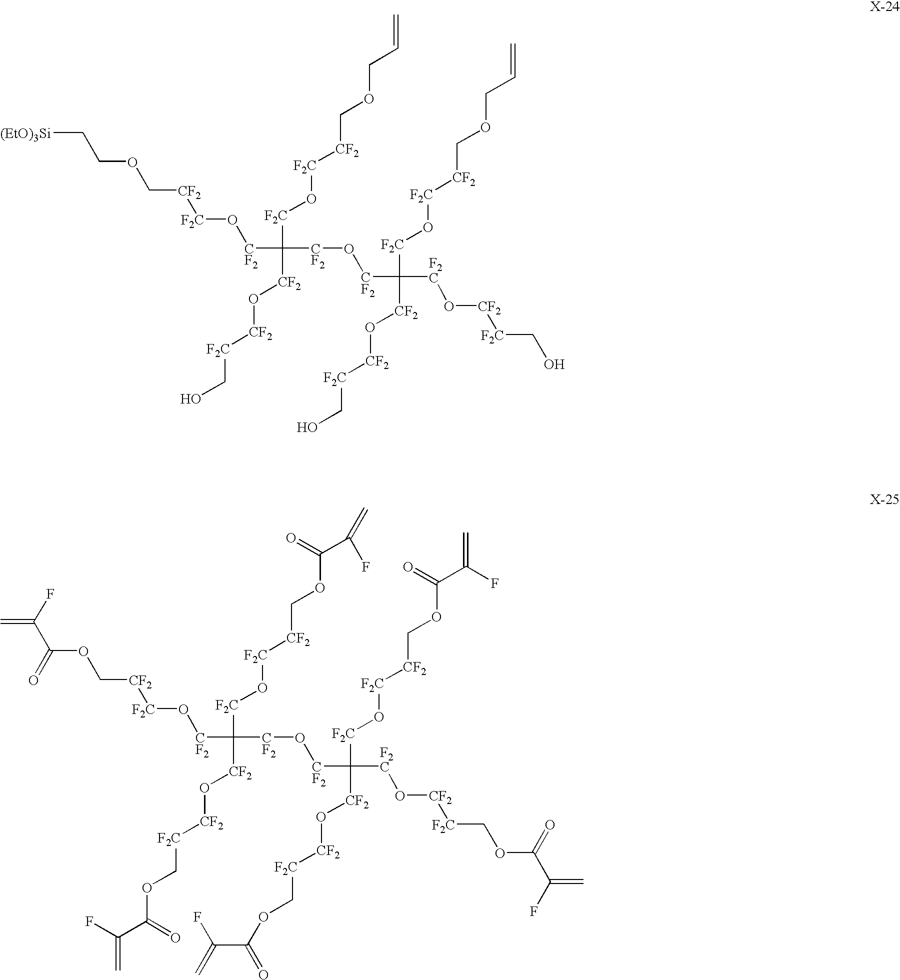

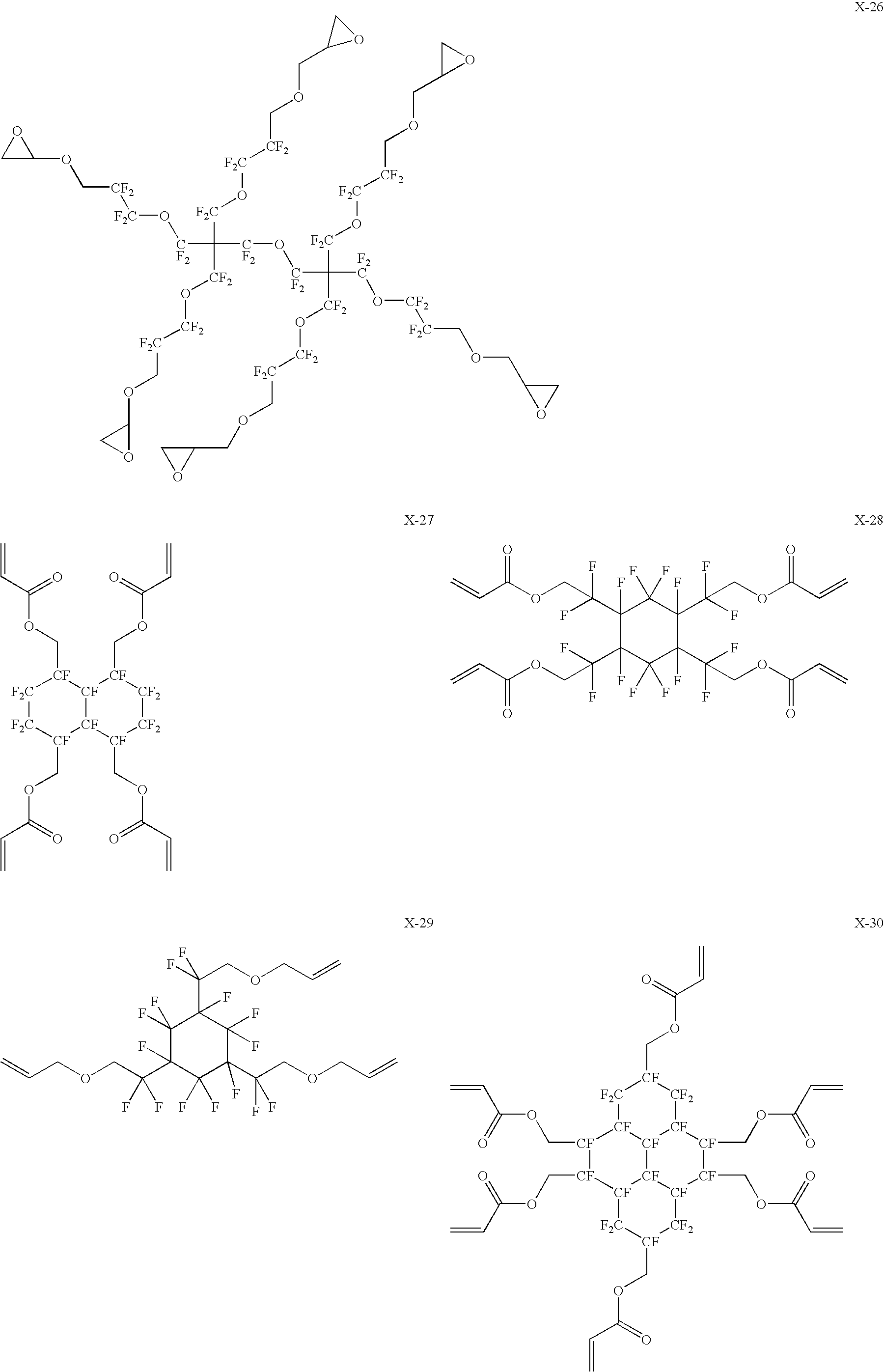

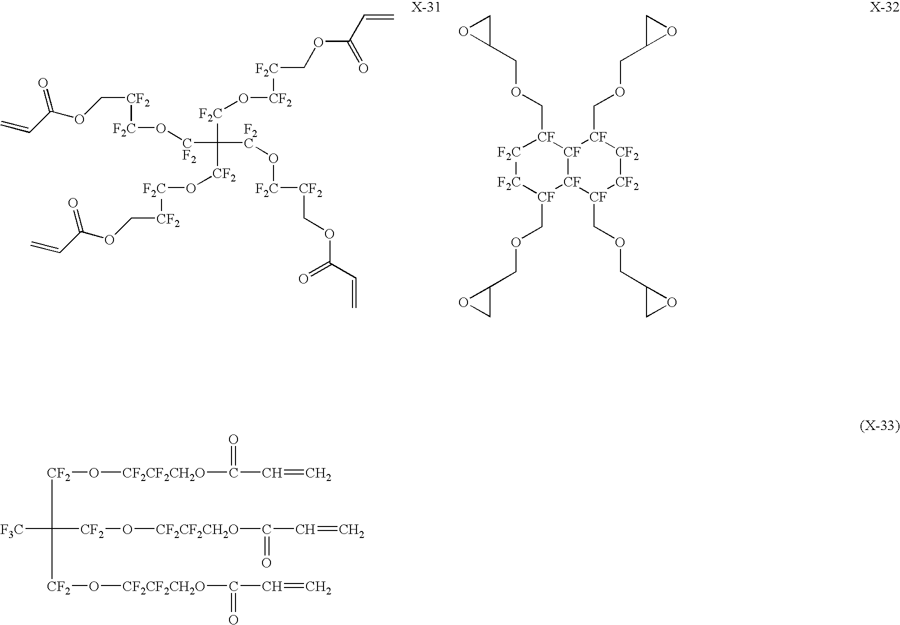

Further, the following M-1 to M-16 described in paragraph numbers [0062] to [0065] of JP-A No. 2006-284761 can also be used preferably.

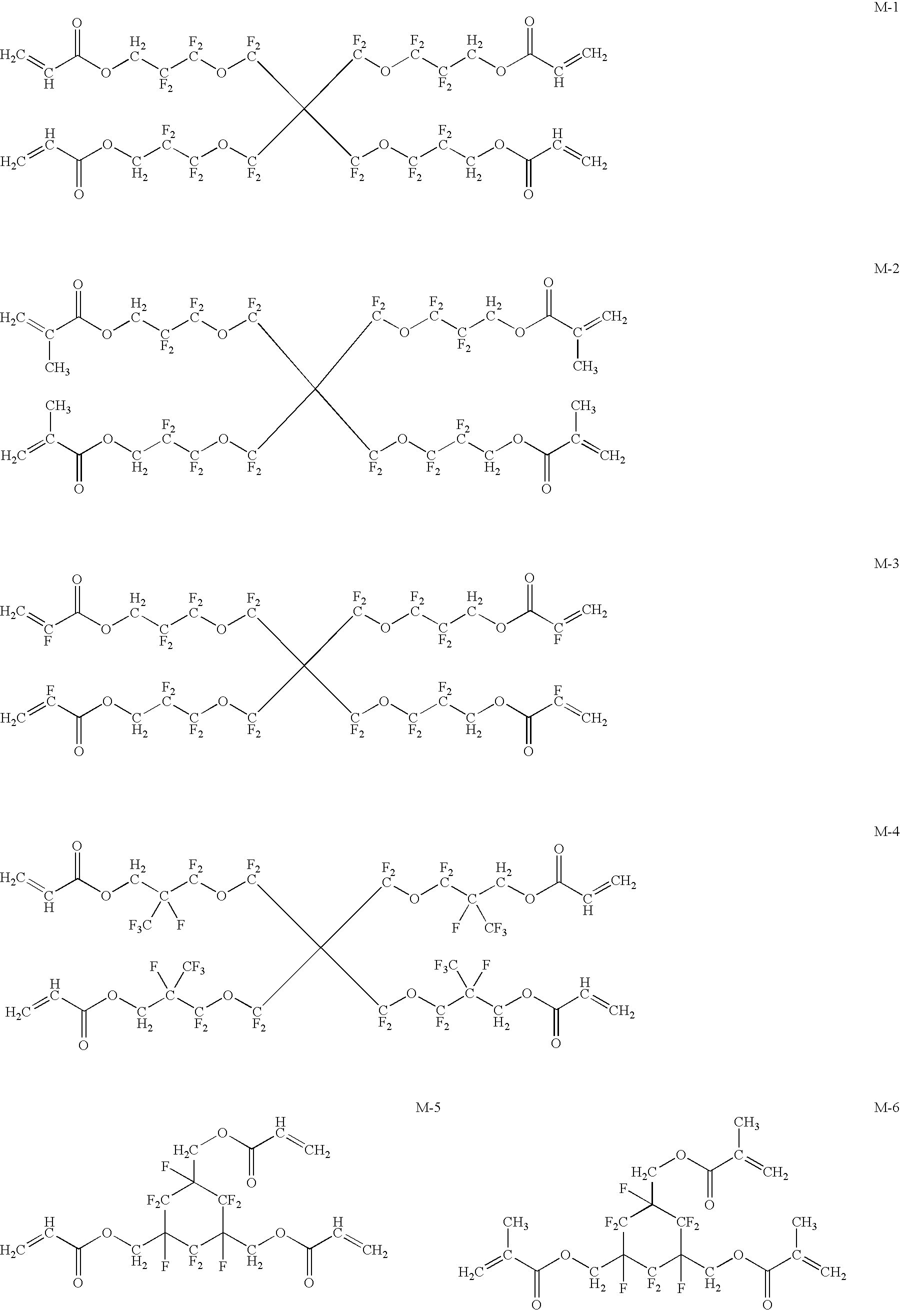

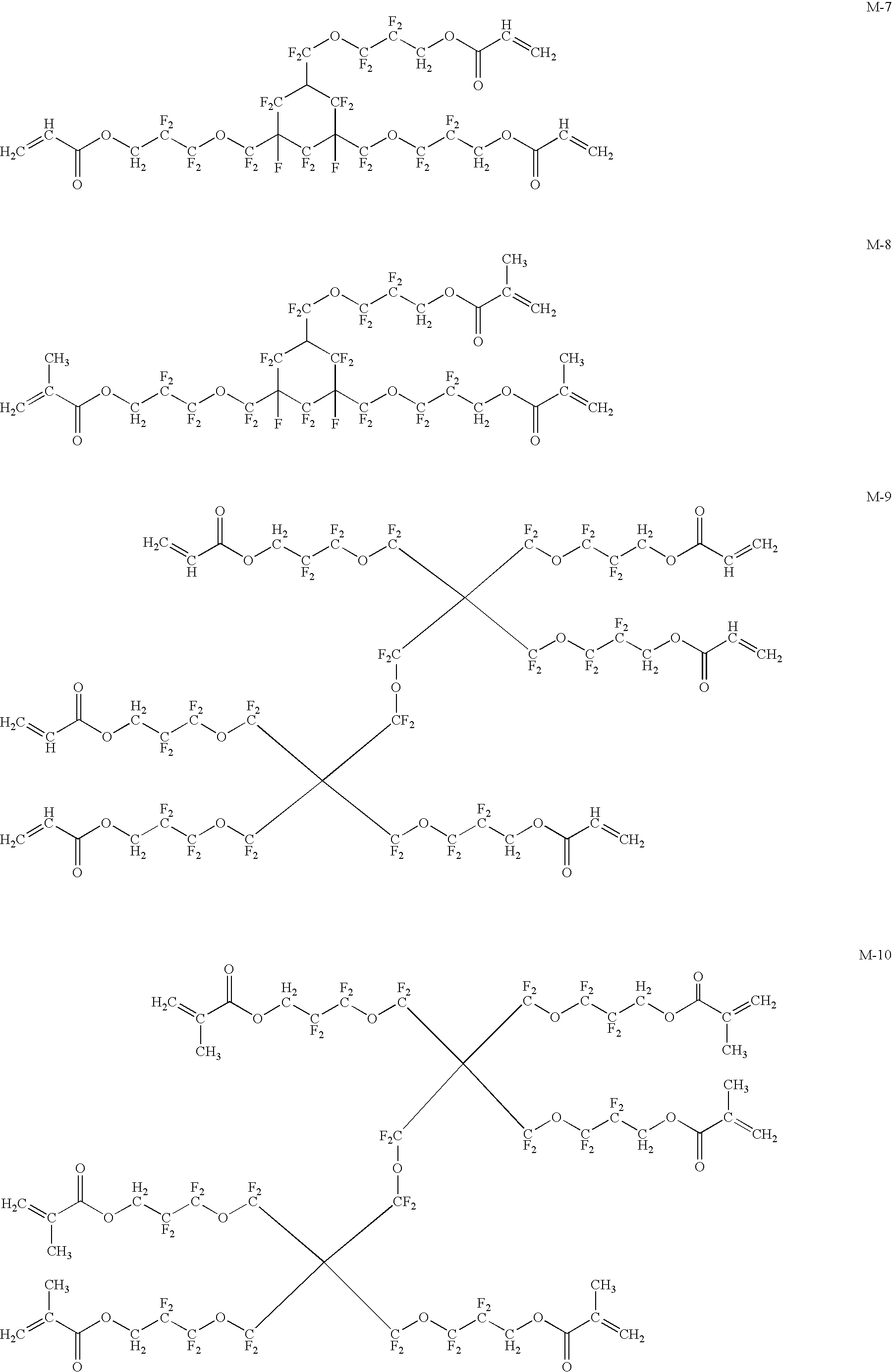

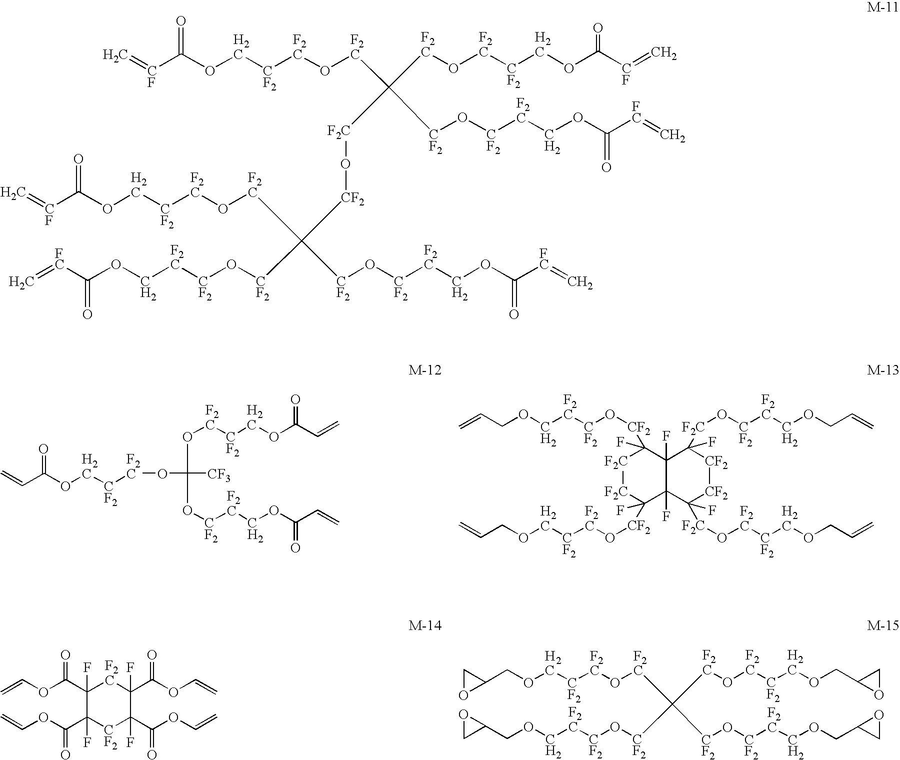

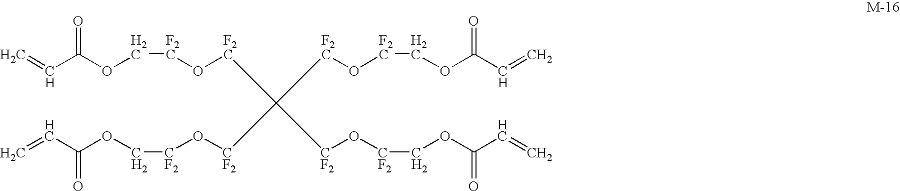

Further, compounds MA1 to MA20 shown below can also be used preferably.

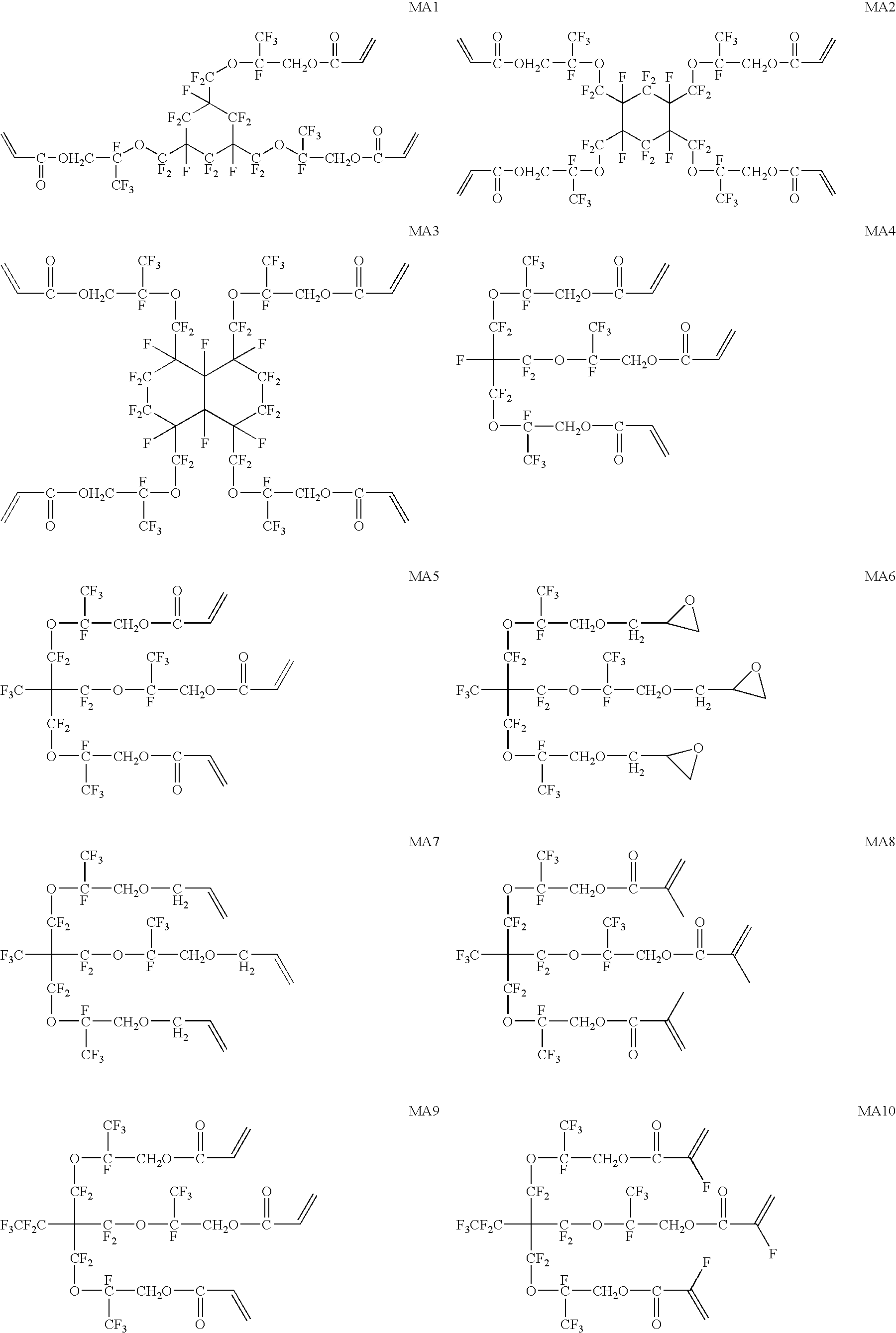

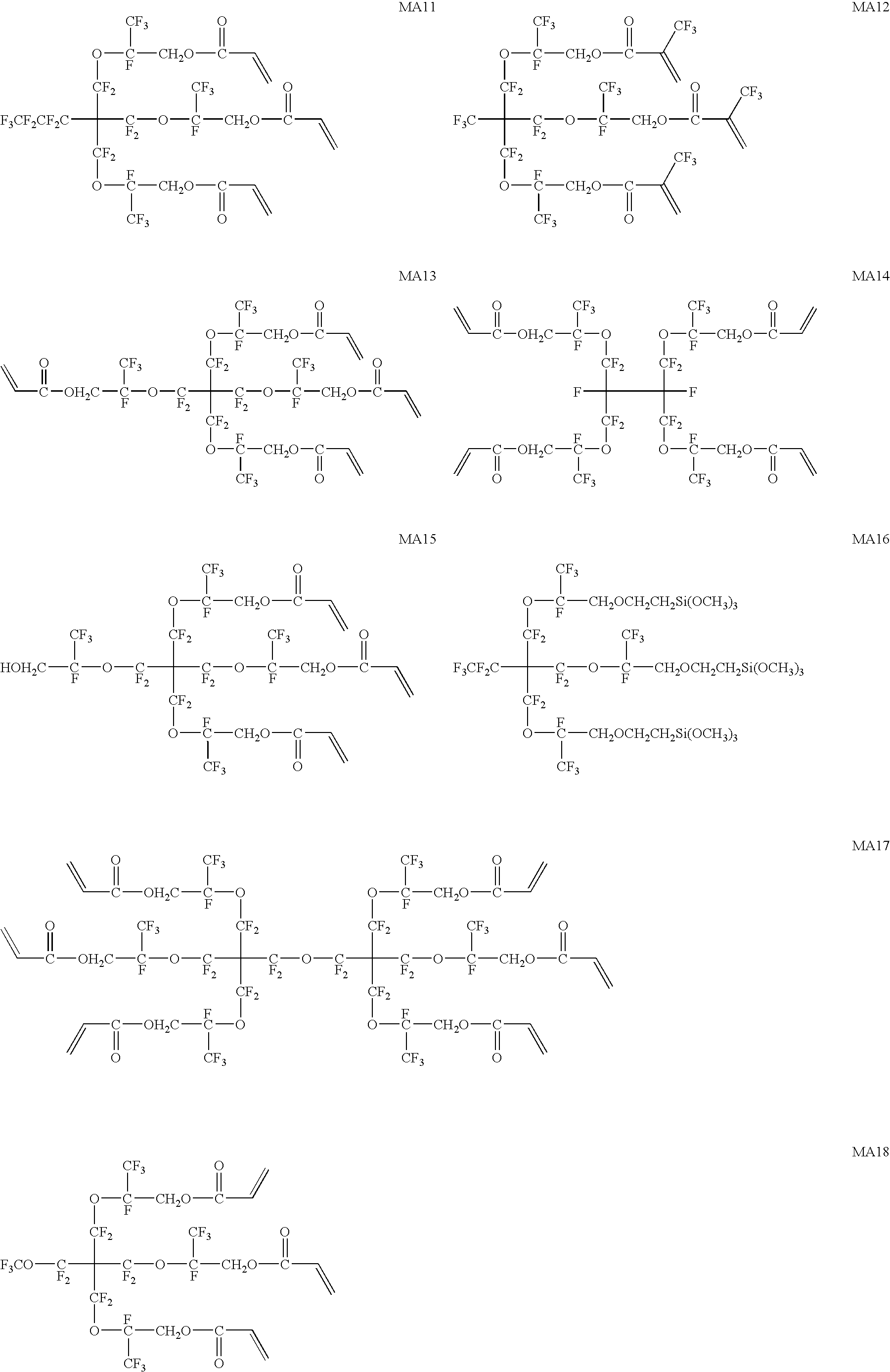

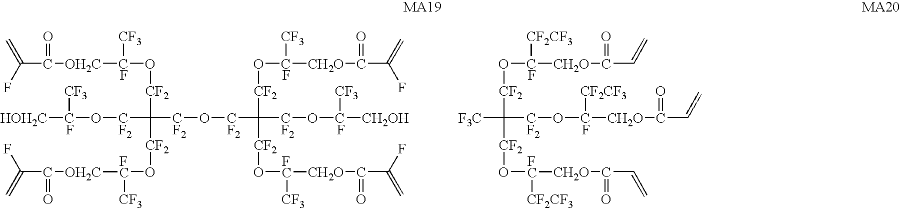

Among them, use of X-22 and M-1 is particularly preferable from the standpoint of satisfaction of both abrasion resistance and low refractive index, and use of M-1 is most preferable.

Further, the following compounds described in paragraph numbers 0135 to 0149 of WO 2005/059601 can also be used suitably.

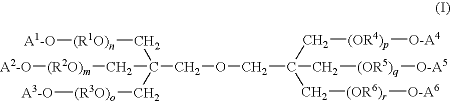

(in the above-described formula (I), A¹ to A⁶ represent each independently an acryloyl group, methacryloyl group, α-fluoroacryloyl group or trifluoromethacryloyl group, n, m, o, p, q and r represent each independently an integer of 0 to 2, and R¹ to R⁶ represent each independently an alkylene group having 1 to 3 carbon atoms or, a fluoroalkylene group having 1 to 3 carbon atoms in which one or more hydrogen atoms are substituted with a fluorine atom.).

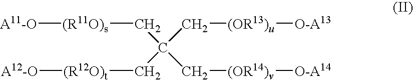

(in the above-described formula (II), A¹¹ to A¹⁴ represent each independently an acryloyl group, methacryloyl group, α-fluoroacryloyl group or trifluoromethacryloyl group, s, t, u and v represent each independently an integer of 0 to 2, and R¹¹ to R¹⁴ represent each independently an alkylene group having 1 to 3 carbon atoms or, a fluoroalkylene group having 1 to 3 carbon atoms in which one or more hydrogen atoms are substituted with a fluorine atom.).

Further, compounds described in paragraph numbers 0014 to 0028 of JP-A No. 2006-291077 can also be used suitably.

[Compound Forming Chemical Bond with Hydroxyl Group]

It is preferable that the low refractive index layer in the present invention is formed using a composition comprising a fluorine-containing polymer containing a hydroxyl group, and a compound (hardener) capable of reacting with a hydroxyl group in the fluorine-containing polymer, what is called a hardening resin composition. The hardener preferably has two or more sites, further preferably four or more sites reacting with a hydroxyl group.

The structure of the hardener is not particularly restricted providing it has the above-described number of functional groups capable of reacting with a hydroxyl group, and examples thereof include polyisocyanates, partial condensates of isocyanate compounds, multimers, poly-hydric alcohols, addition products with a low molecular weight polyester film and the like, blocked polyisocyanate compounds in which an isocyanate group is blocked with a blocking agent such as phenol and the like, aminoplastos, polybasic acids or anhydrides thereof, and the like.

In the present invention, preferable are aminoplastos crosslink-reacting with a hydroxyl group-containing compound under an acidic condition, from the standpoint of simultaneous satisfaction of stability in preservation and activity of the crosslink reaction and from the standpoint of the strength of a film to be formed. Aminoplastos are compounds containing an amino group which is capable of reacting with a hydroxyl group present in a fluorine-containing polymer, namely, a hydroxyalkylamino group or alkoxyalkylamino group, or a carbon atom adjacent to a nitrogen atom and substituted with an alkoxy group. Specifically, for example, melamine compounds, urea compounds, benzoguanamine compounds and the like are listed.

The above-described melamine compound is generally known as a compound having a skeleton in which a nitrogen atom is connected to a triazine ring, and specifically mentioned are melamine, alkylated melamine, methylolmelamine, alkoxylated methylmelamine and the like. In particular, methylolated melamine and alkoxylated methylmelamine obtained by reacting melamine and formaldehyde under basic conditions, and derivatives thereof are preferable, and particularly, alkoxylated methylmelamine is particularly preferable from the standpoint of storage stability. Methylolated melamine and alkoxylated methylmelamine are not particularly restricted, and use can be made also of various resins obtained by a method as described in, for example, “Plastic Material Course [8] Urea•Melamine resin” (THE NIKKAN KOGYO SHINBUN LTD.).

As the above-described urea compound, polymethylolated urea and its derivative: alkoxylated methyl urea, further, compounds having a glycol uryl skeleton as a cyclic urea structure or 2-imidazolidinone skeleton are also preferable, in addition to urea. Also with respect to amino compounds such as the above-described urea derivatives and the like, use can be made of various resins described in the above-described “Urea•Melamine resin”.

As the compound which is suitably used as the crosslinking agent in the present invention, preferable from the standpoint of compatibility with a fluorine-containing copolymer are, particularly, melamine compounds or glycol uryl compounds, and of them, it is preferable from the standpoint of reactivity that the crosslinking agent is a compound containing a nitrogen atom, and containing two or mo carbon atoms substituted with an alkyl group adjacent to the nitrogen atom. Particularly preferable are compounds having structures represented by the following H-1 and H-2, and partial condensates thereof In the formulae, R represents an alkyl group having 1 to 6 carbon atoms, or a hydroxyl group.

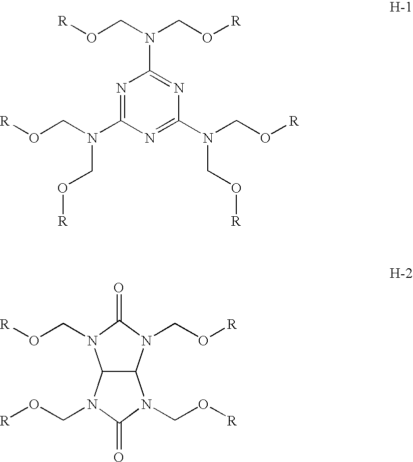

The addition amount of an aminoplasto based on a fluorine-containing polymer is 1 to 50 parts by mass, preferably 3 to 40 parts by mass, further preferably 5 to 30 pats by mass per 100 parts by mass of the copolymer. When the addition amount is 1 part by mass or more, durability as a thin film which is a feature of the present invention can be manifested sufficiently, and when 50 parts by mass or less, low refractive index which is a feature of the low refractive index layer in the present invention can be maintained in utilization in optical use, thus, the above-described range is preferable. Preferable are hardeners causing small increase in refractive index even if added, for maintain refractive index low even if the hardener is added, and for this reason, compounds having a skeleton represented by H-2 are more preferable among the above-described compounds.

In the present invention, it is also possible to partially bonding the above-described hydroxyl group-containing polymer and the above-described polyfunctional reactive compound previously before formation of an application composition. This is particularly effective in the case of high fluorine content as in the present invention, and thereby, the hardness of a coated film increases and dispersion stability of fine particle used together is improved.

### (Hardening Catalyst)

In the reaction of a hydroxyl group-containing fluorine-containing compound and the above-described hardener, the following hardening catalyst is preferably contained. In this system, hardening is promoted by an acid, thus, it is desirable to add an acidic substance to a hardening resin composition, however, if a usual acid is added, a crosslinking reaction progresses also in application liquid, causing failures (unevenness, repellency and the like). Therefore, for simultaneously satisfying storage stability and hardening activity in a thermo-hardening system, it is more preferable to add a compound generating an acid by heating as the hardening catalyst.

The hardening catalyst is preferably a salt composed of an acid and an organic base. As the acid, organic acids such as sulfonic acid, phosphonic acid, carboxylic acid and the like and inorganic acids such as sulfuric acid and phosphoric acid are listed, and from the standpoint of compatibility with a polymer, organic acids are more preferable, and sulfonic acids and phosphonic acids are further preferable, and sulfonic acids are most preferable. Preferable sulfonic acids include p-toluenesulfonic acid (PTS), benzenesulfonic acid (BS), p-dodecylbenzenesulfonic acid (DBS), p-chlorobenzenesulfonic acid (CBS), 1,4-naphthalenedisulfonic acid (NDS), methanesulfonic acid (MsOH), nonafluorobutane-1-sulfonic acid (NFBS) and the like, and any of them can be preferably used (mark in parentheses is abbreviation).

The hardening catalyst varies significantly depending on the boiling point and basicity of an organic base to be combined with an acid. Hardening catalysts used preferably in the present invention from various standpoints will be illustrated below.

When the basicity of an organic base is lower, the acid generating efficiency in heating is higher, being preferable from the standpoint of hardening activity, however, when the basicity is too low, storage stability becomes insufficient. Therefore, it is preferable to use an organic base having suitable basicity. When represented using pKa of a conjugated acid as the index of basicity, pKa of the organic acid to be used in the present invention is required to be 5.0 to 10.5, more preferably 6.0 to 10.0, further preferably 6.5 to 10.0. As the value of pKa of an organic base, values in an aqueous solution are described in Chemical Handbook, basic edition (revised 5-th edition, The Chemical Society of Japan ed., Maruzen, 2004), vol. 2, II-334 to 340, thus, organic bases having suitable pKa can be selected from them. Even if not described in this literature, compounds having suitable pKa from the structural standpoint can also be used preferably.

### <Photoradical Polymerization Initiator>

The photoradical polymerization initiator includes acetophenones, benzoins, benzophenones, phosphine oxides, ketals, anthraquinones, thioxanetones, azo compounds, peroxides, 2,3-dialkyldione compounds, disulfide compounds, fluoroamine compounds, aromatic sulfoniums, lophine dimers, onium salts, borate salts, active esters, active halogens, inorganic complexes, coumarins and the like.

Examples of the acetophenones include 2,2-dimethoxyacetophenone, 2,2-diethoxyacetophenone, p-dimethylacetophenone, 1-hydroxy-dimethyl phenyl ketone, 1-hydroxy-dimethyl-p-isopropyl phenyl ketone, 1-hydroxycyclohexyl phenyl ketone, 2-methyl-4-methylthio-2-morpholinopropiophenone, 2-benzyl-2-dimethylamino-1-(4-morpholinophenyl)-butanone, 4-phenoxydichloroacetophenone, 4-t-butyl-dichloroacetophenone.

Examples of the benzoins include benzoin, benzoin methyl ether, benzoin ethyl ether, benzoin isopropyl ether, benzyl dimethyl ketal, benzoin benzenesulfonate, benzoin toluenesulfonate, benzoin methyl ether, benzoin ethyl ether and benzoin isopropyl ether.

Examples of the benzophenones include benzophenone, hydroxybenzophenone, 4-benzoyl-4′-methyldiphenyl sulfide, 2,4-dichlorobenzophenone, 4,4-dichlorobenzophenone and p-chlorobenzophenone, 4,4′-dimethylaminobenzophenone (Michler's ketone), 3,3′,4,4′-tetra(t-butyl peroxycarbonyl)benzophenone and the like.

Examples of the phosphine oxides include 2,4,6-trimethylbenzoyl diphenylphosphine oxide.

Examples of the active esters include 1,2-octane dione, 1-[4-(phenylthio)-,2-(O-benzoyl oxime)], sulfonates, cyclic active ester compounds and the like.

Examples of the onium salts include aromatic diazonium salts, aromatic iodonium salts and aromatic sulfonium salts.

Examples of the borate salts include ion complexes with cationic coloring matters.

As the active halogens, S-triazine and oxathiazole compounds are known, and examples thereof include 2-(p-methoxyphenyl)-4,6-bis(trichloromethyl)-s-triazine, 2-(p-methoxyphenyl)-4,6-bis(trichloromethyl)-s-triazine, 2-(p-styrylphenyl)-4,6-bis(trichloromethyl)-s-triazine, 2-(3-Br-4-di(ethyl acetate)amino)phenyl)-4,6-bis(trichloromethyl)-s-triazine, 2-trihalomethyl-5-(p-methoxyphenyl)-1,3,4-oxadiazole.

Examples of the inorganic complexes include bis(η5-2,4-cyclopentadien-1-yl)-bis(2,6-difluoro-3-(1H-pyrrol-1-yl)-phenyl)titanium.

Examples of the coumarins include 3-ketocoumarin.

These initiators may be used singly or in admixture.

Various examples are described in “Saishin UV Koka Gijutsu”, Technical Information Institute Co., Ltd., 1991, p. 159, and useful in the present invention.

As commercially available photo-fragmentation type photoradical polymerization initiator, mentioned as preferable examples thereof are Irgacure (651, 184, 127, 819, 907, 1870 (CGI-403/Irg184=7/3 mixed initiator, 500, 369, 1173, 2959, 4265, 4263 and the like), OXE O 1) and the like manufactured by Chiba Specialty Chemicals, KAYACURE (DETX-S, BP-100, BDMK, CTX, BMS, 2-EAQ, ABQ, CPTX, EPD, ITX, QTX, BTC, MCA and the like) manufactured by Nippon Kayaku Co., Ltd., Esacure (KIP100F, KB1, EB3, BP, X33, KT046, KT37, KIP1 50, TZT) manufactured by Sartomer Company Inc.

The photopolymerization initiator is used in an amount of preferably in the range of 0.1 to 15 parts by mass, more preferably in the range of 1 to 10 parts by mass with respect to 100 parts by mass of a polyfunctional monomer.

In addition to the photopolymerization initiator, a photosensitization agent may be used. Specific examples of the photosensitization agent include n-butylamine, triethylamine, tri-n-butylphosphine, Michler's ketone, thioxanetone and the like.

Further, one or more auxiliaries such as azide compounds, thiourea compounds, mercapto compounds and the like may be used in combination.

As the commercially available photosensitization agent, KAYACURE (DMBI, EPA) manufactured by Nippon Kayaku Co., Ltd. and the like are mentioned.

### <Thermoradical Initiator>

As the thermoradical initiator, organic or inorganic peroxides, organic azo and diazo compounds and the like can be used.

Specifically, the organic peroxides include benzoyl peroxide, halogenbenzoyl peroxide, lauroyl peroxide, acetyl peroxide, dibutyl peroxide, cumene hydroperoxide, butyl hydroperoxide, the inorganic peroxides include hydrogen peroxide, ammonium persulfate, potassium persulfate and the like, the azo compounds include 2,2′-azobis(isobutyronitrile), 2,2′-azobis(propionitrile), 1,1′-azobis(cyclohexanecarbonitrile) and the like, the diazo compounds include diazoaminobenzene, p-nitrobenzenediazonium and the like.

### [Inorganic Fine Particle (D)]

Next, fine particles which can be preferably used in the low refractive index layer of the present invention will be illustrated.

The application amount of fine particles contained in the low refractive index layer is preferably 1 to 100 mg/m², more preferably 5 to 80 mg/m², further preferably 1 to 70 mg/m². When the application amount of fine particles is not lower than the lower limit, the effect of improving abrasion resistance appears clearly, and when not higher than the upper limit, there occur no failures such as formation of fine irregularity on the surface of the low refractive index layer to deteriorate appearance and integral reflection ratio, and the like, thus, the above-described range is preferable. Since the fine particles are contained in the low refractive index layer, it is preferable that the fine particles have low refractive index.

Specifically, preferable as the fine particles contained in the low refractive index layer are inorganic fine particles and hollow inorganic fine particles having low refractive index, and hollow inorganic fine particles are particularly preferable. As the inorganic fine particles, for example, fine particles of silica or hollow silica are mentioned. The average particle size of such fine particles is preferably 30% or more and 100% or less, more preferably 30% or more and 80% or less, further preferably 35% or more and 70% or less of the thickness of the low refractive index layer. That is, when the thickness of the low refractive index layer is 100 nm, the particle size of the fine particles is preferably 30 nm or more and 100 nm or less, more preferably 30 nm or more and 80 nm or less, further preferably 35 nm or more and 70 nm or less.

When the particle size of the (hollow) silica fine particles as described above is not lower than the above-described lower limit, the effect of improving abrasion resistance appears clearly, and when not higher than the above-described upper limit, there occur no failures such as formation of fine irregularity on the surface of the low refractive index layer to deteriorate appearance and integral reflection ratio, and the like, thus, the above-described range is preferable.

The (hollow) silica fine particles may be crystalline or amorphous, and may be monodispersed particles or agglomerated particles (in this case, it is preferable that the secondary particle size is 30% to 100% of the thickness of the low refractive index layer). Further, two or more kinds of particles (kind or particle size) may be used. The shape of the particle is most preferably spherical it may also be amorphous without causing problems.

For lowering the refractive index of the low refractive index layer, use of hollow silica fine particles is particularly preferable. The hollow silica fine particles have a refractive index of 1.17 to 1.40, more preferably 1.17 to 1.35, further preferably 1.17 to 1.30. Here, the refractive index means a refractive index as the whole particle, and does not mean a refractive index of only silica on the outer shell forming the hollow silica particle. If the radius of a cavity in the particle is represented by rᵢ and the radius of the particle outer shell is represented by r₀, the void ratio x is calculated according to the following numerical formula (1).

Numerical formula (1): x=(4πrᵢ³/3)/(4πrₒ³/3)×100

The void ratio x is preferably 10 to 60%, further preferably 20 to 60%, most preferably 30 to 60%. When it is tried to make the refractive index of the hollow silica particle lower and make the void ratio larger, the thickness of the outer shell becomes small to weaken the strength of the particle, thus, particles having a low refractive index of less than 1.17 are not permissible from the standpoint of abrasion resistance. The refractive index of these hollow silica particles was measured by an Abbe refractomer (manufactured by Atago Co., Ltd.).

Further, in the present invention, it is preferable to lower the surface free energy of the surface of the low refractive index layer from the standpoint of improvement in stain proofing. Specifically, it is preferable to use a fluorine-containing compound or a compound having a polysiloxane structure in the low refractive index layer.

As the additive having a polysiloxane structure, also reactive group-containing polysiloxanes {for example, “KF-100T”, “X-22-169AS”, “KF-102”, “X-22-37011E”, “X-22-164B”, “X-22-5002”, “X-22-173B”, “X-22-174D”, “X-22-167B”, “X-22-161AS” (trade name)(all are manufactured by Shin-Etsu Chemical Co., Ltd.); “AK-5”, “AK-30”, “AK-32” (trade name)(all are manufactured by TOAGOSEI Co., LTd.); “SILAPLANE FM0725”, “SILAPLANE FM0721” (trade name)(all are manufactured by CHISSO Corporation), and the like} are preferably added. Also silicone compounds described in Tables 2 and 3 of JP-A No. 2003-112383 can be preferably used. These polysiloxanes is preferably added in an amount in the range of 0.1 to 10 mass % with respect to all solid components of the low refractive index layer, and the case of 1 to 5 mass % is particularly preferable.

### (Structure of Layer of Optical Film)

The optical film of the present invention (anti-reflection film) has at least one anti-reflection layer laminated on a transparent substrate (hereinafter, referred to as support in some cases), in view of refractive index, thickness, number of layers, order of layers and the like.

The optical film of the present invention has, in general, a constitution in which only a low refractive index layer is applied on a substrate, in its simplest constitution. For further lowering refractive index, it is preferable that the anti-reflection layer is constituted of a combination of a high refractive index layer having higher refractive index than that of the substrate and a low refractive index layer having lower refractive index than that of the substrate. Examples of the constitution include those having two layers of high refractive index layer/low refractive index layer from the substrate side in this order, those having three layers having different refractive indices laminated in the order of middle refractive index layer (layer having refractive index higher than that of the substrate or hard coat layer and lower than that of the high refractive index layer)/high refractive index layer/low refractive index layer, and the like, and further, those having a lot of anti-reflection layers laminated are also suggested. Among them, those having middle refractive index layer/high refractive index layer/low refractive index layer applied in this order on the substrate having a hard coat layer are preferable from the standpoint of durability, optical property, cost, productivity and the like.

Examples of preferable layer constitutions of the optical film of the present invention will be shown below. In the following constitutions, the expression of (antistatic layer) means that a layer having other function has also the function of an antistatic layer simultaneously. By allowing the antistatic layer to have a function other than the antistatic function, the number of layers to be formed can be decreased, thus, such a constitution is preferable because of improved productivity.

support/antistatic layer/low refractive index layer

support/low refractive index layer (antistatic layer)

support/anti-dazzling layer (antistatic layer)/low refractive index layer

support/anti-dazzling layer/antistatic layer/low refractive index layer

support/hard coat layer/anti-dazzling layer (antistatic layer)/low refractive index layer

support/hard coat layer/anti-dazzling layer/antistatic layer/low refractive index layer

support/hard coat layer/antistatic layer/anti-dazzling layer/low refractive index layer

support/hard coat layer (antistatic layer)/anti-dazzling layer/low refractive index layer

support/hard coat layer/high refractive index layer/antistatic layer/low refractive index layer

support/hard coat layer/high refractive index layer (antistatic layer)/low refractive index layer

support/hard coat layer/antistatic layer/high refractive index layer/low refractive index layer

support/hard coat layer/middle refractive index layer/high refractive index layer (antistatic layer)/low refractive index layer

support/hard coat layer/middle refractive index layer (antistatic layer)/high refractive index layer/low refractive index layer

support/hard coat layer (antistatic layer)/middle refractive index layer/high refractive index layer/low refractive index layer

support/anti-dazzling layer/high refractive index layer (antistatic layer)/low refractive index layer

support/anti-dazzling layer/middle refractive index layer (antistatic layer)/high refractive index layer/low refractive index layer

support/antistatic layer/hard coat layer/middle refractive index layer/high refractive index layer/low refractive index layer

antistatic layer/support/hard coat layer/middle refractive index layer/high refractive index layer/low refractive index layer

support/antistatic layer/anti-dazzling layer/middle refractive index layer/high refractive index layer/low refractive index layer

antistatic layer/support/anti-dazzling layer/middle refractive index layer/high refractive index layer/low refractive index layer

antistatic layer/support/anti-dazzling layer/high refractive index layer/low refractive index layer/high refractive index layer/low refractive index layer

The layer constitution is not particularly restricted only to these layer constitutions providing it can reduce reflection ratio by optical interference.

### 1-(12) Support

The support of the film of the present invention is not particularly restricted and includes transparent resin films, transparent resin plates, transparent resin sheets, transparent glass and the like. As the transparent resin film, cellulose acylate films (for example, cellulose triacetate film (refractive index: 1.48), cellulose diacetate film, cellulose acetate butyrate film, cellulose acetate propionate film), polyethylene terephthalate film, polyether sulfone film, polyacrylic resin film, polyurethane resin film, polyester film, polycarbonate film, polysulfone film, polyether film, polymethylpentene film, polyether ketone film, (meth)acrylnitrile film and the like can be used.

### <Cellulose Acylate Film>

Among the above-described films, preferable are cellulose acylate films having high transparency, showing small optical birefringence, of which production is easy, and which are generally used as a protective film of a polarization plate, and particularly preferable is a cellulose triacetate film. The thickness of the transparent support is usually about 25 to 1,000 μm.

In the present invention, it is preferable to use cellulose acetate having a degree of acetylation of 59.0 to 61.5% as the cellulose acylate film.

The degree of acetylation means an amount of acetic acid bonded per cellulose unit weight. The degree of acetylation is obtained according to measurement and calculation of acetylation degree of ASTM: D-817-91 (test method for cellulose acetate or the like).

The cellulose acylate has a viscosity average degree of polymerization (DP) of preferably 250 or more, further preferably 290 or more.

It is preferable that the cellulose acylate to be used in the present invention has a value of Mw/Mn (Mw represents weight average molecular weight, Mn represents number average molecular weight) by gel permeation chromatography near 1.0, in other words, the molecular weight distribution is narrow. Specific value of Mw/Mn is preferably 1.0 to 1.7, further preferably 1.3 to 1.65, most preferably 1.4 to 1.6.

In general, hydroxyl groups at 2, 3 and 6-positions of cellulose acylate are not distributed evenly to ⅓ of the total degree of substitution, and the degree of substitution of a hydroxyl group at 6-position tends to be small. In the present invention, it is preferable that the degree of substitution of a hydroxyl group at 6-position of cellulose acylate is larger as compared with those at 2 and 3-positions.

The proportion of substitution of a hydroxyl group at 6-position by an acyl group with respect to the total degree of substitution is preferably 32% or more, further preferably 33% or more, particularly preferably 34% or more. Further, the degree of substitution of an acyl group at 6-position of cellulose acylate is preferably 0.88 or more. The hydroxyl group at 6-position may be substituted by a propionyl group, butyloyl group, valeroyl group, benzoyl group, acryloyl group or the like which is an acyl group having 3 or more carbon atoms in addition to an acetyl group. Measurement of the degree of substitution at each position can be carried out by NMR.

In the present invention, cellulose acetate obtained by methods described in JP-A No. 11-5851, paragraphs [0043] to [0044], [Example], [Synthesis Example 1], paragraphs [0048] to [0049], [Synthesis Example 2], paragraphs [0051] to [0052] and [Synthesis Example 3] can be used as the cellulose acylate.

### <Polyethylene Terephthalate Film>

In the present invention, also a polyethylene terephthalate film can be preferably used since it is excellent in transparency, mechanical strength, flatness, chemical resistance and humidity resistance, and additionally, it is cheap.

For further improving close adherence strength between a transparent plastic film and a hard coat layer provided thereon, it is further preferable that the transparent plastic film has been subjected to a treatment for easy adhesion.

As the commercially available PET film equipped with an easy-adhesive layer for optical use, Cosmo Shine A4100, A4300 and the like manufactured by Toyobo Co., Ltd. are mentioned.

### 2. Layer Constituting Film

The film of the present invention is obtained by mixing and applying the above-described various compounds, and layers constituting the film of the present invention will be described below.

### 2-(1) Anti-Dazzling Layer

The anti-dazzling layer is formed for the purpose of imparting to a film an anti-dazzling property by surface scattering, and preferably, a hard coat property for improving the abrasion resistance of the film.

As the method of providing an anti-dazzling property, a method in which a shaped film in the form of mat having fine irregularity on the surface is laminated to provide an anti-dazzling property as described in JP-A No. 6-16851, a method in which an anti-dazzling property is provided by hardening constriction of an ionizing radiation-hardening type resin due to a difference of the dose of ionizing radiation as described in JP-A No. 2000-206317, a method in which translucent fine particles and translucent resin are solidified while gelling to form irregularity on the surface of a coated film by decrease in the weight ratio of a good solvent against the translucent resin by drying as described in JP-A No. 2000-338310, a method in which irregularity is imparted to the surface by pressure from outside as described in JP-A No. 2000-275404, and the like are known, and these known methods can be used.

The anti-dazzling layer which can be used in the present invention preferably contains a binder capable of imparting a hard coat property, translucent particles for imparting an anti-dazzling property, and a solvent as essential components, and it is preferable that irregularity is formed on the surface of the anti-dazzling layer by a projection of the translucent particle itself or a projection formed by an aggregate of a plurality of particles.

The anti-dazzling layer formed by dispersion of mat particles is composed of a binder and translucent particles dispersed in the binder. It is preferable that the anti-dazzling layer having an anti-dazzling property has a hard coat property together with the anti-dazzling property.

As specific examples of the above-described mat particles, preferably mentioned are particles of inorganic compounds such as for example silica particles, TiO₂ particles and the like; and resin particles such as acrylic particles, crosslinked acrylic particles, polystyrene particles, crosslinked styrene particles, melamine resin particles, benzoguanamine resin particles and the like. Of them, crosslinked styrene particles, crosslinked acrylic particles and silica particles are preferable.

As the form of the mat particle, any of spherical and amorphous can be used.

The distribution of particle size of mat particles is measured by a Coulter counter method, and the measured distribution is converted into particle number distribution.

By controlling the refractive index of a translucent resin according to the refractive indices of translucent particles selected from these particles, an internal haze and surface haze in the present invention can be attained. Specifically, a combination of a translucent resin (refractive index after hardening is 1.55 to 1.70) containing as the main component a 3- or more-functional (meth)acrylate monomer preferably used in the anti-dazzling layer of the present invention described later with translucent particles composed of a crosslinked poly(meth)acrylate polymer having a styrene content of 50 to 100 mass % and/or benzoguanamine particles is preferable, and particularly, a combination of the above-described translucent resin with translucent particles (refractive index is 1.54 to 1.59) composed of a crosslinked poly(styrene-acrylate)copolymer having a styrene content of 50 to 100 mass % is particularly preferable.

It is preferable that the translucent particles are compounded into the anti-dazzling layer formed so that the content thereof in 3 to 30 mass % based on all solid components of the anti-dazzling layer from the standpoint of anti-dazzling property, image blur, surface white turbidity, glare and the like. It is more preferably 5 to 20 mass %. When less than 3 mass %, an anti-dazzling property is deficient, and when over 30 mass %, problems such as image blur, surface white turbidity, glare and the like occur.

The density of the translucent particles is preferably 10 to 1000 mg/m², more preferably 100 to 700 mg/m².

The absolute value of a difference between the refractive index of a translucent resin and the refractive index of translucent particles is preferably 0.04 or less. The absolute value of a difference between the refractive index of a translucent resin and the refractive index of translucent particles is preferably 0.001 to 0.030, more preferably 0.001 to 0.020, further preferably 0.001 to 0.015. When this difference is over 0.040, problems such as film letter blur, decrease in dark room contrast, surface white turbidity and the like occur.

Here, the refractive index of the above-described translucent resin can be evaluated quantitatively by direct measurement by an Abbe refractometer, by measurement of spectral reflection spectrum or spectral ellipsometry, and the like. The refractive index of the above-described translucent particle is measured by dispersing equal amount of translucent particles in a solvent having refractive index changed by changing the mixing ratio of two solvents having different refractive indices, and measuring the turbidity thereof, and measuring the refractive index of the solvent by an Abbe refractometer when the turbidity becomes minimum.

Further, two or more kinds of mat particles having different particle sizes may be used together. It is possible to impart an anti-dazzling property by mat particles of larger particle size, and to impart another optical property by mat particles of smaller particle size. For example, when an anti-dazzling anti-reflection film is pasted to a high-resolution display of 133 ppi or more, a failure regarding the quality of display image called “glare” occurs in some cases. “glare” is ascribable to lose of uniformity of brightness by enlargement or shrinkage of picture elements because of irregularity present on the surface of the anti-dazzling anti-reflection film, and can be significantly improved by simultaneous use mat particles having particle size smaller than that of the mat particles for imparting an anti-dazzling layer, and having a refractive index different from that of the binder.

The thickness of the anti-dazzling layer is preferably 1 to 10 μm, more preferably 1.2 to 8 μm. When too thin, hardness is deficient, and when too thick, curl and brittleness deteriorate to lower processing suitability in some cases, thus, the above-described range is preferable.

On the other hand, the center line average roughness (Ra) of the anti-dazzling layer is preferably in the range of 0.10 to 0.40 μm. When over 0.40 μm, problems occur such as glare and blanching of the surface when an outer light is reflected, and the like. The value of the definition of a transmitted image is preferably 5 to 60%.

The strength of the anti-dazzling layer is preferably H or more, further preferably 2H or more, most preferably 3H or more in the pencil hardness test.

### 2-(2) Hard Coat Layer

On the film of the present invention, a hard coat layer can be provided in addition to the anti-dazzling layer, for imparting physical strength of the film.

Preferably, a low refractive index layer is provided on this, further preferably, a middle refractive index layer and a high refractive index layer are provided between the hard coat layer and low refractive index layer, constituting an anti-reflection film.

The hard coat layer may be constituted of two or more layers laminated.

The refractive index of the hard coat layer in the present invention is in the range of preferably 1.48 to 2.00, more preferably 1.52 to 1.90, further preferably 1.55 to 1.80 from the standpoint of optical design for obtaining an anti-reflection film. In the present invention, since at least one low refractive index layer is present on the hard coat layer, when the refractive index is too smaller than this range, an anti-reflection property lowers, and when too larger, the color of a reflected light tends to be strong.

The thickness of the hard coat layer is usually about 0.5 μm to 50 μm, preferably 1 μm to 20 μm, further preferably 2 μm to 10 μm, most preferably 3 μm to 7 μm from the standpoint of imparting sufficient durability and impact resistance to the film.

The strength of the hard coat layer is preferably H or more, further preferably 2H or more, most preferably 3H or more in the pencil hardness test.

Further, smaller wear volume of a specimen before and after the test is more preferable, in a taper test according to JIS K5400.

The hard coat layer is preferably formed by a crosslinking reaction or polymerization reaction of an ionizing radiation-hardening compound. For example, it can be formed by applying an application composition containing an ionizing radiation-hardening polyfunctional monomer or polyfunctional oligomer on a transparent substrate, and crosslinking or polymerizing the polyfunctional monomer or polyfunctional oligomer.

As the functional group of the ionizing radiation-hardening polyfunctional monomer and polyfunctional oligomer, photo-, electron beam- and radiation-polymerizable functional groups are preferable, and of them, photo-polymerizable functional groups are preferable.

As the photo-polymerizable functional group, unsaturated polymerizable functional groups such as a (meth)acryloyl group, vinyl group, styryl group, allyl group and the like are mentioned, and of them, a (meth)acryloyl group is preferable.

The hard coat layer may contain mat particles having an average particle size of 1.0 to 10.0 μm, preferably 1.5 to 7.0 μm, for example, inorganic compound particles or resin particles, for the purpose of imparting an interior scattering property.

In the binder of the hard coat layer, a high refractive index monomer or inorganic particles, or both of them can be added, for the purpose of controlling the refractive index of the hard coat layer. Inorganic particles have, in addition to the effect of controlling refractive index, also an effect of suppressing hardening shrinkage by the crosslinking reaction. In the present invention, a polymer generated by polymerization of the above-described polyfunctional monomer and/or high refractive index monomer and the like, after formation of the hard coat layer, and inorganic particles dispersed therein, are collectively referred to as binder.

For the purpose of maintaining the clearness of an image, adjustment of the definition of a transmitted image is preferable in addition to control of the irregular form on the surface. The transmitted image definition of a clear anti-reflection film is preferably 60% or more. The transmitted image definition is generally an index showing blurring extent of an image transmitted through the film, and larger this value, more clear and excellent the image seen through the film. The transmitted image definition is preferably 70% or more, further preferably 80% or more.

### 2-(3) High Refractive Index Layer, Middle Refractive Index Layer

In the film of the present invention, a high refractive index layer and a middle refractive index layer can be provided to enhance an anti-reflection property.

In this specification, this high refractive index layer and middle refractive index layer are collectively called a high refractive index layer in some cases. In the present invention, “high”, “middle” and “low” of the high refractive index layer, middle refractive index layer and low refractive index layer represent relative magnitude relation of refractive index between the layers. In a relation with a transparent support, it is preferable that the refractive index satisfies relations of transparent support>low refractive index layer, high refractive index layer>transparent support.

In this specification, the high refractive index layer, middle refractive index layer and low refractive index layer are collectively called an anti-reflection film in some cases.

For constructing a low refractive index layer on a high refractive index layer to manufacture a anti-reflection film, the refractive index of the high refractive index layer is preferably 1.55 to 2.40, more preferably 1.60 to 2.20, further preferably 1.65 to 2.10, most preferably 1.80 to 2.00.

In the case of applying a middle refractive index layer, high refractive index layer and low refractive index layer from the substrate side in this order to manufacture an anti-reflection film, the refractive index of the high refractive index layer is preferably 1.65 to 2.40, further preferably 1.70 to 2.20. The refractive index of the middle refractive index layer is controlled so that it is a value between the refractive index of the low refractive index layer and the refractive index of the high refractive index layer. The refractive index of the middle refractive index layer is preferably 1.55 to 1.80.

Inorganic particles composed mainly of TiO₂ to be used in the high refractive index layer and middle refractive index layer are used in the form of dispersion for formation of the high refractive index layer and middle refractive index layer.

In dispersing the inorganic particles, they are dispersed in a dispersion medium in the presence of a dispersing agent.

The high refractive index layer and middle refractive index layer to be used in the present invention are preferably formed by further adding, preferably, a binder precursor necessary for matrix formation (for example, ionizing radiation-hardening polyfunctional monomer and polyfunctional oligomer, and the like), a photopolymerization initiator and the like to dispersion liquid prepared by dispersing inorganic particles in a dispersion medium to give an application composition for formation of the high refractive index layer and middle refractive index layer, applying the application composition for formation of the high refractive index layer and middle refractive index layer on a transparent substrate, and hardening the composition by a crosslinking reaction or polymerization reaction of an ionizing radiation-hardening composition (for example, polyfunctional monomer and polyfunctional oligomer, and the like).

Further, it is preferable that the binder of the high refractive index layer and middle refractive index layer is crosslinked or polymerized with a dispersing agent, simultaneously with application of the layer or after the application.

Regarding the binder of the high refractive index layer and middle refractive index layer thus manufactured, for example, the above-described preferable dispersing agent and the ionizing radiation-hardening polyfunctional monomer and polyfunctional oligomer are crosslinked or polymerized, and an anionic group of the dispersing agent is incorporated into the binder. Further, in the binder of the high refractive index layer and middle refractive index layer, the anionic group has a function of maintaining the dispersion condition of inorganic particles, and the crosslinked or polymerized structure imparts a film forming ability to the binder, thereby, improving the physical strength, chemical resistance and weather resistance of the high refractive index layer and middle refractive index layer containing inorganic particles.

The binder of the high refractive index layer is added in an amount of 5 to 80 mass % with respect the solid content of the application composition of the layer.

The content of inorganic particles in the high refractive index layer is preferably 10 to 90 mass %, more preferably 15 to 80 mass %, particularly preferably 15 to 75 mass % with respect to the weight of the high refractive index layer. Two or more kinds of inorganic particles may be used together in the high refractive index layer.

When a low refractive index layer is present on the high refractive index layer, it is preferable that the refractive index of the high refractive index layer is higher than the refractive index of a transparent substrate.

In the high refractive index layer, a binder obtained by a crosslinking or polymerization reaction of an ionic radiation-hardening compound containing an aromatic ring, an ionic radiation-hardening compound containing a halogen atom other than fluorine (for example, Br, I, Cl and the like), an ionic radiation-hardening compound containing an atom such as S, N, P and the like, etc. can also be preferably used.

The thickness of the high refractive index layer can be suitably set depending on use. When the high refractive index layer is used as an optical interference layer described later, the thickness is preferably 30 to 200 nm, more preferably 50 to 170 nm, and particularly preferably 60 to 150 nm.

When particles of imparting an anti-dazzling function are not contained, lower haze of the high refractive index layer is more preferable. It is preferably 5% or less, further preferably 3% or less, and particularly preferably 1% or less.

The high refractive index layer is preferably constructed on the above-described transparent support directly or via other layer.

### 2-(4) Low Refractive Index Layer

For lowering the refractive index of the film of the present invention, a low refractive index layer can be used. The refractive index of the low refractive index layer is preferably 1.20 to 1.46, more preferably 1.25 to 1.40, particularly preferably 1.30 to 1.37.

The thickness of the low refractive index layer is preferably 30 to 500 nm, further preferably 70 to 500 nm. For imparting electric conductivity, it is preferable that the thickness of the low refractive index layer is 130 to 500 nm. The haze of the low refractive index layer is preferably 3% or less, further preferably 2% or less, most preferably 1% or less. Specific strength of the low refractive index layer is preferably H or more, further preferably 2H or more, most preferably 3H or more in the pencil hardness test under 500 g load. For improving the stain-proofing performance of the optical film, the contact angle against water on the surface is preferably 90° or more. It is further preferably 95° or more, particularly preferably 100° or more.

### 2-(5) Antistatic Layer, Electric Conductive Layer

In the present invention, it is preferable to provide an antistatic layer for preventing static charge on the surface of the film. Examples of the method for forming an antistatic layer include a method in which electric conductive coating liquid containing electric conductive fine particles and a reactive hardening resin is coated, a method in which a metal, metal oxide and the like forming a transparent film is vapor-deposited or sputtered to form an electric conductive thin film, and conventionally known methods such as inclusion of an electric conductive polymer such as polythiophene and polyaniline, and the like. The electric conductive layer can be formed on a support directly or via a primer layer for reinforcing adhesion with the support. Further, it is also possible to use the antistatic layer as a part of the anti-reflection film.

The thickness of the antistatic layer is preferably 0.01 to 10 μm, more preferably 0.03 to 7 μm, and further preferably 0.05 to 5 μm. The surface resistance of the antistatic layer is preferably 10⁵ to 10¹² Ω/sq, further preferably 10⁵ to 10⁹ Q/sq and most preferably 10⁵ to 10⁸ Ω/sq. The surface resistance of the antistatic layer can be measured by a four search needle method.

It is preferable that the antistatic layer is substantially transparent. Specifically, the haze of the antistatic layer is preferably 10% or less, more preferably 5% or less, further preferably 3% or less, and most preferably 1% or less. The transmittance of a light having wavelength of 550 nm is preferably 50% or more, more preferably 60% or more, further preferably 65% or more, and most preferably 70% or more.

The antistatic layer of the present invention is excellent in strength, and the specific strength of the antistatic layer is preferably H or more, more preferably 2H or more, further preferably 3H or more, and most preferably 4H or more as a pencil hardness under 1 kg load.

The polarization plate of the present invention is a polarization plate having a polarization film and protective films provided on both sides of the polarization film, wherein at least one of the protective films is an optical film of the present invention.

The optical film or polarization plate of the present invention is not particularly restricted in its use, and can be suitably used as an anti-reflection film. The anti-reflection film can be used for preventing decrease in contrast by reflecting of images and reflection of outside light, in various image display devices such as liquid crystal display devices (LCD), plasma display panels (PDP), electroluminescence displays (ELD), cathode ray tubes (CRT), field emission displays (FED) and surface-conduction electron-emitter devices (SED).

The image display device of the present invention (preferably, liquid crystal display device) has an optical film or polarization plate of the present invention. The optical film or polarization plate of the present invention is preferably disposed on the surface of the display (visible side of display image plane).

### EXAMPLES

The following examples are mentioned for illustrating the present invention in detail, but the present invention is not limited to them. Unless otherwise stated, “part” and “%” are by mass.

### (Various Evaluation of Optical Film)

### (Evaluation of Steel Wool Abrasion Resistance)

A rubbing test can be carried out under the following conditions using a rubbing tester, to give an index for abrasion resistance.

Evaluation environmental conditions: 25° C., 60% RH

Rubbing material: steel wool (manufactured by Nihon Steel Wool Co., Ltd., grade No. 0000)

A film is wound on a rubbing point portion (1 cm×1 cm) of a tester getting into contact with a sample, and fixed with a band.

Moving distance (one way): 8 cm

Rubbing speed: 8 cm/sec.

Load: 200 g/cm²

Point portion contact area: 1 cm×1 cm, rubbing number: 10 reciprocations

An oily black ink is painted on the rear side of the rubbed sample, and flaw on the rubbed part is visually observed under a reflected light, and abrasion resistance is evaluated based on a difference from reflection light quantity on other parts than rubbed part.

### (Mirror Surface Reflection Ratio)

For measurement of the mirror reflection ratio, an adapter “ARV-474” is installed on a spectral photometer “V-550” [manufactured by Nippon Bunko K.K.], and mirror reflection ratio of emitting angle-5° is measured at an incident angle-5° in a wavelength range of 380 to 780 nm, and average reflection ratio in 450 to 650 nm is calculated, and a reflection preventing property can be evaluated.

It is preferable that the optical film of the present invention has a mirror reflection ratio of 2.0% or less since then reflection of an outer light can be suppressed and visibility is improved. The mirror reflection ratio is particularly preferably 1.4% or less.

### (Evaluation of White Turbidity Feeling)

An oily black ink was painted on the rear side of a sample, and white turbidity feeling was evaluated by visually observing this under solar light.

### <Manufacturing of Anti-Reflection Film>

### [Preparation of Application Liquid for Forming Layer]

[Preparation of Sol Liquid (a)]

Into a 1000 mL reaction vessel equipped with a thermometer, nitrogen introducing tube and dropping funnel was charged 187 g (0.80 mol) of 3-acryloxyoxypropyltrimethoxysilane, 27.2 g (0.20 mol) of methyltrimethoxysilane, 320 g (10 mol) of methanol and 0.06 g (0.001 mol) of potassium fluoride (KF), and 15.1 g (0.86 mol) of water was dropped slowly at room temperature while stirring. After completion of dropping, the mixture was stirred at room temperature for 3 hours, then, stirred with heat for 2 hours under methanol reflux. Thereafter, components of low boiling point were distilled off under reduce pressure, and further filtrated, to obtain 120 g of sol liquid (a).

Thus obtained substance was measured by GPC. The mass average molecular mass was 1,500, and the proportion of components having a molecular weight of 1,000 too 20,000 was 30 mass % among components of oligomer or larger components. It was found from the measurement result of ¹H-NMR that the resultant substance had a structure of the following formula.

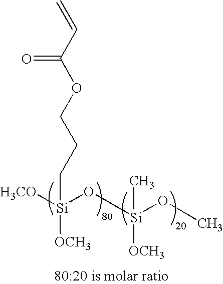

Further, the condensation ratio α by ²⁹Si-NMR measurement was 0.56. It was found from this analysis result that this silane coupling agent sol was mostly composed of linear structure parts. From the gas chromatography analysis, the raw material acryloxypropyltrimethoxysilane showed a residual ratio of 5 mass % or less.

[Preparation of Sol Liquid (b)]

In a reaction vessel equipped with a stirrer and a reflux condenser, 119 parts by mass of methyl ethyl ketone, 101 parts by mass of 3-acryloyloxypropyltrimethoxysilane “KBM-5103” {silane coupling agent, manufactured by Shin-Etsu Chemical Co., Ltd.} and 3 parts by mass of diisopropoxyaluminum ethylacetoacetate were added and mixed, then, 30 parts by mass of ion exchange water was added and the mixture was reacted at 60° C. for 4 hours, then, cooled down to room temperature, to obtain sol liquid (b).

The sol liquid (b) had a weight average molecular weight of 1,600, and the proportion of components having a molecular weight of 1,000 too 20,000 was 100 mass % among components of oligomer or larger components. It was found from the gas chromatography analysis that the raw material acryloyloxypropyltrimethoxysilane did not remain at all. This sol liquid (b) had a SP value of 22.4.

### [Preparation of Polyrotaxane and Crosslinked Polyrotaxane]

Preparation of a polyrotaxane and a crosslinked polyrotaxane was carried out referring to the following preparation method described in Japanese Patent No. 3475252.

A method of preparing the compound is described in the case of using α-cyclodextrin as a cyclic molecule, polyethylene glycol as a linear molecule, 2,4-dinitrophenyl group as a block group, and cyanuric chloride as a crosslinking agent.

For a blocking treatment to be performed later, both ends of polyethylene glycol were modified into an amino group, to obtain a polyethylene glycol derivative. α-cyclodextrin and the polyethylene glycol derivative were mixed to prepare a polyrotaxane. In preparation, for example, the mixing time can be controlled to 1 to 48 hours and the mixing temperature can be controlled 0°0 C. to 100° C. so that the fitting amount is 0.001 to 0.6 when the maximum fitting amount is 1.

In general, at a maximum 230 α-cyclodextrins can be fitted to a polyethylene glycol having an average molecular weight of 20,000. Namely, this value is the maximum fitting amount. The above-described conditions are conditions under which on average 60 to 65 (63) α-cyclodextrins are fitted using a polyethylene glycol having an average molecular weight of 20,000. The fitting amount of α-cyclodextrin can be confirmed by NMR, light absorption, element analysis and the like.

The resultant polyrotaxane is reacted with 2,4-dinitrofluorobenzene dissolved in DMF, to obtain a blocked polyrotaxane.

Next, the resultant blocked polyrotaxane is dissolved in a sodium hydroxide aqueous solution. Cyanuric chloride is added to this liquid and reacted, to obtain a crosslinked polyrotaxane in which α-cyclodextrins are mutually crosslinked.

### [Preparation of Polyrotaxane Compound (PR-1)]

### <Activation of Both Ends of Polyethylene Glycol>

Into a 100 ml Erienrneyer flask was charged 4 g of polyethylene glycol (abbreviated as PEG. Average molecular weight: 20,000) and 20 ml of anhydrous methylene chloride to dissolve PEG This solution was placed under an argon atmosphere, and 0.8 g of 1,1′-carbonyldimidazole was added, subsequently, under an argon atmosphere, the solution was stirred and reacted at room temperature (20° C.) for 6 hours.

The reaction product obtained above was poured into 300 ml of diethyl ether stirred at high speed. After allowing to stand still for 10 minutes, liquid containing a precipitate was centrifugally separated at 10,000 rpm for 5 minutes. The precipitate was taken out, and dried in vacuo at 40° C. for 3 hours.

The resultant product was dissolved in 20 ml of methylene chloride. This liquid was dropped into 10 ml of ethylenediamine over a period of 3 hours, and after dropping, the mixture was stirred for 40 minutes. The resultant reaction product was treated in a rotary evaporator to remove methylene chloride, and thereafter, dissolved in 50 ml of water and the solution was placed in a dialysis tube (fraction molecular weight: 8,000) and dialyzed in water for 3 days. The resultant dialyzed product was dried by a rotary evaporator, further, this dried product was dissolved in 20 ml of methylene chloride, and allowed to re-precipitate with 180 ml of diethyl ether. The liquid containing the precipitate was centrifugally separated at 100,000 rpm for 5 minutes, and dried in vacuo at 40° C. for 2 hours, to obtain 2.83 g of a product carrying amino groups introduced at both ends of PEG.

### <Preparation of Polyrotaxane>

3.6 g of α-cyclodextrin (abbreviated as α-CD) and 0.9 g of the above-prepared compound (molecular weight: about 20,000) were dissolved in 15 ml of water of 80° C., respectively, then, the solutions were mixed and cooled at 5° C. for 6 hours, to prepare a polyrotaxane. Thereafter, it was dried in vacuo at 40° C. for 12 hours.

### <Preparation of Blocked Polyrotaxane>

The polyrotaxane obtained above was charged into a 100 ml Erlenmeyer flask. Separately, 10 ml of N,N-dimethyformamide and 2.4 ml of 2,4-dinitrofluorobenzene were mixed to prepare a solution, and this mixed solution was dropped into the flask containing the polyrotaxane, and under argon inclusion, the mixture was reacted at ambient temperature. Five hours after, 40 ml of dimethyl sulfoxide was added to this mixture to give a transparent solution. This solution was dropped into 750 ml of water stirred vigorously, to obtain a pale yellow precipitate. This precipitate was dissolved in 50 ml of dimethyl sulfoxide again, and this solution was dropped into 700 ml of a 0.1% sodium chloride aqueous solution stirred vigorously, to cause re-precipitation again. This precipitate was washed with water and methanol, and after washing, centrifugally separated at 10,000 rpm for 1 minute, and this procedure was repeated three times. The resultant substance was dried in vacuo at 50° C. for 12 hours, to obtain 3.03 g of a blocked polyrotaxane (PR-1).

### [Preparation of Hydrophobicized Polyrotaxane (PR-2)]

### <Preparation of End-Capped Polyrotaxane>

4.5 g of polyethylene glycol bisamine having a number average molecular weight of 20,000 and 18.0 g of α-cyclodextrin were added to 150 mL of water, and heated at 80° C. to cause dissolution thereof. This solution was cooled and allowed to stand still at 5° C. for 16 hours. The produced white pasty precipitate was separated and dried.

To the above-described dried substance was added a mixed solution of 12.0 g of 2,4-dinitrofluorobenzene and 50 g of dimethylformamide and the mixture was stirred at room temperature for 5 hours. To the resultant reaction mixture was added 200 mL of dimethyl sulfoxide (DMSO) to cause dissolution thereof, then, the solution was poured into 3,750 mL of water, and the deposited substance was separated. The deposit was dissolved in 250 mL of DMSO again, then, the solution was poured into 3,500 mL of 0.1% saline again and the deposited substance was separated. The deposit was washed with water and methanol each three times, then, dried in vacuo at 50° C. for 12 hours, to obtain 2.0 g of an inclusion compound in which polyethylene glycol bisamine was included in the skewered form in α-cyclodextrin, and a 2,4-dinitrophenyl group was connected to both end amino groups. The resultant inclusion compound (end-capped blocked polyrotaxane) was subjected to ultraviolet absorption measurement and ¹H-NMR measurement, and the α-cyclodextrin fitting amount was calculated, to find a fitting amount of 72.

The fitting amount can be calculated by ultraviolet absorption measurement and ¹H-NMR measurement, and specifically, in the ultraviolet absorption measurement, the fitting amount of cyclodextrin was calculated by measuring the mol absorption coefficient at 360 nm of the synthesized inclusion compound and 2,4-dinitroaniline. In the ¹H-NMR measurement, the fitting amount of cyclodextrin was calculated from the integral ratio of hydrogen atoms of the polyethylene portion and hydrogen atoms of the cyclodextrin portion.

### <Acetylation of End-Capped Blocked Polyrotaxane>

1 g of the inclusion compound synthesized above (end-capped blocked polyrotaxane) was dissolved in 50 g of a 8% solution of lithium chloride/N,N-dimethylacetamide. To this was added 6.7 g of acetic anhydride, 5.2 g of pyridine and 100 mg of N,N-dimethylaminopyridine and the mixture was stirred at room temperature overnight. The reaction solution was poured into methanol, and the deposited solid was separated by centrifugal separation. The separated solid was dried, then, dissolved in acetone. The solution was poured into water, and the deposited solid was separated by centrifugal separation and dried, to obtain 1.2 g of an acetylated hydrophobicized polyrotaxane (PR-2).

The resultant acetylated polyrotaxane was subjected to ¹H-NMR measurement, and the acetyl introduction amount was calculated to find a value of 75%.

[Synthesis of Polyrotaxane Compound (PR-3) having Unsaturated Double Bond Group]

### <Preparation of End-Capped Polyrotaxane>

4.5 g of polyethylene glycol bisamine having a number average molecular weight of 20,000 and 18.0 g of α-cyclodextrin were added to 150 mL of water, and the mixture was heated to 80° C. to cause dissolution thereof. The solution was cooled and allowed to stand still at 5° C. for 16 hours. The produced white pasty precipitate was separated and dried.

To the above-described dried substance was added a mixed solution of 12.0 g of 2,4-dinitrofluorobenzene and 50 g of dimethylformamide and the mixture was stirred at room temperature for 5 hours. To the reaction mixture was added 200 mL of dimethyl sulfoxide (DMSO) to cause dissolution thereof, then, the solution was poured into 3,750 mL of water and the deposited substance was separated. The deposit was dissolved in 250 mL of DMSO again, then, the solution was poured into 3,500 mL of 0.1% saline again and the deposited substance was separated. The deposit was washed with water and methanol each three times, then, dried in vacuo at 50° C. for 12 hours to obtain 2.0 g of an inclusion compound in which polyethylene glycol bisamine was included in the skewered form in α-cyclodextrin, and a 2,4-dinitrophenyl group was connected to both end amino groups.

The resultant inclusion compound (end-capped blocked polyrotaxane) was subjected to ultraviolet absorption measurement and ¹H-NMR measurement, and the α-cyclodextrin fitting amount was calculated, to find a fitting amount of 72.

The fitting amount can be calculated by ultraviolet absorption measurement and ¹H-NMR measurement, and specifically, in the ultraviolet absorption measurement, the fitting amount of cyclodextrin was calculated by measuring the mol absorption coefficient at 360 nm of the synthesized inclusion compound and 2,4-dinitroaniline. In the ¹H-NMR measurement, the fitting amount of cyclodextrin was calculated from the integral ratio of hydrogen atoms of the polyethylene portion and hydrogen atoms of the cyclodextrin portion.

### <Acetylation of End-Capped Blocked Polyrotaxane>

1 g of the inclusion compound synthesized above (end-capped blocked polyrotaxane) was dissolved in 50 g of a 8% solution of lithium chloride/N,N-dimethylacetamide. To this was added 6.7 g of acetic anhydride, 5.2 g of pyridine and 100 mg of N,N-dimethylaminopyridine and the mixture was stirred at room temperature overnight. The reaction solution was poured into methanol, and the deposited solid was separated by centrifugal separation. The separated solid was dried, then, dissolved in acetone. The solution was poured into water, and the deposited solid was separated by centrifugal separation and dried, to obtain 1.2 g of an acetylated polyrotaxane.

The resultant acetylated polyrotaxane was subjected to ¹H-NMR measurement, and the acetyl introduction amount was calculated to find a value of 75%.

### <Introduction of Polymerizable Group>

1 g of the acetylated polyrotaxane synthesized above was dissolved in 50 g of a 8% solution of lithium chloride/N,N-dimethylacetamide. To this was added 5.9 g of acrylic chloride, 5.2 g of pyridine and 100 mg of N,N-dimethylaminopyridine and the mixture was stirred at room temperature over two nights. The reaction solution was poured into methanol, and the deposited solid was separated by centrifugal separation. The separated solid was dried, then, dissolved in acetone. The solution was poured into water, and the deposited solid was separated by centrifugal separation and dried, to obtain 0.8 g of polyrotaxane (PR-3) modified with acryloyl and acetyl.

The resultant polyrotaxane (PR-3) modified with acryloyl and acetyl was subjected to ¹H-NMR measurement, and the acryloyl and acetyl introduction amount was calculated to find a value of 87%.

(1) Preparation of application liquid for anti-dazzling layer
Composition of application liquid 1 for anti-dazzling layer

| | |
|---|---|
| PET-30 | 40.0 parts by mass |
| DPHA | 10.0 parts by mass |
| Irgacure 184 | 2.0 parts by mass |
| SX-350 (30%) | 2.0 parts by mass |
| Crosslinked acryl-styrene particle (30%) | 13.0 parts by mass |
| SP-13 | 0.06 parts by mass |
| Sol liquid (a) | 11.0 parts by mass |
| Toluene | 38.5 parts by mass |

The above-described application liquid was filtrated through a polypropylene filter having a pore diameter of 30 μm, to prepare application liquids 1 to 6 for hard coat.

The used compounds are shown below.

DPHA: mixture of dipentaerythritol pentaacrylate and dipentaerythritol hexaacrylate [manufactured by Nippon Kayaku Co., Ltd.]

PET-30: mixture of pentaerythritol triacrylate and pentaerythritol tetraacrylate [manufactured by Nippon Kayaku Co., Ltd.]

Irgacure 184: polymerization initiator [manufactured by Chiba Specialty Chemicals]

SX-350: crosslinked polystyrene particle having an average particle size of 3.5 μm [refractive index 1.60, manufactured by Soken Chemical & Engineering Co., Ltd., 30% toluene dispersion, used after dispersion for 20 minutes at 10,000 rpm by a POLYTRON dispersing machine]

Crosslinked acryl-styrene particle: average particle size 3.5 μm [refractive index 1.55, manufactured by Soken Chemical & Engineering Co., Ltd., 30% toluene dispersion, used after dispersion for 20 minutes at 10,000 rpm by a POLYTRON dispersing machine]

SP-13 fluorine-based surface modifier

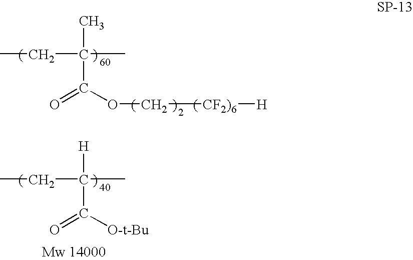

(application of Anti-Dazzling Layer 101)

A triacetylcellulose film (TAC-TD 80U, manufactured by FUJIFILM Corporation) was unwound in roll form, and anti-dazzling layer application liquid 1 was directly extruded and applied thereon using a coater having a throttle die. Application was carried out at a transporting speed of 30 m/min., and dried at 30° C. for 15 seconds and at 90° C. for 20 seconds, then, further, the applied layer was hardened by irradiation with ultraviolet ray at a dose of 60 mJ/cm² using 160 W/cm air-cooling metal halide lamp (manufactured by EYE GRAPHICS Co., Ltd.) under nitrogen purge, thereby, an anti-dazzling layer having an average thickness of 6.0 μm and having an anti-dazzling property was formed, and wound to manufacture HC-1.

### (Preparation of Application Liquid for Low Refractive Index Layer (Ln-1 to Ln-11))

Components were mixed as shown in the following table, and dissolved in MEK to produce low refractive index layer application liquid having a solid content of 5 mass %.

TABLE 2

| | Content (solid component) | | | | | | | | | |
|---|---|---|---|---|---|---|---|---|---|---|
| | | | | | | | | | Fluorine- | |
| | Fluorine- | | | | | | | | containing | |
| Application | containing | | Hardening | | Polymerization | | Polyrotaxane | | polyfunctional | |
| liquid | copolymer | | catalyst | | initiator | | compound | | monomer | |
| NO. | kind | amount | kind | amount | kind | amount | kind | amount | kind | amount |
| Ln1 | P-24 | 67 | — | — | Irg.127 | 3 | PR1 | 6 | — | — |
| Ln2 | P-24 | 67 | — | — | Irg.127 | 3 | PR2 | 6 | — | — |
| Ln3 | P-24 | 67 | — | — | Irg.127 | 3 | PR3 | 6 | — | — |
| Ln4 | P-24 | 67 | — | — | Irg.127 | 3 | PR4 | 6 | — | — |
| Ln5 | P-24 | 52 | — | — | Irg.127 | 3 | PR4 | 6 | — | — |
| Ln6 | P-24 | 52 | — | — | Irg.127 | 3 | PR4 | 6 | — | — |
| Ln7 | P-24 | 37 | — | — | Irg.127 | 3 | PR4 | 6 | M-1 | 15 |
| Ln8 | P-28 | 52 | — | — | Irg.127 | 3 | PR4 | 6 | — | — |
| Ln9 | P-29 | 52 | — | — | Irg.127 | 3 | PR4 | 6 | — | — |
| Ln10 | P-2 | 58 | Catalyst | 1 | — | — | PR1 | 6 | — | — |
| | | | 4050 | | | | | | | |
| Ln11 | P-2 | 58 | Catalyst | 1 | — | — | PR3 | 6 | — | — |
| | | | 4050 | | | | | | | |
| Ln12 | P-2 | 48 | Catalyst | 1 | — | — | PR3 | 6 | — | — |
| | | | 4050 | | | | | | | |

| | Content (solid component) | | | | | |
|---|---|---|---|---|---|---|
| | | Compound | | | | |
| | | having | | | | |
| | | unsaturated | | | | |
| Application | | double bond | | | | |
| liquid | Cymer | group | | | | |
| NO. | 303 | kind | amount | RMS-D33 | MEK-ST-L | remark |
| Ln1 | — | — | — | 4 | 20 | Comparative |
| | | | | | | Example |
| Ln2 | — | — | — | 4 | 20 | Example |
| Ln3 | — | — | — | 4 | 20 | Example |
| Ln4 | — | — | — | 4 | 20 | Example |
| Ln5 | — | PETA | 15 | 4 | 20 | Example |
| Ln6 | — | Sol(b) | 15 | 4 | 20 | Example |
| Ln7 | — | PETA | 15 | 4 | 20 | Example |
| Ln8 | — | PETA | 15 | 4 | 20 | Example |
| Ln9 | — | PETA | 15 | 4 | 20 | Example |
| Ln10 | 15 | — | — | — | 20 | Comparative |
| | | | | | | Example |
| Ln11 | 15 | — | — | — | 20 | Example |
| Ln12 | 15 | Sol(b) | 10 | — | 20 | Example |

Abbreviations in the above-described table are as described below.

“P-2, 24, 28, 29”: fluorine-containing copolymer described in the text.

PET-30: mixture of pentaerythritol triacrylate and pentaerythritol tetraacrylate [manufactured by Nippon Kayaku Co., Ltd.]

Irg. 127: Irgacure 127, polymerization initiator (manufactured by Nihon Ciba-Geigy K.K.)

M-1: fluorine-containing polyfunctional acrylate described in texture

RMS-033: mathacryloxy-modified silicone (manufactured by Gelest K.K.)

MEK-ST-L: manufactured by Nissan Chemical Industries Ltd., colloidal silica, average particle size: about 50 nm

Cymer 303: manufactured by Nihon Cytec Industries Inc., methylolated melamine

Catalyst 4050: manufactured by Nihon Cytec Industries Inc., hardening catalyst (Manufacturing of optical film samples 1 to 11)

On a hard coat 101, the above-described low refractive index layer application liquids Ln-1 to Ln-11 were applied by a micro-gravure application mode, while regulating the thickness of the low refractive index layer to 95 nm, to produced optical film samples 1 to 11, respectively.

Hardening conditions are shown below.

### <Samples 1 to 8>

Drying: 80° C. for 60 seconds

UV hardening: 60° C. for 1 minute; 240 W/cm air-cooling metal halide lamp (manufactured by EYE GRAPHICS Co., Ltd.) is used while purging with nitrogen so as to give an oxygen concentration of 0.01 vol % or less; illuminance 120 mW/cm²; dose 500 mJ/cm²

### <Samples 9 to 11>

(1) Drying: 80° C. for 120 seconds

(2) Thermal hardening: 110° C. for 10 minutes

(3) UV hardening: 60° C. for 1 minute; 240 W/cm air-cooling metal halide lamp (manufactured by EYE GRAPHICS Co., Ltd.) is used while purging with nitrogen so as to give an oxygen concentration of 0.01 vol % or less; illuminance 120 mW/cm²; dose 200 mJ/cm²

### (Saponification Treatment of Optical Film)

The resultant optical film was treated and dried under the following saponification standard conditions.

Alkali bath: 1.5 mol/dm³ sodium hydroxide aqueous solution, 55° C. for 120 seconds

First water washing bath: tap water, 60 seconds

Neutralization bath: 0.05 mol/dm³ sulfuric acid, 30° C. for 20 seconds

Second water washing bath: tap water, 60 seconds

Drying: 120° C., 60 seconds

### (Evaluation of Optical Film)

The following evaluations were carried out using the above-described saponified optical films.

### (Evaluation 1) Steel Wool Abrasion Resistance Evaluation

A test was conducted by a method described in body text, an oily black ink was painted on the rear side of the abraded sample, and flaw on the abraded part was visually observed under reflection light, and evaluated under the following standard. A load of 200 g/cm² was used, and 10 reciprocations were performed.

∘∘: flaw is not seen at all even if observed very carefully

∘: slightly weak flaw is seen if observed very carefully

∘Δ: weak flaw is seen

Δ: middle flaw is seen

×: there is flaw which can be found by only one glance

### (Evaluation 2) Measurement of Mirror Reflection Ratio

An average reflection ratio at 450 to 650 nm was used by a method described in body text. In the case of a sample processed into polarization plate, the polarization plate form itself is used, and in the case of a film itself or display device using no polarization plate, the rear surface of an anti-reflection film was roughen, then, a light absorption treatment (transmittance at 380 to 780 nm is less than 10%) was carried out with a black ink, and the mirror reflection ratio was measured on a black table.

### (Evaluation 3) Evaluation of White Turbidity Feeling

Evaluation was carried out according to the following standard by a method described in body text.

∘∘: white turbidity is not seen even if observed very carefully

∘: light white turbidity is found if observed very carefully

∘Δ: white turbidity is seen if observed carefully

Δ: weak white turbidity is seen on the whole film

×: strong white turbidity of the whole film is found by only one glance

The evaluation results are shown in Table 3.

TABLE 3

| | | | | Steel wool | | |
|---|---|---|---|---|---|---|
| | | Low refractive | Mirror reflection | abrasion | | |
| Sample No. | HC layer | index layer | ratio | resistance | White turbidity | remark |
| 1 | HC-1 | Ln1 | 1.34% | x | x | Comparative |
| | | | | | | Example |
| 2 | HC-1 | Ln2 | 1.34% | Δ | Δ | Example |
| 3 | HC-1 | Ln3 | 1.34% | Δ | Δ | Example |
| 4 | HC-1 | Ln4 | 1.34% | ∘Δ | Δ | Example |
| 5 | HC-1 | Ln5 | 1.52% | ∘∘ | ∘ | Example |
| 6 | HC-1 | Ln6 | 1.50% | ∘ | ∘∘ | Example |
| 7 | HC-1 | Ln7 | 1.50% | ∘∘ | ∘∘ | Example |
| 8 | HC-1 | Ln8 | 1.54% | ∘∘ | ∘∘ | Example |
| 9 | HC-1 | Ln9 | 1.59% | ∘∘ | ∘∘ | Example |
| 10 | HC-1 | Ln10 | 1.37% | x | x | Comparative |
| | | | | | | Example |
| 11 | HC-1 | Ln11 | 1.37% | ∘Δ | ∘Δ | Example |
| 12 | HC-1 | Ln12 | 1.60% | ∘∘ | ∘∘ | Example |

From the above-described tables, it is understood that when a polyrotaxane compound is used for improving the abrasion resistance of a low refractive index layer containing a fluorine-containing copolymer, an anti-reflection film showing no white turbidity of a coated film, having low reflection ratio and excellent in abrasion resistance is obtained, in the present invention.

According to the present invention, an optical film having improved abrasion resistance and showing no white turbidity of a coated film though using a polyrotaxane compound is obtained. Further, an anti-reflection film having further improved abrasion resistance and showing no white turbidity of a coated film though having a sufficient anti-reflection performance is obtained. Furthermore, a polarization plate and an image display device equipped with the optical film or the anti-reflection film are obtained.

In detail, there can be obtained an anti-reflection film excellent in abrasion resistance and having low reflection ratio, and showing no white turbidity of a coated film by use of a hydrophobic polyrotaxane compound or simultaneous use of a compound having a plurality of unsaturated double bond groups in one molecule, in using a polyrotaxane compound for improving the abrasion resistance of a low refractive index layer having a fluorine-containing copolymer. It is estimated that compatibility of a hydrophilic polyrotaxane compound with a hydrophobic fluorine-containing copolymer is improved by use of the hydrophobic polyrotaxane compound or simultaneous use of the above-described compound.

The entire disclosure of each and every foreign patent application from which the benefit of foreign priority has been claimed in the present application is incorporated herein by reference, as if fully set forth.

What is claimed is:

1. An optical film, comprising:
a transparent support; and
at least one low refractive index layer on or above the transparent support,
wherein the low refractive index layer is formed from a low refractive index layer forming composition containing (A) a hydrophobic polyrotaxane compound, (B) a fluorine-containing copolymer and an organic solvent.

2. The optical film according to claim 1,
wherein the hydrophobic polyrotaxane compound (A) is a compound including a cyclic molecule that is hydrophobicized.

3. The optical film according to claim 1,
wherein the hydrophobic polyrotaxane compound (A) includes a cyclodextrin molecule as a cyclic molecule.

4. The optical film according to claim 1,
wherein the hydrophobic polyrotaxane compound (A) is a polyrotaxane compound having an unsaturated double bond group.

5. The optical film according to claim 1,
wherein the low refractive index layer forming composition further contains (C) at least one compound having a plurality of unsaturated double bond groups in one molecule.

6. The optical film according to claim 5,
wherein at least one of the at least one compound (C) includes an organosiloxane structure.

7. The optical film according to claim 5,
wherein at least one of the at least one compound (C) is a fluorine-containing poly-functional monomer having two or more polymerizable groups and having a fluorine content of 20.0 mass % or more.

8. The optical film according to claim 1,
wherein the low refractive index layer forming composition further contains (D) inorganic fine particles.

9. A polarization plate, comprising:
a polarization film; and
a plurality of protective films on both sides of the polarization film,
wherein at least one of the plurality of protective films is the optical film according to claim 1.

10. An image display device, comprising:
the optical film according to claim 1 disposed on the outermost surface of a display.
